(19) United States
(12) Patent Application Publication
(10) Pub. No.: US 2026/0019609 A1
(43) Pub. Date: Jan. 15, 2026

(54) VIDEO-DYNAMIC MESH CODING ENTROPY ENCODING IMPROVEMENTS IN STATIC-MESH ENCODER

(71) Applicant: QUALCOMM Incorporated, San Diego, CA (US)

(72) Inventors: Anique Akhtar, San Diego, CA (US); Geert Van der Auwera, San Diego, CA (US); Adarsh Krishnan Ramasubramonian, Irvine, CA (US); Reetu Hooda, San Diego, CA (US); Marta Karczewicz, San Diego, CA (US)

(21) Appl. No.: 19/244,249

(22) Filed: Jun. 20, 2025

Related U.S. Application Data
(60) Provisional application No. 63/669,175, filed on Jul. 9, 2024.
(60) Provisional application No. 63/671,999, filed on Jul. 16, 2024.
(60) Provisional application No. 63/714,504, filed on Oct. 31, 2024.

(51) Int. Cl. H04N 19/44; H04N 19/13; H04N 19/17; H04N 19/597; H04N 19/70; H04N 19/91

(52) U.S. Cl. CPC H04N 19/44; H04N 19/13; H04N 19/17; H04N 19/597; H04N 19/70; H04N 19/91

(57) ABSTRACT

A device is configured to decode a mesh from a bitstream that includes the encoded mesh data, wherein, as part of decoding the mesh, one or more processors of the device are configured to determine, based on encoded mesh data, a base mesh that includes a set of vertices; apply the entropy decoding to first, second, and third entropy-encoded data comprises using a shared non-bypass context for entropy decoding at least one bin of each of the first truncated unary (TU) data, the second TU data, and the third TU data, where the first, second, and third TU data are included in binarized representations of syntax elements representing first and second residual values of components of normal vectors of vertices and a second residual value of a component of a normal vector of a vertex.

This application claims the benefit of U.S. Provisional Patent Application 63/714,504, filed Oct. 31, 2024, U.S. Provisional Patent Application 63/671,999, filed Jul. 16, 2024, and U.S. Provisional Patent Application 63/669,175, filed Jul. 9, 2024, the entire content of each of which is incorporated by reference.

### TECHNICAL FIELD

This disclosure relates to video-based coding of dynamic meshes.

### BACKGROUND

Meshes may be used to represent physical content of a 3-dimensional space. Meshes may have utility in a wide variety of situations. For example, meshes may be used in the context of representing the physical content of an environment for purposes of positioning virtual objects in an extended reality, e.g., augmented reality (AR), virtual reality (VR), or mixed reality (MR), application. Mesh compression is a process for encoding and decoding meshes. Encoding meshes may reduce the amount of data required for storage and transmission of the meshes.

### SUMMARY

This disclosure describes techniques for improving entropy encoding in a static-mesh encoder. Vertices of a mesh may include a set of attributes. The attributes may include a normal vector attribute that indicate a normal vector of a vertex. A computing system may use the normal vectors of vertices of a mesh when rendering the mesh for display. For instance, the computing system may use the normal vectors for one or more of lighting calculations, determining surface orientations, smooth shading, texture mapping, reflection, and refraction when rendering the mesh for display. In proposals for a Video-Dynamic Mesh Coding (V-DMC) standard, a normal vector attribute for a vertex comprises three components (i.e., normal vector attribute components), which correspond to directions in a 3-dimensional (3D) space. For each normal vector attribute component, a V-DMC encoder may generate a predictor for the normal vector attribute component. Additionally, the V-DMC encoder may generate a residual value for the normal vector attribute component that indicates a difference between the actual value of the normal vector attribute component and the predictor for the normal vector attribute component.

The V-DMC encoder may use a fine prediction process or a coarse prediction process to generate predictors for the normal vector attribute component. For instance, if a sufficient number of neighboring vertices of a current vertex have already been decoded, the V-DMC encoder may use the fine prediction process (e.g., a multi-parallelogram prediction scheme) to generate a fine prediction value for the normal vector attribute component. The V-DMC encoder may then generate a mesh normal fine residual value indicating a difference between the fine prediction value and the current value of the normal vector attribute component. The V-DMC encoder may generate a mesh normal fine residual syntax element that specifies the mesh normal fine residual value. If there is an insufficient number of decoded neighboring vertices to perform the fine prediction process, the V-DMC encoder may use a coarse prediction process that involves fewer neighboring vertices (e.g., cross prediction or delta prediction) to generate a coarse prediction value for the normal vector attribute component. In general, the fine prediction process may yield more accurate predictions than the coarse prediction process. The V-DMC encoder may then generate a mesh normal coarse residual value indicating a difference between the coarse prediction value and the current value of the normal vector attribute component. The V-DMC encoder may generate a mesh normal coarse residual syntax element that specifies the mesh normal coarse residual value.

When generating the mesh normal fine residual syntax element or the mesh normal coarse residual syntax element, the V-DMC encoder may convert the mesh normal fine residual value or the mesh normal coarse residual value into an octahedral format. Conversion of the mesh normal fine residual value or the mesh normal coarse residual value into the octahedral format is a lossy conversion. In other words, a reconstructed value generated by reversing the conversion may be different from the original value. Hence, the V-DMC encoder may generate a normal second residual syntax element that specifies a difference between the reconstructed value and the original normal fine residual value or the original normal coarse residual value.

A V-DMC decoder may reconstruct a normal vector based on a mesh normal coarse residual syntax element or a mesh normal fine residual syntax element, and a normal second residual syntax element. For instance, the V-DMC decoder may perform a fine residual prediction or a coarse residual prediction to determine a predictor of the normal vector attribute component, add the predictor to the mesh normal fine residual syntax element or mesh normal coarse residual syntax element to determine a first residual, and add the normal second residual syntax element to the first residual value to reconstruct the component of the normal vector of the vertex.

The V-DMC encoder may use entropy encoding to encode each of the mesh normal fine residual syntax element, the mesh normal coarse residual syntax element, and the normal second residual syntax element. As part of entropy encoding these syntax elements, the V-DMC encoder binarizes the mesh normal fine residual syntax element, the mesh normal coarse residual syntax element, and the normal second residual syntax element into a truncated unary (TU) code and an exponential-Golomb code, which includes a prefix and a suffix. The V-DMC decoder may apply entropy decoding the entropy encoded binarized data to decode the binarized data, and may then debinarize the binarized data to reconstruct the mesh normal fine residual syntax element, the mesh normal coarse residual syntax element, and the normal second residual syntax element.

In proposals for the V-DMC standard, the V-DMC encoder and the V-DMC decoder use different contexts for each of the mesh normal fine residual syntax element, the mesh normal coarse residual syntax element, and the normal second residual syntax element. In other words, a first set of contexts is used for entropy encoding and entropy decoding the truncated unary code of the mesh normal coarse residual syntax element, a second set of contexts is used for entropy encoding and entropy decoding the truncated unary code of the mesh normal fine residual syntax element, a third set of contexts is used for entropy encoding and entropy decoding the truncated unary code of the normal second residual syntax element. The sets of contexts used for the prefixes and suffixes of the truncated unary codes, prefixes and suffixes for these three syntax elements are likewise different.

Storing different sets of contexts for the TU codes, prefixes, and suffixes of these three syntax elements increases the complexity and storage requirements of encoders and decoders. Hence, in accordance with techniques of this disclosure, a first set of one or more non-bypass contexts is shared between the TU codes of the three syntax elements, a second set of one or more contexts is shared between the prefixes of the three syntax elements, and a third set of one or more contexts is shared between the prefixes of the three syntax elements. By sharing sets of non-bypass contexts in this way, the complexity and storage requirements of the encoder and decoder may be reduced.

In one example, this disclosure describes a device for decoding encoded mesh data, the device comprising: one or more memory units; and one or more processors implemented in circuitry, coupled to the one or more memory units, and configured to decode a mesh from a bitstream that includes the encoded mesh data, wherein the one or more processors are configured to, as part of decoding the mesh: determine, based on the encoded mesh data, a base mesh that includes a set of vertices; use a first prediction method to generate a prediction of a component of a first normal vector of a first vertex in the set of vertices; apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determine the first normal vector based in part on the prediction of the component of the first normal vector, the value of the component of the first prediction residual, and the second residual value of the component of the first normal vector; use a second prediction method to generate a prediction of a component of a second normal vector of a second vertex in the set of vertices; apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determine the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdivide the base mesh to determine an additional set of vertices for the base mesh; determine one or more displacement vectors; deform the base mesh, wherein to deform the base mesh, the one or more processors are configured to modify locations of the additional set of vertices based on the one or more displacement vectors; and determine a decoded mesh based on the base mesh.

In another example, this disclosure describes a method for decoding encoded mesh data, the method comprising: decoding a mesh from a bitstream that includes the encoded mesh data, wherein decoding the mesh comprises: determining, based on the encoded mesh data, a base mesh that includes a set of vertices; using a first prediction method to generate a prediction of a component of a first normal vector of a first vertex in the set of vertices; applying entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; applying entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determining the first normal vector based in part on the prediction of the component of the first normal vector, the value of the component of the first prediction residual, and the second residual value of the component of the first normal vector; using a second prediction method to generate a prediction of a component of a second normal vector of a second vertex in the set of vertices; applying entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determining the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdividing the base mesh to determine an additional set of vertices for the base mesh; determining one or more displacement vectors; deforming the base mesh, wherein deforming the base mesh comprises modifying locations of the additional set of vertices based on the one or more displacement vectors; and determining a decoded mesh based on the base mesh.

In another example, this disclosure describes a non-transitory computer-readable storage medium having instructions stored thereon that, when executed by one or more processors, cause the one or more processors to: decode a mesh from a bitstream that includes encoded mesh data, wherein the one or more processors are configured to, as part of decoding the mesh: determine, based on the encoded mesh data, a base mesh that includes a set of vertices; use a first prediction method to generate a prediction of a component of a first normal vector of a first vertex in the set of vertices; apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determine the first normal vector based in part on the prediction of the component of the first normal vector, the value of the component of the first prediction residual, and the second residual value of the component of the first normal vector; use a second prediction method to generate a prediction of a component of a second normal vector of a second vertex in the set of vertices; apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determine the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdivide the base mesh to determine an additional set of vertices for the base mesh; determine one or more displacement vectors; deform the base mesh, wherein to deform the base mesh, the one or more processors are configured to modify locations of the additional set of vertices based on the one or more displacement vectors; and determine a decoded mesh based on the base mesh.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example encoding and decoding system that may perform the techniques of this disclosure.

FIG. 2 shows an example implementation of a V-DMC encoder.

FIG. 3 shows an example implementation of a V-DMC decoder.

FIG. 4 shows an example of resampling to enable efficient compression of a 2D curve.

FIG. 5 shows a displaced curve that has a subdivision structure, while approximating the shape of the original mesh.

FIG. 6 shows a block diagram of a pre-processing system.

FIG. 7 shows an example of a V-DMC intra frame encoder.

FIG. 8 shows an example of a V-DMC decoder.

FIG. 9 shows an example V-DMC decoding process with both inter and intra.

FIG. 10 shows an example of a V-DMC intra frame decoder.

FIG. 11 is a flowchart illustrating an example process for encoding a mesh.

FIG. 12 is a flowchart illustrating an example process for decoding a compressed bitstream of mesh data.

FIG. 13 shows an example overview of a complete Edgebreaker mesh codec using reverse mode in V-DMC v7.0.

FIG. 14 shows an example detailed overview of a base mesh encoder.

FIG. 15 shows an example detailed overview of a base mesh decoder.

FIG. 16 shows an architecture of a V-DMC encoder and a V-DMC decoder for attribute encoding/decoding within the basemesh encoder.

FIG. 17A shows an example of position residuals contexts employed in a static mesh encoder.

FIG. 17B shows an alternative example of position residuals contexts employed in a static mesh encoder.

FIG. 18A shows example texture residuals contexts employed in a static mesh encoder.

FIG. 18B shows an alternative example texture residuals contexts employed in a static mesh encoder.

FIG. 19A shows example normal residuals contexts employed in a static mesh encoder.

FIG. 19B shows an alternative example normal residuals contexts employed in a static mesh encoder.

FIG. 20A and FIG. 21A show example attribute residuals contexts employed in a static mesh encoder.

FIG. 20B and FIG. 21B show an alternative example attribute residual contexts employed in the static mesh encoder.

FIG. 22A shows an example context assignment scheme for mesh position fine residual syntax elements, a context assignment scheme for mesh texture fine residual syntax elements, and a context assignment scheme for mesh texture coarse residual syntax elements.

FIG. 23A shows a context assignment scheme for mesh normal fine residual syntax elements and a context assignment scheme for normal second residual syntax elements.

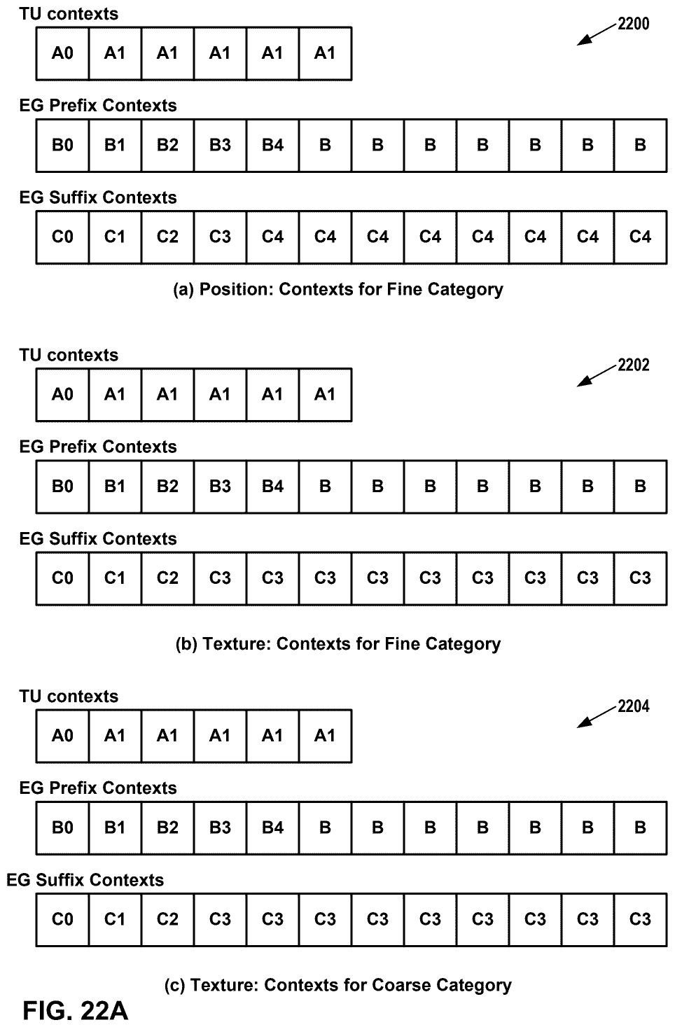

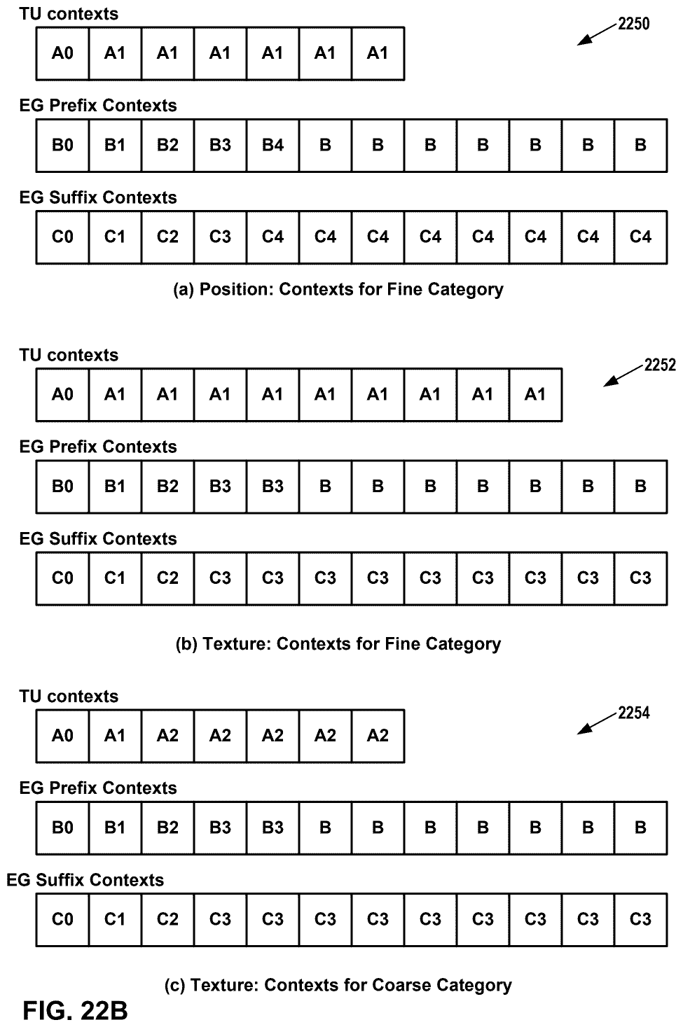

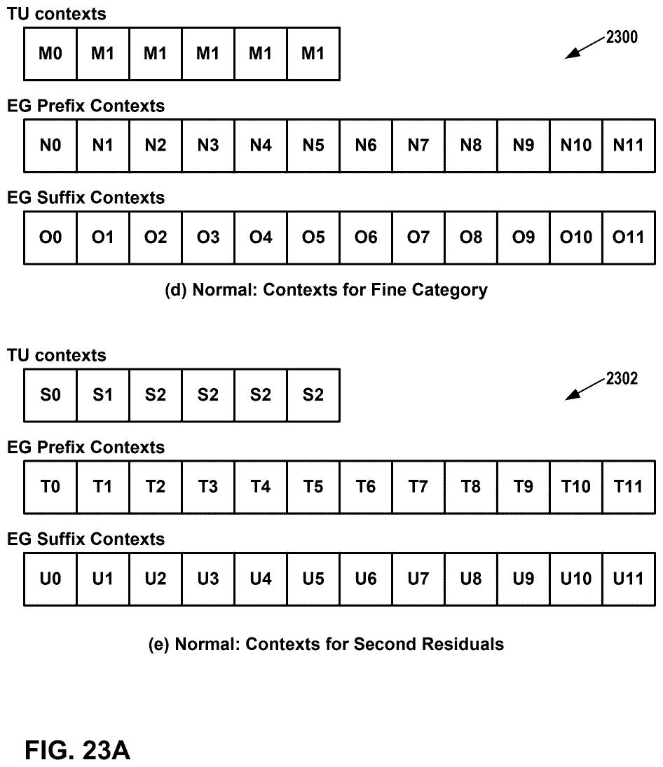

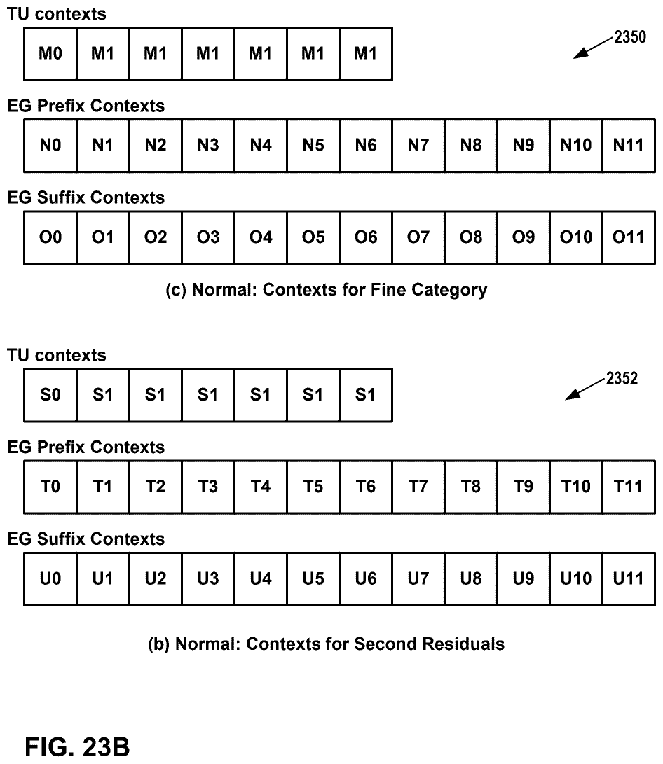

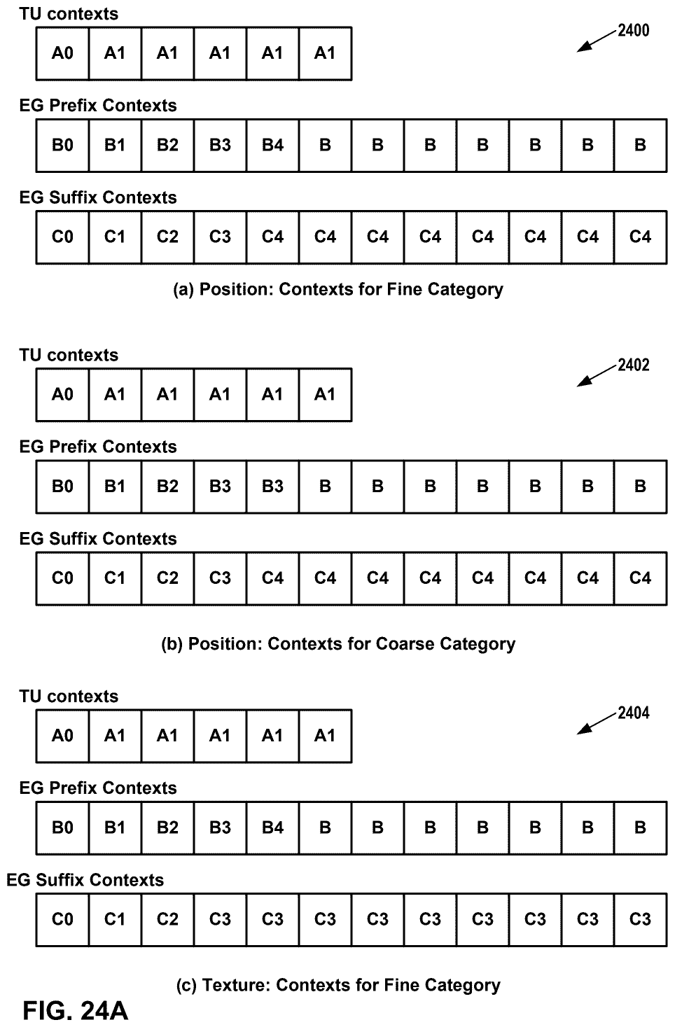

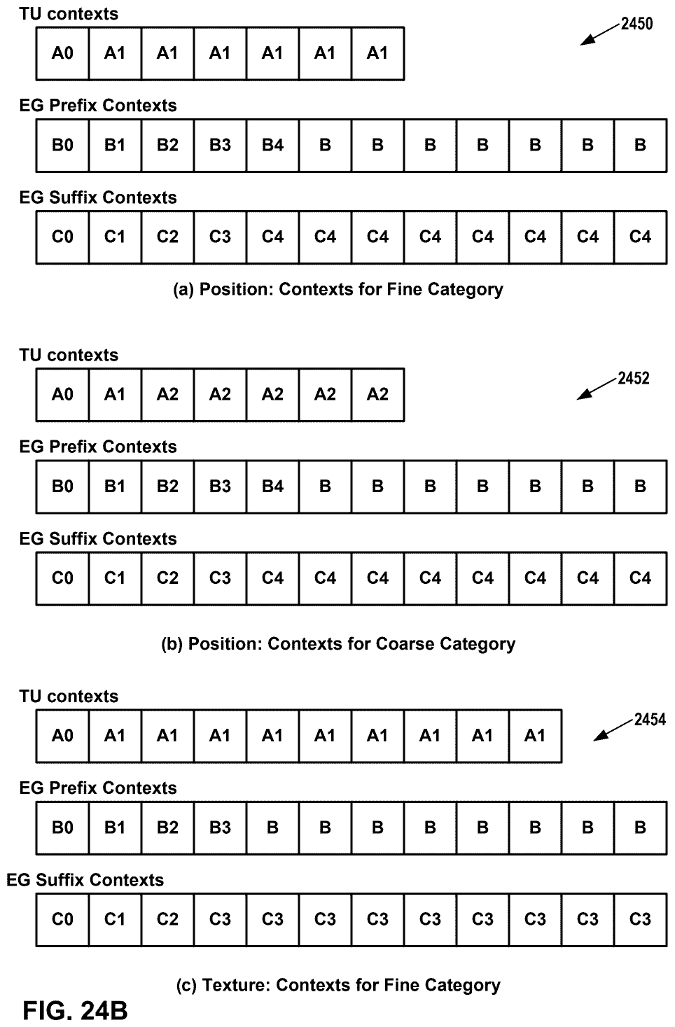

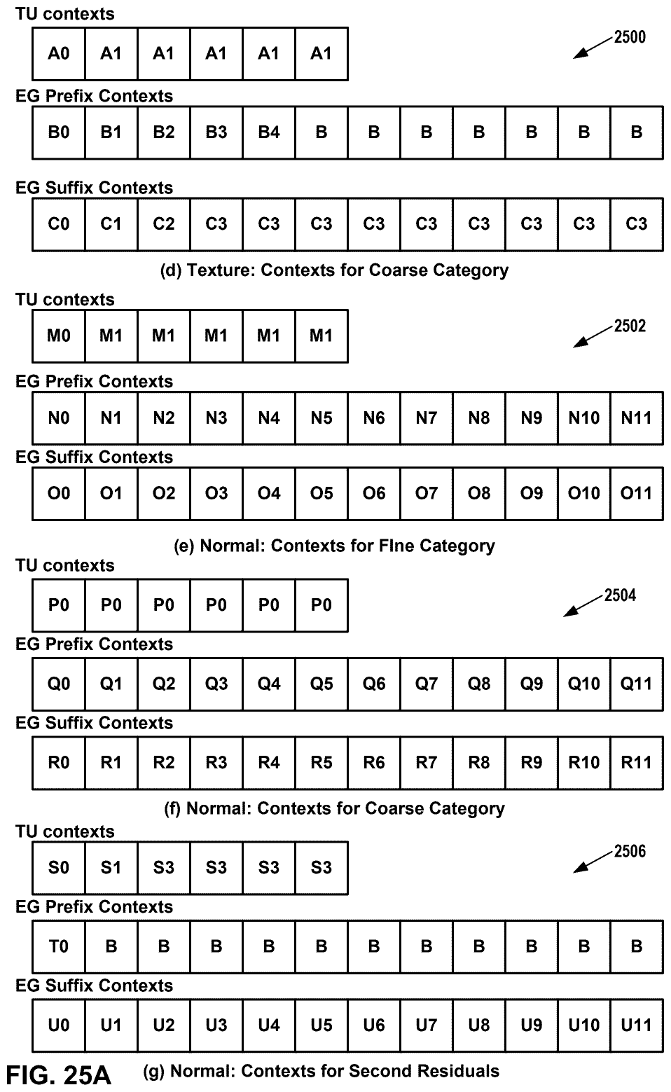

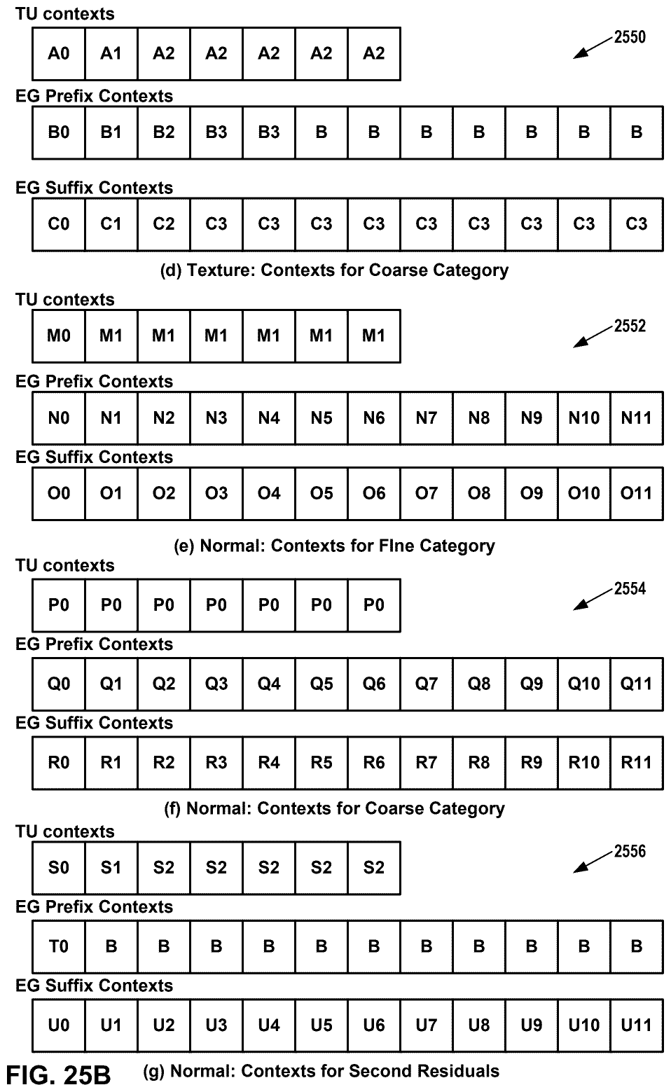

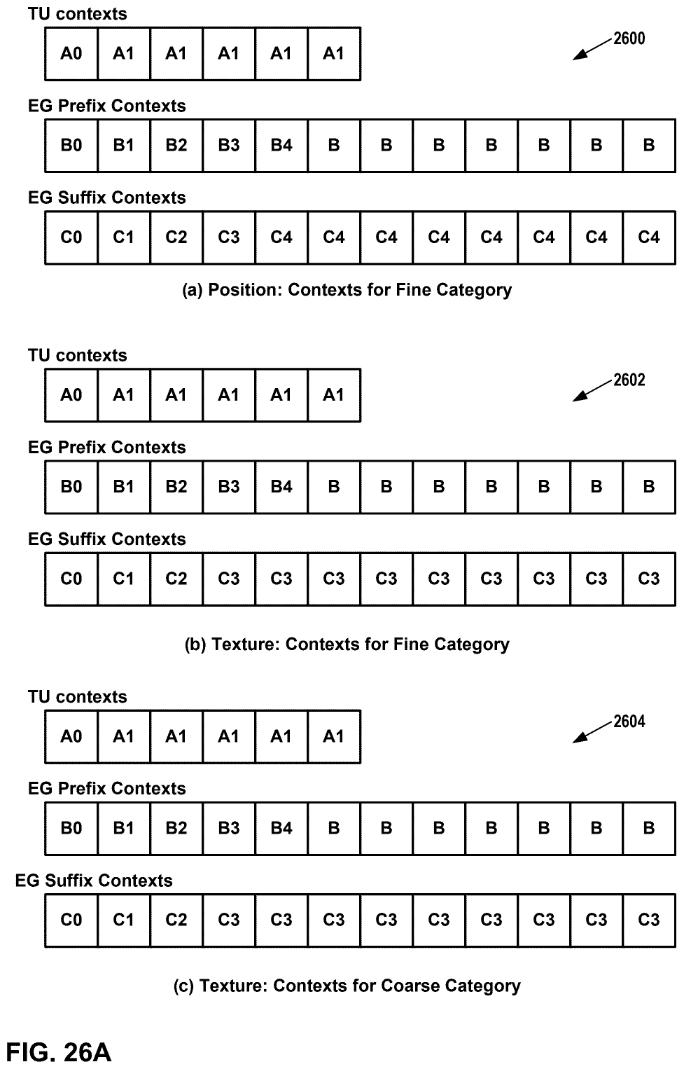

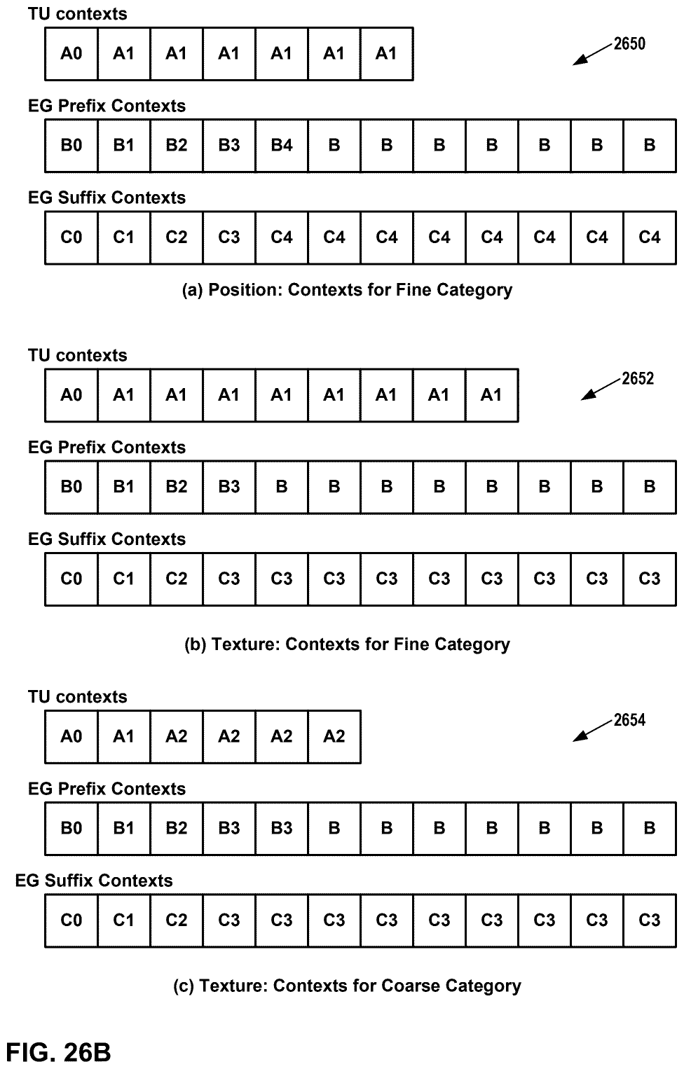

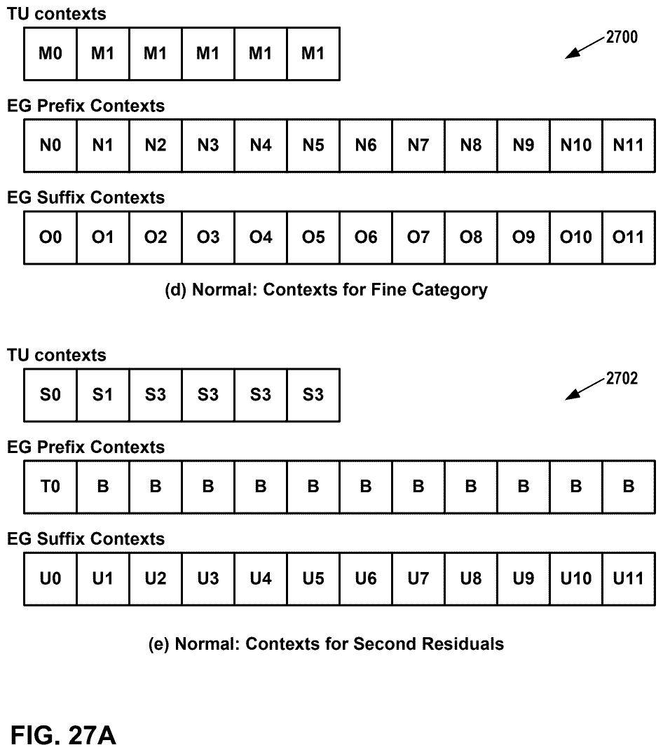

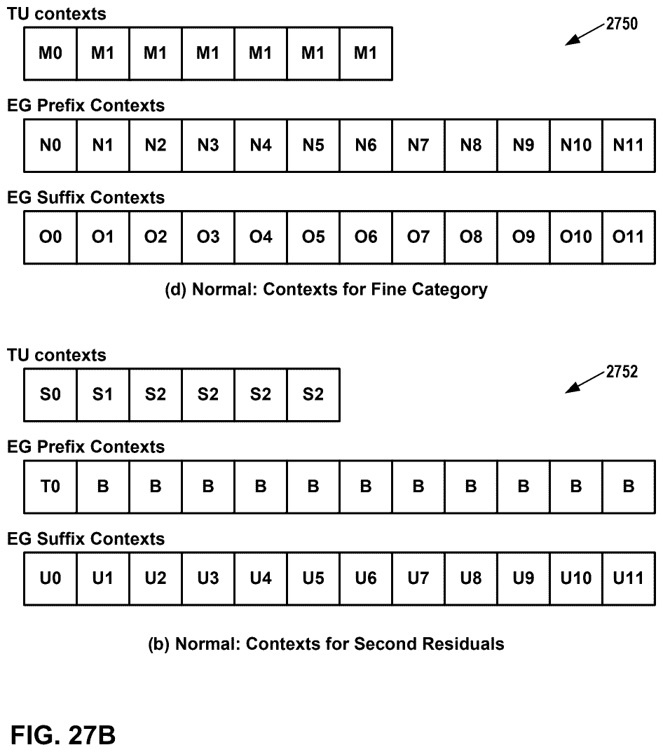

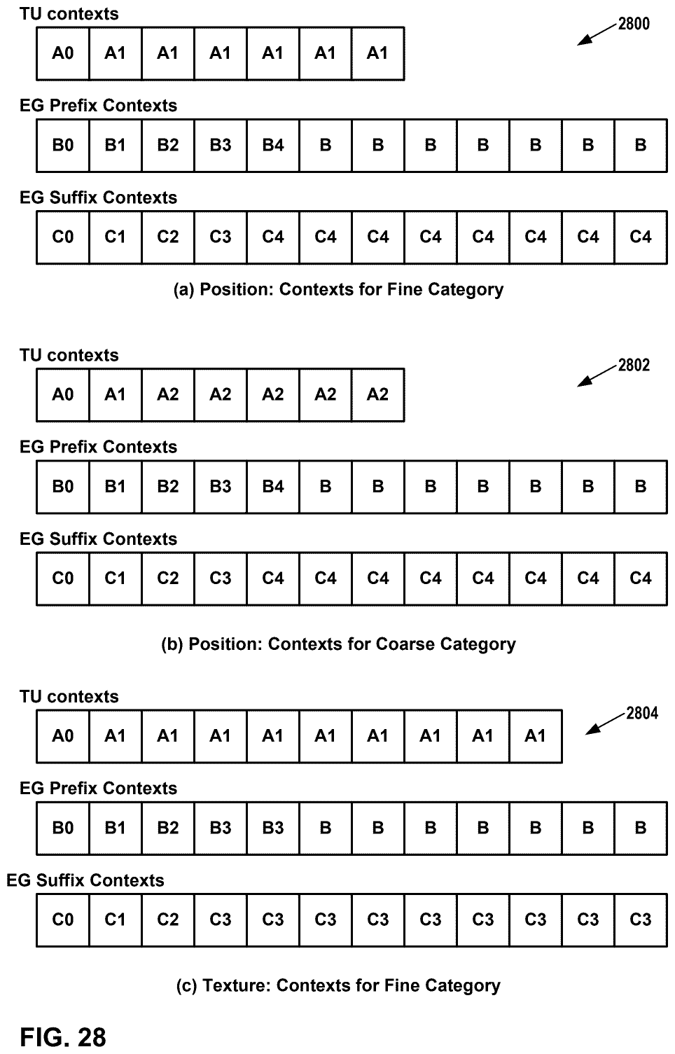

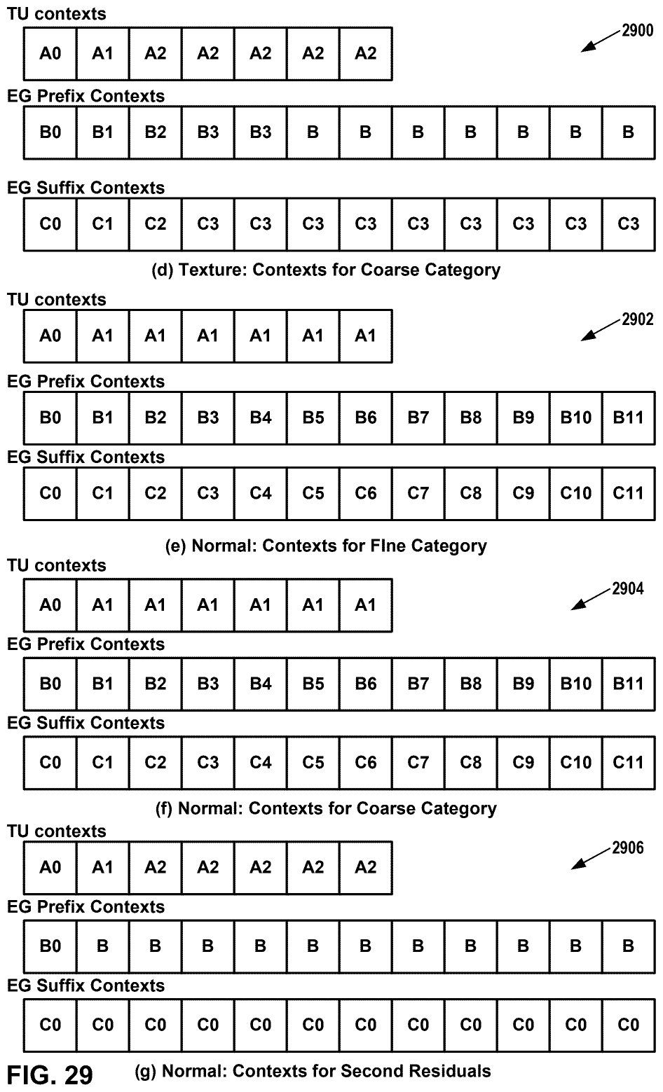

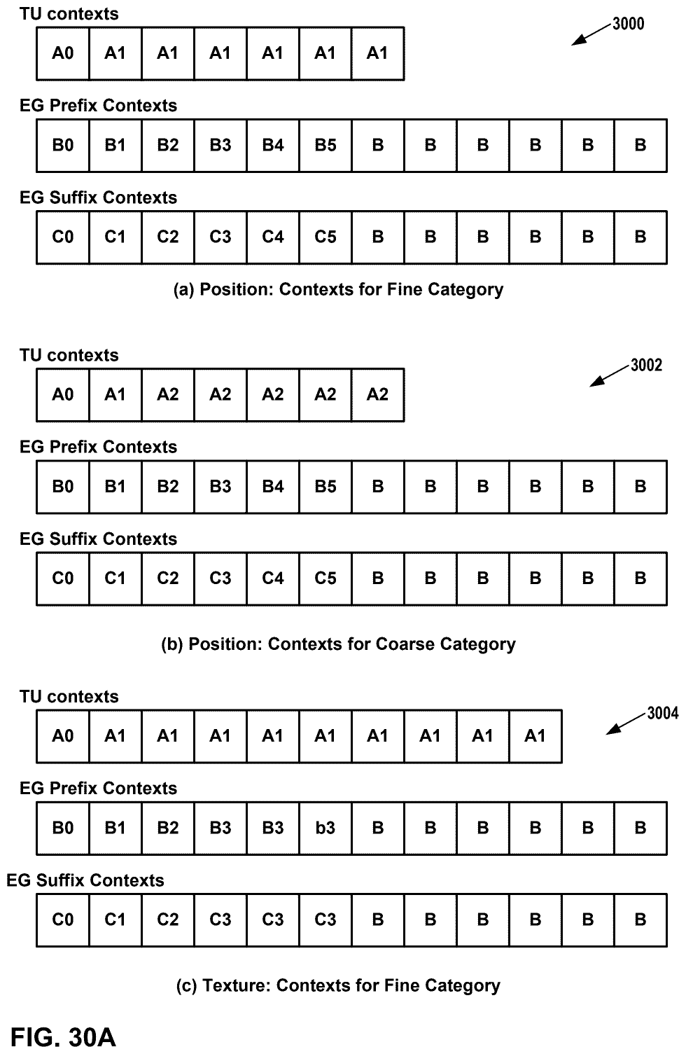

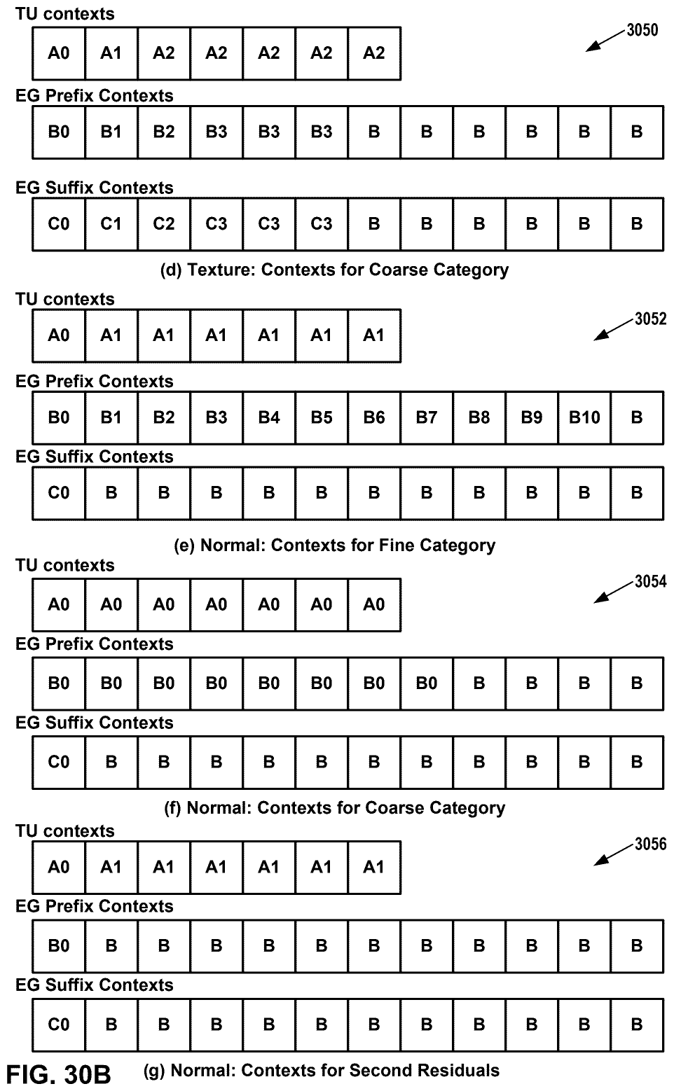

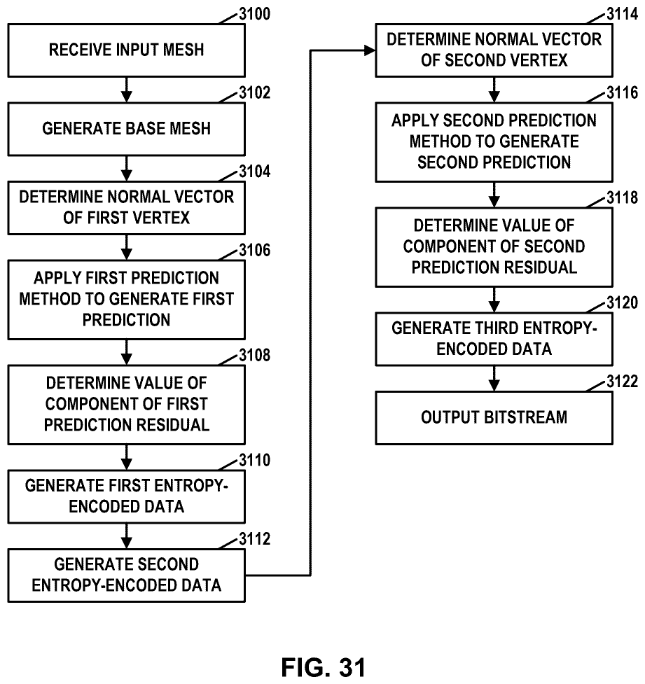

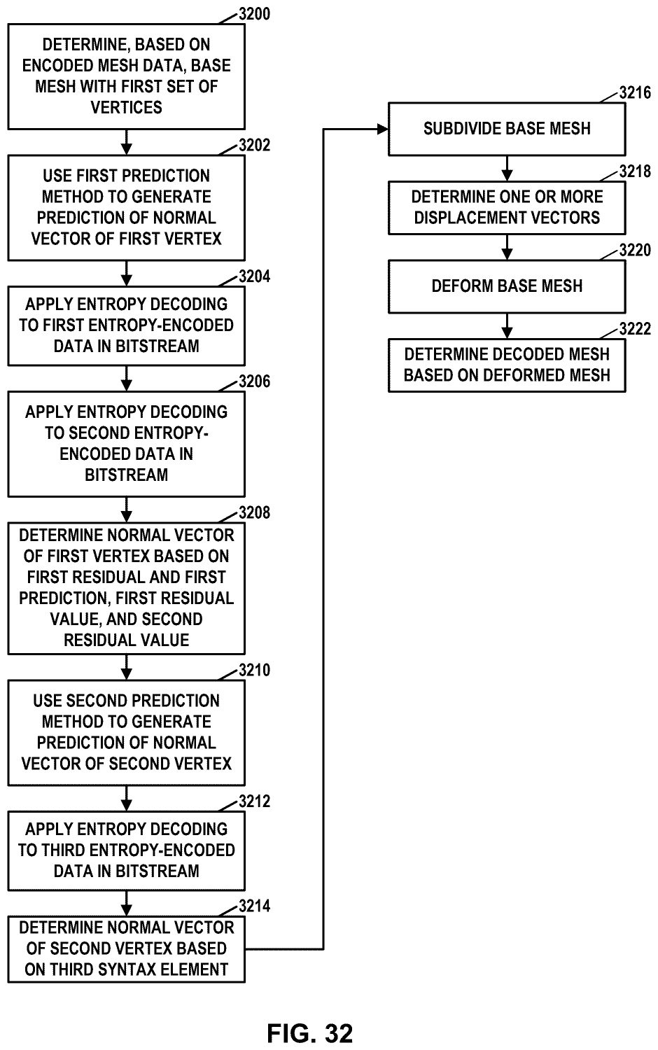

FIG. 22B and FIG. 23B show an alternative example removal of coarse residuals from position and normals, in accordance with techniques of this disclosure.

FIG. 24A and FIG. 25A show example context assignment schemes for context selection for normal attributes, in accordance with techniques of this disclosure.

FIG. 24B and FIG. 25B show alternative context assignment schemes for context selection for normal attributes, in accordance with techniques of this disclosure.

FIG. 23B and FIG. 23B show an alternative example removal of coarse residuals from position + normals, in accordance with techniques of this disclosure.

FIG. 24A and FIG. 25A show an example context update for normal.

FIG. 24B and FIG. 25B show an alternative example context update for normal.

FIG. 26A and FIG. 27A show example context assignment schemes for coarse removal plus context update for normal techniques.

FIG. 26B and FIG. 27B show alternative example context assignment schemes for coarse removal plus context update for normal.

FIG. 28 and FIG. 29 show an example of context employed in static mesh Encoder (Normal part updated).

FIG. 30A and FIG. 30B show the implementation of normal contexts in accordance with one or more techniques of this disclosure.

FIG. 31 is a flowchart illustrating an example operation of a V-DMC encoder in accordance with one or more techniques of this disclosure.

FIG. 32 is a flowchart illustrating an example operation of V-DMC decoder 300 for decoding a mesh from a bitstream that includes encoded mesh data, in accordance with one or more techniques of this disclosure.

### DETAILED DESCRIPTION

A mesh generally refers to a collection of vertices in a three-dimensional (3D) space that collectively represent one or multiple objects in the 3D space. The vertices are connected by edges, and the edges form polygons, which form faces of the mesh. Each vertex may also have one or more associated attributes, such as a texture or a color. In most scenarios, having more vertices produces higher quality, e.g., more detailed and more realistic, meshes. Having more vertices, however, also requires more data to represent the mesh.

To reduce the amount of data needed to represent the mesh, the mesh may be encoded using lossy or lossless encoding. In lossless encoding, the decoded version of the encoded mesh exactly matches the original mesh. In lossy encoding, by contrast, the process of encoding and decoding the mesh causes loss, such as distortion, in the decoded version of the encoded mesh.

In one example of a lossy encoding technique for meshes, a mesh encoder decimates an original mesh to determine a base mesh. To decimate the original mesh, the mesh encoder subsamples or otherwise reduces the number of vertices in the original mesh, such that the base mesh is a rough approximation, with fewer vertices, of the original mesh. The mesh encoder then subdivides the decimated mesh. That is, the mesh encoder estimates the locations of additional vertices in between the vertices of the base mesh. The mesh encoder then deforms the subdivided mesh by moving the vertices in a manner that makes the deformed mesh more closely match the original mesh.

After determining a desired base mesh and deformation of the subdivided mesh, the mesh encoder generates a bitstream that includes data for constructing the base mesh and data for performing the deformation. The data defining the deformation may be signaled as a series of displacement vectors that indicate the movement, or displacement, of the additional vertices determined by the subdividing process. To decode a mesh from the bitstream, a mesh decoder reconstructs the base mesh based on the signaled information, applies the same subdivision process as the mesh encoder, and then displaces the additional vertices based on the signaled displacement vectors.

Vertices of a mesh are associated with attributes. For instance, a vertex may be associated with position attributes (e.g., coordinate values) that specify a spatial position of the vertex. Additionally, a vertex is associated with one or more texture attributes that indicate a texture associated with the vertex. A vertex is also associated with one or more normal vector attributes that indicate a normal vector associated with the vertex. A V-DMC encoder generates syntax elements corresponding to the position attributes, texture attributes, and normal vector attributes. For each position attribute, texture attribute, and normal vector attribute, the V-DMC encoder may generate either or both a coarse residual syntax element and a fine residual syntax element. The coarse residual syntax element specifies a value of a component of a prediction residual the corresponding attribute predicted using a coarse prediction method. The fine prediction method may generate predictions based on more vertices than the coarse prediction method and may therefore generate more accurate predictions. Additionally, for the normal vector attribute, the V-DMC encoder may generate a 2nd residual syntax element that indicates a difference between an actual value of a component of a normal vector of a vertex and a value of the component of the normal vector of the first vertex reconstructed from an octahedral representation of the component of the normal vector of the first vertex.

The V-DMC encoder may generate binarized data representing the syntax element, selecting contexts for individual bins of the binarized data, and apply entropy encoding to the binarized data using the selected contexts. In some examples, binarizing a syntax element involves generating a truncated unary (TU) code and an exponential-Golomb code for the syntax element. The exponential-Golomb code includes a prefix and a suffix. Each context may specify a probability of the bin being 0 and a probability of the bin being 1. To perform entropy coding, an entropy encoder may divide a current range of values (initially 0 to 1) into sub-ranges based on the probabilities specified by the context selected for the bin. The entropy encoder selects one of the sub-ranges based on the value of the bin. The selected sub-range then becomes the current range and the entropy encoder repeats the process for the next bin of the binarized data. In this way, the entropy encoder progressively refines the range. The entropy encoded data is a single value indicating the range at the last bin of the binarized data. An entropy decoder performs the process in reverse. That is, the entropy decoder receives the value indicating the refined range, establishes an initial current range, determines sub-ranges of the current range based a context for a first bin, determines whether the received value is in the first sub-range or the second sub-range, and outputs a binary value based on whether the bin is in the first sub-range or the second sub-range. The entropy decoder repeats this process until a binary value is determined for each bin. The entropy decoder then performs a debinarization process to determine the value of the syntax element. For bins coded in bypass mode, the probability of a bin being 0 and the probability of the bin being 1 are equal.

A V-DMC decoder entropy decodes the binarized data of syntax elements and may determine the position attributes, texture attributes, and normal vector attributes based on the syntax elements. In general terms, the V-DMC decoder reverses the encoding operation performed by the V-DMC encoder.

In existing proposals for V-DMC, the V-DMC encoder and the V-DMC decoder each store and use different contexts for encoding and decoding bins in the TU codes of the binarized syntax elements for TU codes of the binarized data of coarse position syntax elements, fine position syntax elements, coarse texture syntax elements, fine texture syntax elements, coarse normal vector syntax elements, fine normal vector syntax elements, and normal vector 2nd residual syntax elements. Similarly, the V-DMC encoder and the V-DMC decoder store and use different contexts for encoding and decoding the exponential-Golomb prefixes of each of these syntax elements and the exponential-Golomb suffixes of each of these syntax elements. Storing and using each of these contexts may significantly add to complexity of the V-DMC encoder and the V-DMC decoder.

The techniques of this disclosure may address this problem. As described herein, contexts may be shared between normal vector attributes and the other attributes (e.g., position and texture attributes). In some examples, contexts are shared between fine, coarse, and 2nd residuals of normal vector attribute encoding. Thus, in some examples, a V-DMC decoder may decode a mesh from a bitstream that includes the encoded mesh data. As part of decoding the mesh, the V-DMC decoder may determine, based on the encoded mesh data, a base mesh that includes a set of vertices. The V-DMC decoder may use a first prediction method to generate a prediction of a component of a first normal vector of a first vertex in the set of vertices. The V-DMC decoder may apply entropy decoding to first entropy-encoded data in the bitstream to decode first data. The first data is a binarized representation of a first syntax element. The first syntax element indicates a value of a component of a first prediction residual. The value of the component of the first prediction residual indicates a difference between the prediction of the component of the first normal vector and a value of the component of the first normal vector. The first data comprises first truncated unary (TU) data and a first exponential-Golomb code, the first exponential-Golomb code comprising a first prefix and a first suffix. The V-DMC decoder may apply entropy decoding to second entropy-encoded data in the bitstream to decode second data. The second data is a binarized representation of a second syntax element. The second syntax element indicates a second residual value of the component of the normal vector of the first vertex. The second data comprises second TU data and a second exponential-Golomb code, the second exponential-Golomb code comprising a second prefix and a second suffix. The V-DMC decoder may determine the first normal vector based in part on the prediction of the component of the first normal vector, the value of the component of the first prediction residual, and the second residual value of the component of the first normal vector. Additionally, the V-DMC decoder may use a second prediction method to generate a prediction of a component of a second normal vector of a second vertex in the set of vertices. The V-DMC decoder may apply entropy decoding to third entropy-encoded data in the bitstream to decode third data. The third data is a binarized representation of a third syntax element, the third syntax element indicates a value of a component of a second prediction residual. The value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix. V-DMC decoder may determine the normal vector of the second vertex based in part on the prediction of the component of the second normal vector and the value of the component of the second prediction residual. When applying the entropy decoding to the first, second, and third entropy-encoded data, the V-DMC decoder may use a first shared non-bypass context for entropy decoding at least one bin of each of the first TU data, the second TU data, and the third TU data. Thus, the first shared non-bypass context may be reused for the first, second, and third TU data. Other contexts may also be shared for entropy decoding bins of the binarized representations of the first, second, and third syntax elements. Sharing contexts in this way may reduce the complexity of V-DMC decoder. Similar processes and considerations apply with respect to the V-DMC encoder.

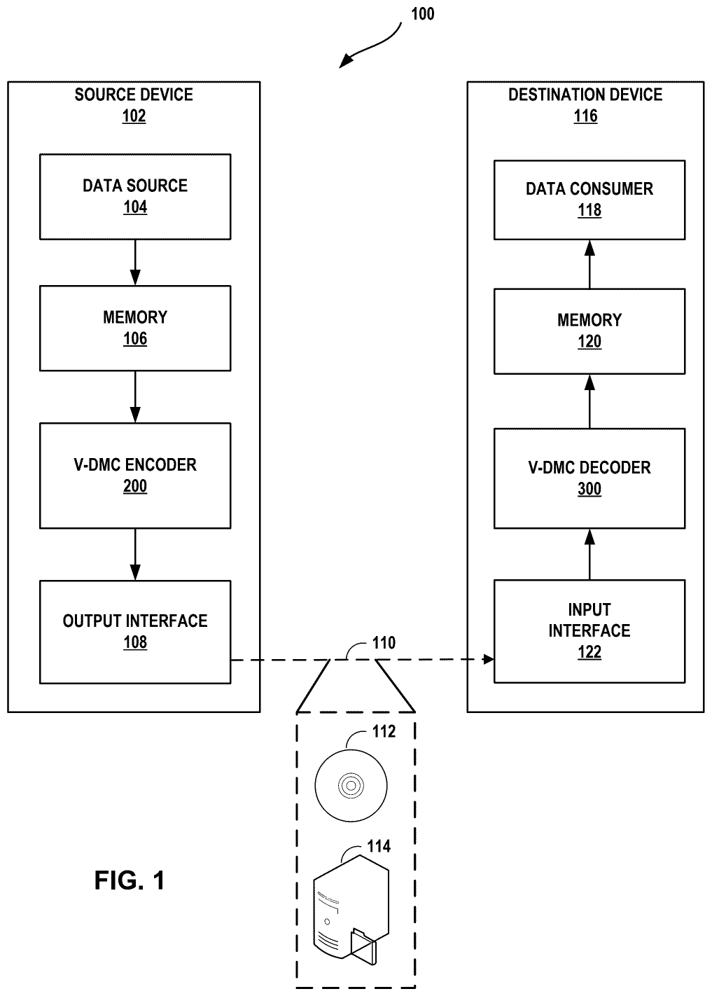

FIG. 1 is a block diagram illustrating an example encoding and decoding system 100 that may perform the techniques of this disclosure. The techniques of this disclosure are generally directed to coding (encoding and/or decoding) meshes. The encoding may be effective in compressing data of the meshes and the decoding may be effective in decompressing encoded data of the meshes.

As shown in FIG. 1, system 100 includes a source device 102 and a destination device 116. Source device 102 provides encoded data to be decoded by a destination device 116. Particularly, in the example of FIG. 1, source device 102 provides the data to destination device 116 via a computer-readable medium 110. Source device 102 and destination device 116 may comprise any of a wide range of devices, including desktop computers, notebook (i.e., laptop) computers, tablet computers, set-top boxes, telephone handsets such as smartphones, televisions, cameras, display devices, digital media players, video gaming consoles, video streaming devices, terrestrial or marine vehicles, spacecraft, aircraft, robots, LIDAR devices, satellites, or the like. In some cases, source device 102 and destination device 116 may be equipped for wireless communication.

In the example of FIG. 1, source device 102 includes a data source 104, a memory 106, a V-DMC encoder 200, and an output interface 108. Destination device 116 includes an input interface 122, a V-DMC decoder 300, a memory 120, and a data consumer 118. In accordance with this disclosure, V-DMC encoder 200 of source device 102 and V-DMC decoder 300 of destination device 116 may be configured to apply the techniques of this disclosure related to displacement vector quantization. Thus, source device 102 represents an example of an encoding device, while destination device 116 represents an example of a decoding device. In other examples, source device 102 and destination device 116 may include other components or arrangements. For example, source device 102 may receive data from an internal or external source. Likewise, destination device 116 may interface with an external data consumer, rather than include a data consumer in the same device.

System 100 as shown in FIG. 1 is merely one example. In general, other digital encoding and/or decoding devices may perform the techniques of this disclosure related to displacement vector quantization. Source device 102 and destination device 116 are merely examples of such devices in which source device 102 generates coded data for transmission to destination device 116. This disclosure refers to a “coding” device as a device that performs coding (encoding and/or decoding) of data. Thus, V-DMC encoder 200 and V-DMC decoder 300 represent examples of coding devices, in particular, an encoder and a decoder, respectively. In some examples, source device 102 and destination device 116 may operate in a substantially symmetrical manner such that each of source device 102 and destination device 116 includes encoding and decoding components. Hence, system 100 may support one-way or two-way transmission between source device 102 and destination device 116, e.g., for streaming, playback, broadcasting, telephony, navigation, and other applications.

In general, data source 104 represents a source of data (e.g., raw, unencoded data) and may provide a sequential series of “frames” of the data to V-DMC encoder 200, which encodes data for the frames. Data source 104 may, for example, execute a framework or platform for generating graphics for video games, augmented reality, simulations, or any other such use case. Data source 104 of source device 102 may include a graphics engine that generates raw mesh data from any combination of one or more sensors configured to obtain real-world data. Examples of such sensors include cameras, 2D scanners, 3D scanners, light detection and ranging (LIDAR) devices, video cameras, ultrasonic sensors, infrared sensors, inertial measurement sensors, sonar sensors, pressure sensors, thermal imaging sensors, magnetic sensors, laser range finders, photodetectors, and the like. In other examples, the graphics engine may generate meshes that are entirely computer generated, i.e., not representative of a real-world scene, using modeling, simulation, animation, generative adversarial networks, and the like. In yet other examples, data source 104 may not include a graphics engine, but instead, may obtain the mesh data from a storage unit or other device.

Regardless of whether the mesh data is based on real-world sensor data, entirely computer generated, obtained from an external source, or some combination thereof, V-DMC encoder 200 encodes the mesh data. V-DMC encoder 200 may rearrange the frames from the received order (sometimes referred to as “display order”) into a coding order for coding. V-DMC encoder 200 may generate one or more bitstreams including encoded data. Source device 102 may then output the encoded data via output interface 108 onto computer-readable medium 110 for reception and/or retrieval by, e.g., input interface 122 of destination device 116.

Memory 106 of source device 102 and memory 120 of destination device 116 may represent general purpose memories. In some examples, memory 106 and memory 120 may store raw data, e.g., raw data from data source 104 and raw, decoded data from V-DMC decoder 300. Additionally or alternatively, memory 106 and memory 120 may store software instructions executable by, e.g., V-DMC encoder 200 and V-DMC decoder 300, respectively. Although memory 106 and memory 120 are shown separately from V-DMC encoder 200 and V-DMC decoder 300 in this example, it should be understood that V-DMC encoder 200 and V-DMC decoder 300 may also include internal memories for functionally similar or equivalent purposes. Furthermore, memory 106 and memory 120 may store encoded data, e.g., output from V-DMC encoder 200 and input to V-DMC decoder 300. In some examples, portions of memory 106 and memory 120 may be allocated as one or more buffers, e.g., to store raw, decoded, and/or encoded data. For instance, memory 106 and memory 120 may store data representing a mesh.

Computer-readable medium 110 may represent any type of medium or device capable of transporting the encoded data from source device 102 to destination device 116. In one example, computer-readable medium 110 represents a communication medium to enable source device 102 to transmit encoded data directly to destination device 116 in real-time, e.g., via a radio frequency network or computer-based network. Output interface 108 may modulate a transmission signal including the encoded data, and input interface 122 may demodulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded data.

In some examples, source device 102 may output encoded data to file server 114 or another intermediate storage device that may store the encoded data generated by source device 102. Destination device 116 may access stored data from file server 114 via streaming or download. File server 114 may be any type of server device capable of storing encoded data and transmitting that encoded data to the destination device 116. File server 114 may represent a web server (e.g., for a website), a File Transfer Protocol (FTP) server, a content delivery network device, or a network-attached storage (NAS) device. Destination device 116 may access encoded data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded data stored on file server 114. File server 114 and input interface 122 may be configured to operate according to a streaming transmission protocol, a download transmission protocol, or a combination thereof.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 comprise wireless components, output interface 108 and input interface 122 may be configured to transfer data, such as encoded data, according to a cellular communication standard, such as 4G, 4G-LTE (Long-Term Evolution), LTE Advanced, 5G, or the like. In some examples where output interface 108 comprises a wireless transmitter, output interface 108 and input interface 122 may be configured to transfer data, such as encoded data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include a SoC device to perform the functionality attributed to V-DMC encoder 200 and/or output interface 108, and destination device 116 may include a SoC device to perform the functionality attributed to V-DMC decoder 300 and/or input interface 122.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

Input interface 122 of destination device 116 receives an encoded bitstream from computer-readable medium 110 (e.g., a communication medium, storage device 112, file server 114, or the like). The encoded bitstream may include signaling information defined by V-DMC encoder 200, which is also used by V-DMC decoder 300, such as syntax elements having values that describe characteristics and/or processing of coded units (e.g., slices, pictures, groups of pictures, sequences, or the like). Data consumer 118 uses the decoded data. For example, data consumer 118 may use the decoded data to determine the locations of physical objects. In some examples, data consumer 118 may comprise a display to present imagery based on meshes.

V-DMC encoder 200 and V-DMC decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of V-DMC encoder 200 and V-DMC decoder 300 may be included in one or more encoders or decoders, either of which may be integrated as part of a combined encoder/decoder (CODEC) in a respective device. A device including V-DMC encoder 200 and/or V-DMC decoder 300 may comprise one or more integrated circuits, microprocessors, and/or other types of devices.

V-DMC encoder 200 and V-DMC decoder 300 may operate according to a coding standard. This disclosure may generally refer to coding (e.g., encoding and decoding) of pictures to include the process of encoding or decoding data. An encoded bitstream generally includes a series of values for syntax elements representative of coding decisions (e.g., coding modes).

This disclosure may generally refer to “signaling” certain information, such as syntax elements. The term “signaling” may generally refer to the communication of values for syntax elements and/or other data used to decode encoded data. That is, V-DMC encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

This disclosure addresses various improvements of context selection for attributes in the basemesh/static-mesh encoder of the video-based coding of dynamic meshes (V-DMC) technology as set forth in V-DMC Test Model v8.0 (TMM v8.0). V-DMC is being standardized in MPEG WG7 (3DGH). In V-DMC, the original mesh is pre-processed and then encoded using a basemesh/static-mesh encoder. The basemesh/static-mesh encoder encodes the connectivity of the mesh triangles as well as the attributes. These attributes may include position/geometry, color, texture, normals, etc. In this disclosure proposes multiple proposals to improve the entropy coding in the static mesh encoder within the V-DMC.

The MPEG working group 6 (WG7), also known as the 3D graphics and haptics coding group (3DGH), is currently standardizing the video-based coding of dynamic mesh representations (V-DMC) targeting XR use cases. The current test model is based on the call for proposals result, Khaled Mammou, Jungsun Kim, Alexandros Tourapis, Dimitri Podborski, Krasimir Kolarov, [V-CG] Apple's Dynamic Mesh Coding CfP Response, ISO/IEC JTC1/SC29/WG7, m59281, April 2022, and encompasses the pre-processing of the input meshes into approximated meshes with typically fewer vertices named the base meshes, which are coded with a static mesh coder (cfr. Draco, etc.). In addition, the encoder may estimate the motion of the base mesh vertices and code the motion vectors into the bitstream. The reconstructed base meshes may be subdivided into finer meshes with additional vertices and, hence, additional triangles. The encoder may refine the positions of the subdivided mesh vertices to approximate the original mesh. The refinements or vertex displacement vectors may be coded into the bitstream. In the current test model, the displacement vectors are wavelet transformed, quantized, and the coefficients are packed into a 2D frame. The sequence of frames is coded with a typical video coder, for example, HEVC or VVC, into the bitstream. In addition, the sequence of texture frames is coded with a video coder.

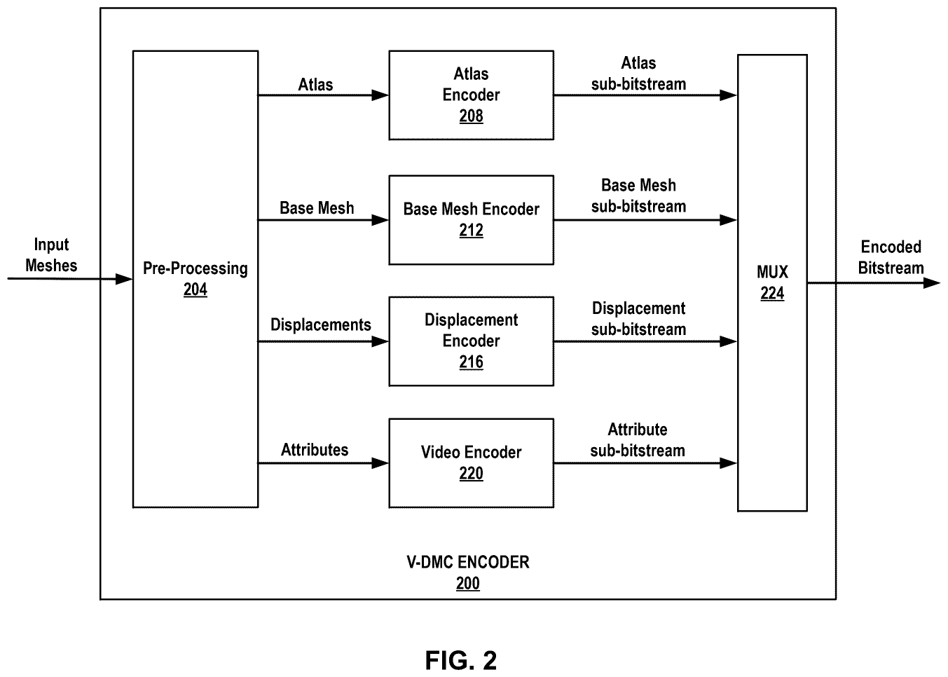

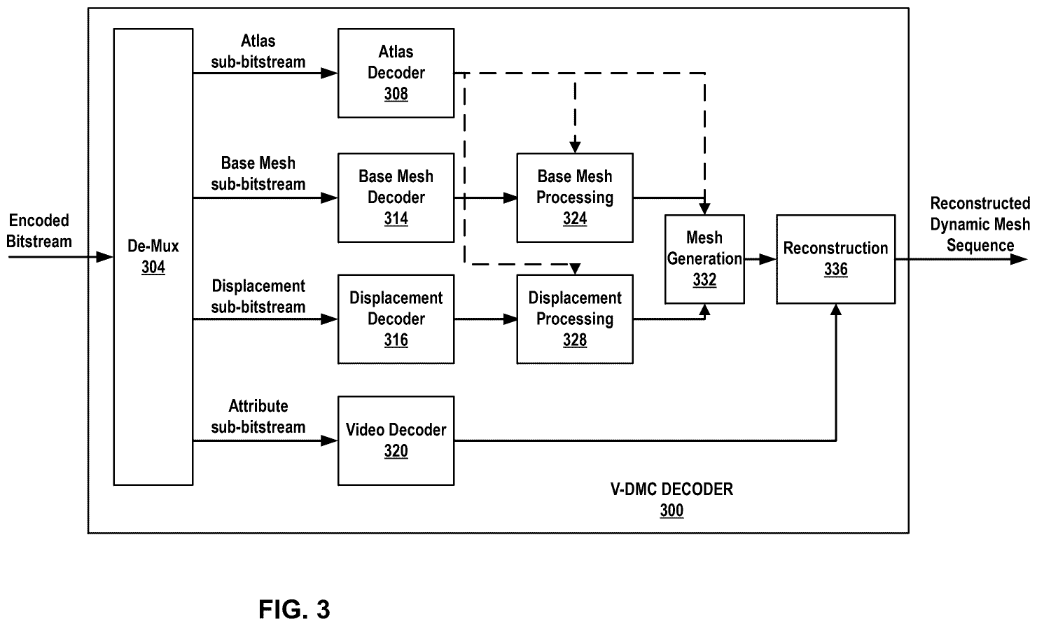

FIGS. 2 and 3 show the overall system model for the current V-DMC test model (TM) encoder (V-DM encoder 200 in FIG. 2) and decoder (V-DMC decoder 300 in FIG. 3) architecture. V-DMC encoder 200 performs volumetric media conversion, and V-DMC decoder 300 performs a corresponding reconstruction. The 3D media is converted to a series of sub-bitstreams: base mesh, displacement, and texture attributes. Additional atlas information is also included in the bitstream to enable inverse reconstruction, as described in N00680.

FIG. 2 shows an example implementation of V-DMC encoder 200. In the example of FIG. 2, V-DMC encoder 200 includes pre-processing unit 204, atlas encoder 208, base mesh encoder 212, displacement encoder 216, and video encoder 220. Pre-processing unit 204 receives an input mesh sequence and generates a base mesh, the displacement vectors, and the texture attribute maps. Base mesh encoder 212 encodes the base mesh. Displacement encoder 216 encodes the displacement vectors, for example as V3C video components or using arithmetic displacement coding. Video encoder 220 encodes attribute components, e.g., texture attribute components such as texture or material information, using any video codec, such as the High Efficiency Video Coding (HEVC) Standard or the Versatile Video Coding (VVC) standard. A multiplexer (MUX) 224 may multiplex the atlas sub-bitstream, the base mesh sub-bitstream, the displacement sub-bitstream, and the attribute sub-bitstream to form an encoded bitstream.

Aspects of V-DMC encoder 200 will now be described in more detail. Pre-processing unit 204 represents the 3D volumetric data as a set of base meshes and corresponding refinement components. This is achieved through a conversion of input dynamic mesh representations into a number of V3C components: a base mesh, a set of displacements, a 2D representation of the texture map, and an atlas. The base mesh component is a simplified low-resolution approximation of the original mesh in the lossy compression and is the original mesh in the lossless compression. The base mesh component can be encoded by base mesh encoder 212 using any mesh codec.

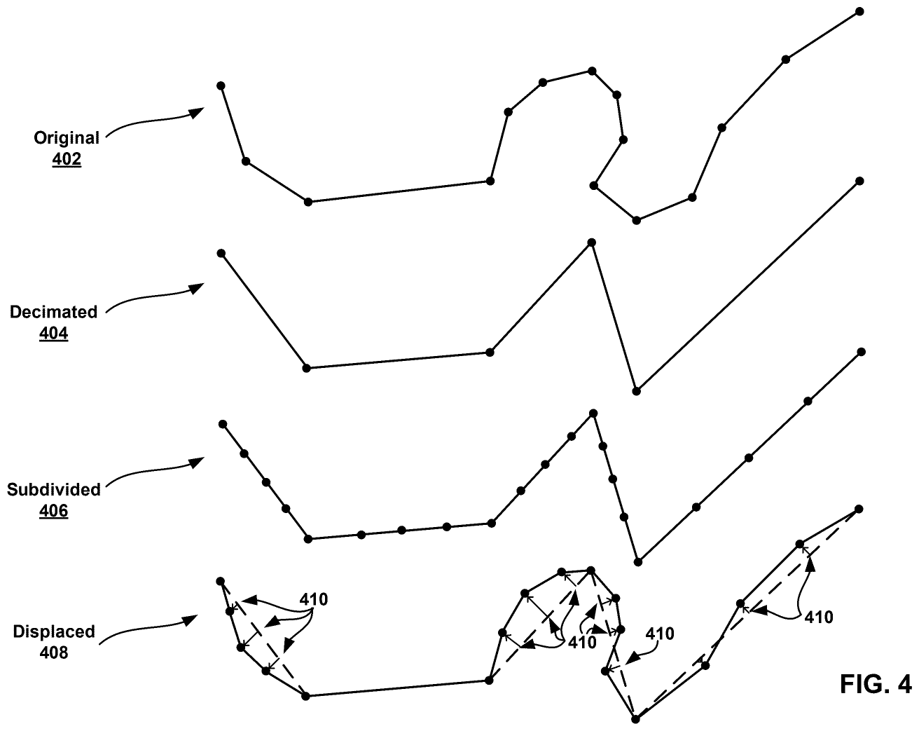

Base mesh encoder 212 is represented as Static Mesh Encoder in FIG. 4 and employs an implementation of the Edgebreaker algorithm, e.g., m63344, for encoding the base mesh where the connectivity is encoded using a CLERS op code, e.g., from Rossignac and Lopes, and the residual of the attribute is encoded using prediction from the previously encoded/decoded vertices' attributes.

Aspects of base mesh encoder 212 will now be described in more detail. One or more submeshes are input to base mesh encoder 212. Submeshes are generated by pre-processing unit 204. Submeshes are generated from original meshes by utilizing semantic segmentation. Each base mesh may include of one or more submeshes.

Base mesh encoder 212 may process connected components. Connected components include of a cluster of triangles that are connected by their neighbors. A submesh can have one or more connected components. Base mesh encoder 212 may encode one “connected component” at a time for connectivity and attributes encoding and then performs entropy encoding on all “connected components”.

Base mesh encoder 212 defines and categorizes the input basemesh into the connectivity and attributes. The geometry and texture coordinates (UV coordinates) are categorized as attributes.

The following is a brief overview of the system and explanation of the terms used throughout V-DMC:

Mesh: This is a 3D data storage format where the 3D data is represented in terms of triangles. The data consists of triangle connectivity and the corresponding attributes.

Mesh Attributes: The attributes can consist of a lot of things per vertex geometry (x,y,z), texture, per-vertex normals, per-vertex color, per-face color, per-face normals, etc.

Texture vs color: Texture is different from the color attribute. A color attribute consists of per-vertex color whereas texture is stored as a texture map (image) and texture coordinates (UV coordinates). Each individual vertex is assigned a UV coordinate that correspond to the (u,v) location on the texture map.

Texture encoding comprises encoding both the per vertex texture coordinates (UV coordinates) and the corresponding texture map. UV coordinates are encoded in the base mesh encoder/static mesh encoder while the texture map is encoded using a video encoder.

Preprocessing: The input mesh sequence first goes through the pre-processing to generate an atlas, base mesh, the displacement vectors, and the attribute maps.

Atlas Encoding: Atlas parameterizations consist of packing 3D mesh into a 2D atlas, i.e., texture mapping. Atlas encoder encodes the information required to parameterize the 3D mesh into a 2D texture map.

Base Mesh/Static Mesh: For lossy encoding, the base mesh may be a simplified mesh with possibly a smaller number of vertices. For lossless encoding, the base mesh is the original mesh with possible simplifications.

Base Mesh Encoder/Static Mesh Encoder: The base mesh is encoded using a base mesh encoder, which may be referred to as a static mesh encoder. The base mesh encoder uses edgebreaker to encode the mesh connectivity and attributes (geometry, texture coordinates (UV coordinates), etc.) in a lossless manner.

Displacement Encoder: Displacements are per-vertex vectors that indicate how the basemesh is transformed/displaced to create the current frame's original mesh. The displacement vectors can be encoded as V3C video component or using arithmetic displacement coding.

Texture Map Encoder: A video encoder is employed to encode the texture map.

Lossless mode: In the lossless mode there are no displacement vectors and the basemesh is not simplified. The basemesh encoder is a lossless encoder so it is sufficient for lossless mode of V-DMC. The texture map is encoded using lossless video encoder. In the lossless mode, the V-DMC operates in all-intra mode.

Lossy mode: In the lossy mode, the basemesh could be a simplified version of the original mesh. Displacement vectors are employed to subdivide and displace the basemesh to obtain reconstructed mesh. The texture map is encoded using lossy video encoder.

Normals: The normals are not currently supported in the V-DMC TMM v7.0. like texture and color, the normals could also be per-vertex normals or they could consist of the normal map with corresponding normal coordinates.

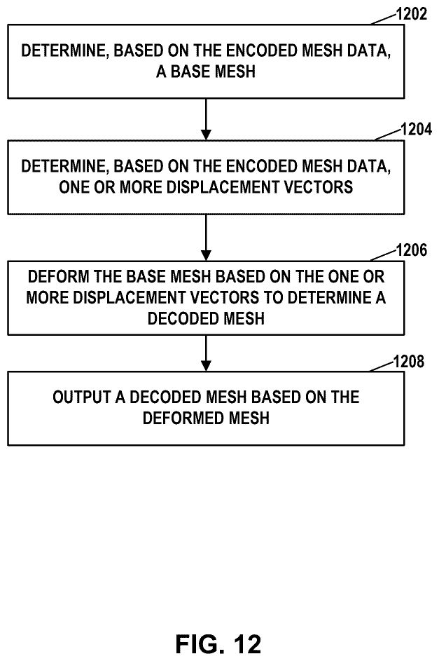

Submesh: The input to a base mesh encoder could be one or more submeshes. Submeshes are generated during the preprocessing step in V-DMC shown in FIG. 12. Submeshes are generated from original mesh by utilizing semantic segmentation. Each base mesh consists of one or more submeshes.

Connected component in the basemesh encoder: connected component consists of a cluster of triangles that are connected by their neighbors. A submesh may have one or more connected components. The current implementation of basemesh encoder encodes one “connected component” at a time for connectivity and attributes encoding and then performs entropy encoding on all “connected components”.

FIG. 3 shows an example implementation of V-DMC decoder 300. In the example of FIG. 3, V-DMC decoder 300 includes demultiplexer 304, atlas decoder 308, base mesh decoder 314, displacement decoder 316, video decoder 320, base mesh processing unit 324, displacement processing unit 328, mesh generation unit 332, and reconstruction unit 336.

Demultiplexer 304 separates the encoded bitstream into an atlas sub-bitstream, a base-mesh sub-bitstream, a displacement sub-bitstream, and a texture attribute sub-bitstream. Atlas decoder 308 decodes the atlas sub-bitstream to determine the atlas information to enable inverse reconstruction. Base mesh decoder 314 decodes the base mesh sub-bitstream, and base mesh processing unit 324 reconstructs the base mesh. Displacement decoder 316 decodes the displacement sub-bitstream, and displacement processing unit 328 reconstructs the displacement vectors. Mesh generation unit 332 modifies the base mesh based on the displacement vector to form a displaced mesh.

Video decoder 320 decodes the texture attribute sub-bitstream to determine the texture attribute map, and reconstruction unit 336 associates the texture attributes with the displaced mesh to form a reconstructed dynamic mesh.

A detailed description of the proposal that was selected as the starting point for the V-DMC standardization can be found in m59281. The following description will detail the displacement vector coding in the current V-DMC test model and WD 2.0.

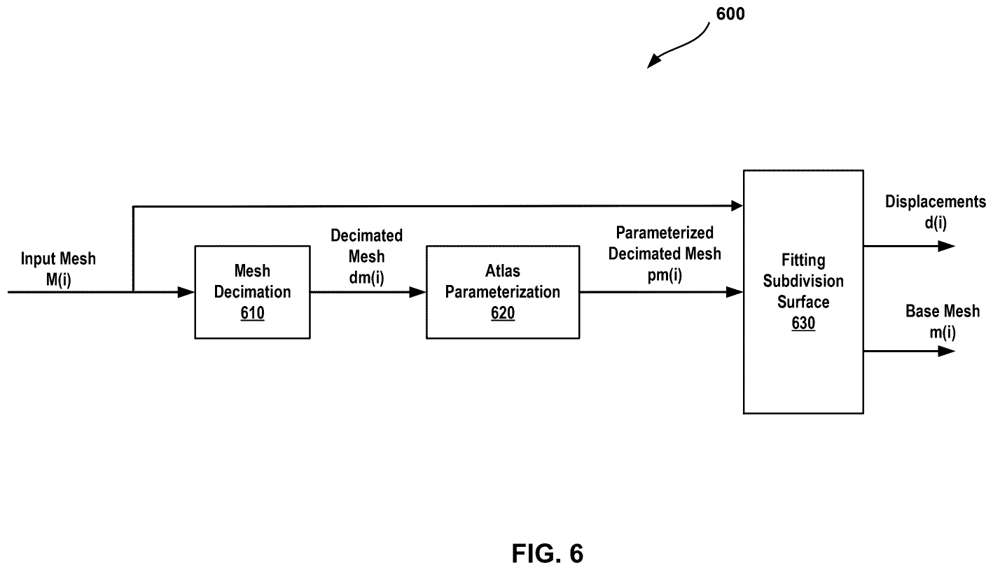

A pre-processing system, such as pre-processing system 204 or pre-processing system 600 described below with respect to FIG. 6, may be configured to perform preprocessing on an input mesh M(i). FIG. 4 illustrates the basic idea behind a pre-processing scheme using a 2D curve. The same concepts may be applied to the input 3D mesh M(i) to produce a base mesh m(i) and a displacement field d(i).

In FIG. 4, the input 2D curve (represented by a 2D polyline), referred to as original curve 402, is first downsampled to generate a base curve/polyline, referred to as the decimated curve 404. A subdivision scheme, such as that described in Garland et al, Surface Simplification Using Quadric Error Metrics (https://www.cs.cmu.edu/˜garland/Papers/quadrics.pdf), is then applied to the decimated polyline to generate a subdivided curve 406. For instance, in FIG. 4, a subdivision scheme using an iterative interpolation scheme is applied. It consists of or comprises inserting at each iteration a new point in the middle of each edge of the polyline. In the example illustrated, two subdivision iterations were applied.

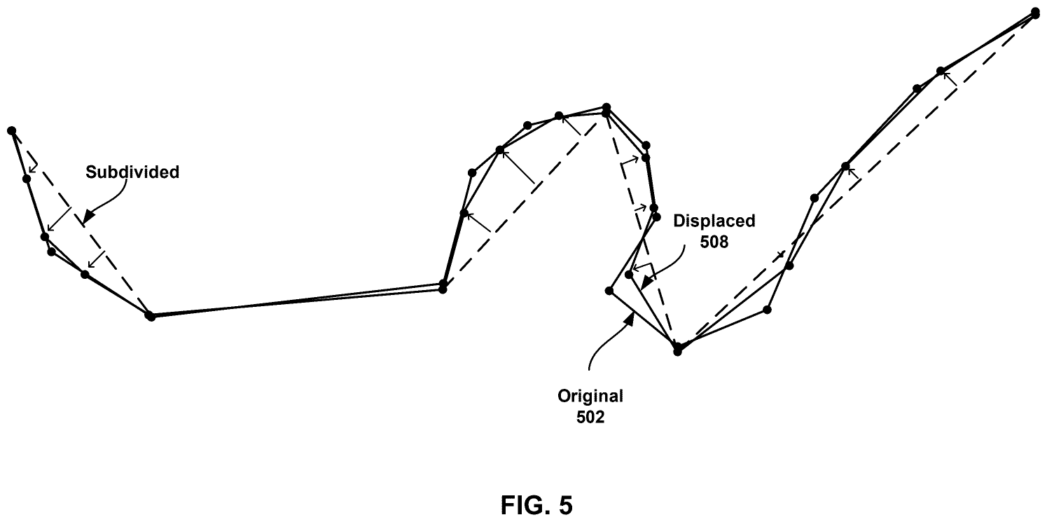

The scheme is independent of the chosen subdivision scheme and may be combined with other subdivision schemes. The subdivided polyline is then deformed, or displaced, to get a better approximation of the original curve. This better approximation is displaced curve 408 in FIG. 4. Displacement vectors (arrows 410 in FIG. 4) are computed for each vertex of the subdivided mesh such that the shape of the displaced curve is as close as possible to the shape of the original curve (see FIG. 5). As illustrated by portion 508 of displaced curve 408 and portion 502 of original curve 402, for example, the displaced curve may not perfectly match the original curve.

An advantage of the subdivided curve is that it has a subdivision structure that allows efficient compression, while it offers a faithful approximation of the original curve. The compression efficiency is obtained thanks to the following properties:
The decimated/base curve has a low number of vertices and requires a limited number of bits to be encoded/transmitted.
The subdivided curve is automatically generated by the decoder once the base/decimated curve is decoded (i.e., no need for any information other than the subdivision scheme type and subdivision iteration count).
The displaced curve is generated by decoding the displacement vectors associated with the subdivided curve vertices. Besides allowing for spatial/quality scalability, the subdivision structure enables efficient transforms such as wavelet decomposition, which can offer high compression performance.

FIG. 6 shows a block diagram of pre-processing system 600 which may be included in V-DMC encoder 200 or may be separate from V-DMC encoder 200. Pre-processing system 600 represents an example implementation of pre-processing unit 204 as described with respect to FIG. 2. In the example of FIG. 6, pre-processing system 600 includes mesh decimation unit 610, atlas parameterization unit 620, and subdivision surface fitting unit 630.

Mesh decimation unit 610 uses a simplification technique to decimate the input mesh M(i) and produce the decimated mesh dm(i). The decimated mesh dm(i) is then re-parameterized by atlas parameterization unit 620, which may for example use the UVAtlas tool. The generated mesh is denoted as pm(i). The UVAtlas tool considers only the geometry information of the decimated mesh dm(i) when computing the atlas parameterization, which is likely sub-optimal for compression purposes. Better parameterization schemes or tools may also be considered with the proposed framework.

Applying re-parameterization to the input mesh makes it possible to generate a lower number of patches. This reduces parameterization discontinuities and may lead to better RD performance. Subdivision surface fitting unit 630 takes as input the re-parameterized mesh pm(i) and the input mesh M(i) and produces the base mesh m(i) together with a set of displacements d(i). First, pm(i) is subdivided by applying the subdivision scheme. The displacement field d(i) is computed by determining for each vertex of the subdivided mesh the nearest point on the surface of the original mesh M(i).

For the Random Access (RA) condition, a temporally consistent re-meshing may be computed by considering the base mesh m(j) of a reference frame with index j as the input for subdivision surface fitting unit 630. This makes it possible to produce the same subdivision structure for the current mesh M′(i) as the one computed for the reference mesh M′(j). Such a re-meshing process makes it possible to skip the encoding of the base mesh m(i) and re-use the base mesh m(j) associated with the reference frame M(j). This may also enable better temporal prediction for both the attribute and geometry information. More precisely, a motion field f(i) describing how to move the vertices of m(j) to match the positions of m(i) is computed and encoded. Note that such time-consistent re-meshing is not always possible. The proposed system compares the distortion obtained with and without the temporal consistency constraint and chooses the mode that offers the best RD compromise.

Note that the pre-processing system is not normative and may be replaced by any other system that produces displaced subdivision surfaces. A possible efficient implementation would constrain the 3D reconstruction unit to directly generate displaced subdivision surface and avoids the need for such pre-processing.

V-DMC encoder 200 and V-DMC decoder 300 may be configured to perform displacements coding. Depending on the application and the targeted bitrate/visual quality, the encoder may optionally encode a set of displacement vectors associated with the subdivided mesh vertices, referred to as the displacement field d(i), as described in this section.

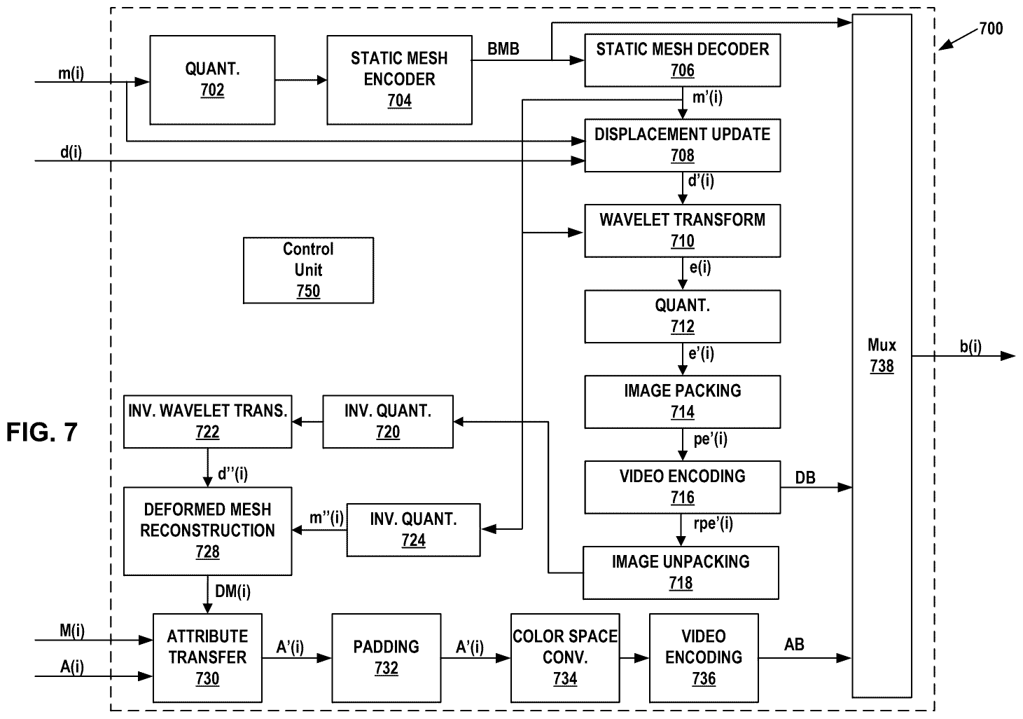

FIG. 7 shows V-DMC encoder 700, which is configured to implement an intra encoding process. V-DMC encoder 700 represents an example implementation of V-DMC encoder 200. FIG. 7 includes the following abbreviations:
m(i)—Base mesh
d(i)—Displacements
m″(i)—Reconstructed Base Mesh
d″(i)—Reconstructed Displacements
A(i)—Attribute Map
A′(i)—Updated Attribute Map
M(i)—Static/Dynamic Mesh
DM(i)—Reconstructed Deformed Mesh
m′(i)—Reconstructed Quantized Base Mesh
d′(i)—Updated Displacements
e(i)—Wavelet Coefficients
e′(i)—Quantized Wavelet Coefficients
pe′(i)—Packed Quantized Wavelet Coefficients
rpe′(i)—Reconstructed Packed Quantized Wavelet Coefficients
AB—Compressed attribute bitstream
DB—Compressed displacement bitstream
BMB—Compressed base mesh bitstream

V-DMC encoder 200 receives base mesh m(i) and displacements d(i), for example from pre-processing system 600 of FIG. 6. V-DMC encoder 200 also retrieves mesh M(i) and attribute map A(i).

Quantization unit 702 quantizes the base mesh, and static mesh encoder 704 encodes the quantized based mesh to generate a compressed base mesh bitstream. A static mesh decoder 706 may decode the static mesh for use by other components of V-DMC encoder 700.

Displacement update unit 708 uses the reconstructed quantized base mesh m′(i) to update the displacement field d(i) to generate an updated displacement field d′(i). This process considers the differences between the reconstructed base mesh m′(i) and the original base mesh m(i). By exploiting the subdivision surface mesh structure, wavelet transform unit 710 applies a wavelet transform to d′(i) to generate a set of wavelet coefficients. The scheme is agnostic of the transform applied and may leverage any other transform, including the identity transform. Quantization unit 712 quantizes wavelet coefficients, and image packing unit 714 packs the quantized wavelet coefficients into a 2D image/video that can be compressed using a traditional image/video encoder in the same spirit as V-PCC to generate a displacement bitstream.

Attribute transfer unit 730 converts the original attribute map A(i) to an updated attribute map that corresponds to the reconstructed deformed mesh DM(i). Padding unit 732 pads the updated attributed map by, for example, filling patches of the frame that have empty samples with interpolated samples that may improve coding efficiency and reduce artifacts. Color space conversion unit 734 converts the attribute map into a different color space, and video encoding unit 736 encodes the updated attribute map in the new color space, using for example a video codec, to generate an attribute bitstream.

Multiplexer 738 combines the compressed attribute bitstream, compressed displacement bitstream, and compressed base mesh bitstream into a single compressed bitstream.

Image unpacking unit 718 and inverse quantization unit 720 apply image unpacking and inverse quantization to the reconstructed packed quantized wavelet coefficients generated by video encoding unit 716 to obtain the reconstructed version of the wavelet coefficients. Inverse wavelet transform unit 722 applies and inverse wavelet transform to the reconstructed wavelet coefficient to determine reconstructed displacements d″(i).

Inverse quantization unit 724 applies an inverse quantization to the reconstructed quantized base mesh m′(i) to obtain a reconstructed base mesh m″(i). Deformed mesh reconstruction unit 728 subdivides m″(i) and applies the reconstructed displacements d″(i) to its vertices to obtain the reconstructed deformed mesh DM(i).

Image unpacking unit 718, inverse quantization unit 720, inverse wavelet transform unit 722, and deformed mesh reconstruction unit 728 represent a displacement decoding loop. Inverse quantization unit 724 and deformed mesh reconstruction unit 728 represent a base mesh decoding loop. V-DMC encoder 700 includes the displacement decoding loop and the base mesh decoding loop so that V-DMC encoder 700 can make encoding decisions, such as determining an acceptable rate-distortion tradeoff, based on the same decoded mesh that a mesh decoder will generate, which may include distortion due to the quantization and transforms. V-DMC encoder 700 may also use decoded versions of the base mesh, reconstructed mesh, and displacements for encoding subsequent base meshes and displacements.

Control unit 750 generally represents the decision-making functionality of V-DMC encoder 700. During an encoding process, control unit 750 may, for example, make determinations with respect to mode selection, rate allocation, quality control, and other such decisions.

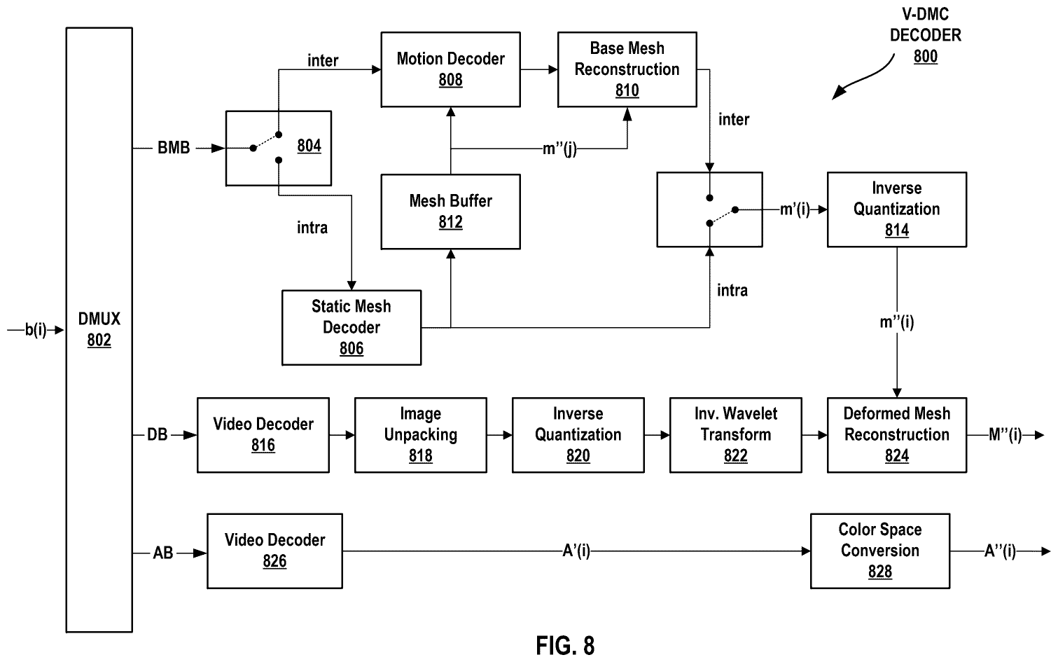

FIG. 8 shows V-DMC decoder 800, which may be configured to perform either intra- or inter-decoding. V-DMC decoder 800 represents an example implementation of V-DMC decoder 300. The processes described with respect to FIG. 8 may also be performed, in full or in part, by V-DMC encoder 200.

V-DMC decoder 800 includes demultiplexer (DMUX) 802, which receives compressed bitstream b (i) and separates the compressed bitstream into a base mesh bitstream (BMB), a displacement bitstream (DB), and an attribute bitstream (AB). Mode select unit 804 determines if the base mesh data is encoded in an intra mode or an inter mode. If the base mesh is encoded in an intra mode, then static mesh decoder 806 decodes the mesh data without reliance on any previously decoded meshes. If the base mesh is encoded in an inter mode, then motion decoder 808 decodes motion, and base mesh reconstruction unit 810 applies the motion to an already decoded mesh (m″(j)) stored in mesh buffer 812 to determine a reconstructed quantized base mesh (m′(i))). Inverse quantization unit 814 applies an inverse quantization to the reconstructed quantized base mesh to determine a reconstructed base mesh (m″(i))

Video decoder 816 decodes the displacement bitstream to determine a set or frame of quantized transform coefficients. Image unpacking unit 818 unpacks the quantized transform coefficients. For example, video decoder 816 may decode the quantized transform coefficients into a frame, where the quantized transform coefficients are organized into blocks with particular scanning orders. Image unpacking unit 818 converts the quantized transform coefficients from being organized in the frame into an ordered series. In some implementations, the quantized transform coefficients may be directly coded, using a context-based arithmetic coder for example, and unpacking may be unnecessary.

Regardless of whether the quantized transform coefficients are decoded directly or in a frame, inverse quantization unit 820 inverse quantizes, e.g., inverse scales, quantized transform coefficients to determine de-quantized transform coefficients. Inverse wavelet transform unit 822 applies an inverse transform to the de-quantized transform coefficients to determine a set of displacement vectors. Deformed mesh reconstruction unit 824 deforms the reconstructed base mesh using the decoded displacement vectors to determine a decoded mesh (M″(i)).

Video decoder 826 decodes the attribute bitstream to determine decoded attribute values (A′(i)), and color space conversion unit 828 converts the decoded attribute values into a desired color space to determine final attribute values (A″(i)). The final attribute values correspond to attributes, such as color or texture, for the vertices of the decoded mesh.

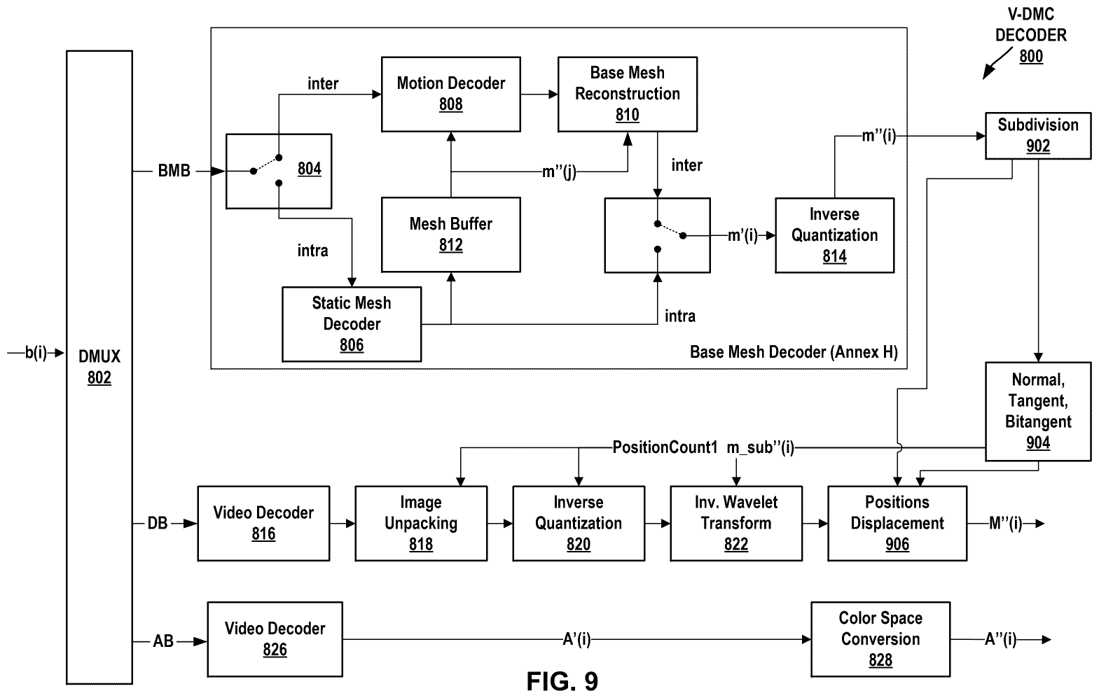

FIG. 9 shows a block diagram illustrating another example of V-DMC decoder 800. In the example of FIG. 9, the reconstructed base mesh (m″(i)) generated by inverse quantization unit 814 may be subdivided into subdivided meshes by a subdivision unit 902. A normal, tangent, and bitangent unit 904 may calculate normal, tangent, and bitangent vectors for the subdivided meshes. Normal, tangent, and bitangent unit 904 may also determine a position count value (m_sub″(i) value that may be used by image unpacking unit 818, inverse quantization unit 820, inverse wavelet transform unit 822. A positions displacement unit 906 may generate decoded mesh (m″(j)) based on output of inverse wavelet transform unit 822, the subdivided meshes, and the normal, tangent, and bitangent vectors.

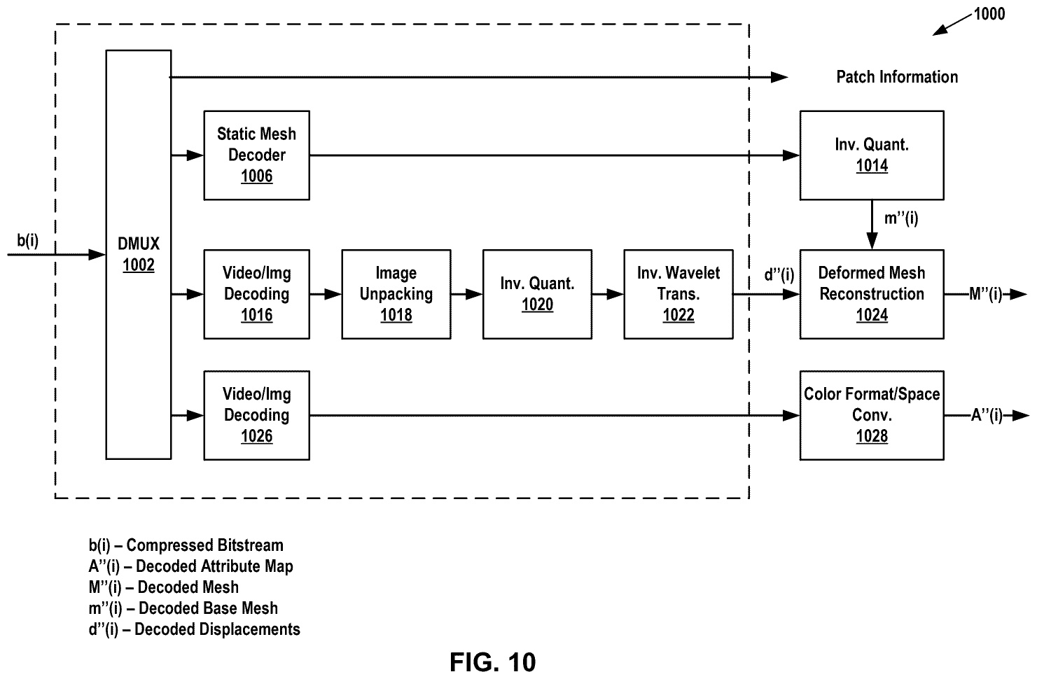

FIG. 10 shows a block diagram of an intra decoder 1000 which may, for example, be part of V-DMC decoder 300. In the example of FIG. 10, de-multiplexer (DMUX) 1002 separates compressed bitstream (bi) into a mesh sub-stream, a displacement sub-stream for positions and potentially for each vertex attribute, zero or more attribute map sub-streams, and an atlas sub-stream containing patch information in the same manner as in V3C/V-PCC.

De-multiplexer 1002 feeds the mesh sub-stream to static mesh decoder 1006 to generate the reconstructed quantized base mesh m′(i). Inverse quantization unit 1014 inverse quantizes the base mesh to determine the decoded base mesh m″(i). Video/image decoding unit 1016 decodes the displacement sub-stream, and image unpacking unit 1018 unpacks the image/video to determine quantized transform coefficients, e.g., wavelet coefficients. Inverse quantization unit 1020 inverse quantizes the quantized transform coefficients to determine dequantized transform coefficients. Inverse transform unit 1022 generates the decoded displacement field d″(i) by applying the inverse transform to the unquantized coefficients. Deformed mesh reconstruction unit 1024 generates the final decoded mesh (M″(i)) by applying the reconstruction process to the decoded base mesh m″(i) and by adding the decoded displacement field d″(i). The attribute sub-stream is directly decoded by video/image decoding unit 1026 to generate an attribute map A″(i). Color format/space conversion unit 1028 may convert the attribute map into a different format or color space.

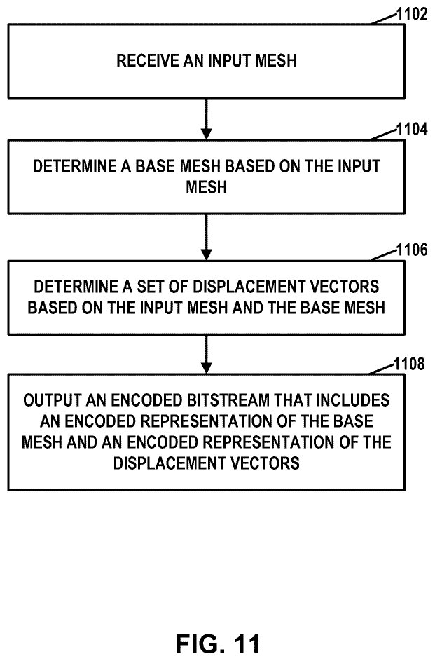

FIG. 11 is a flowchart illustrating an example process for encoding a mesh. Although described with respect to V-DMC encoder 200 (FIGS. 1 and 2), it should be understood that other devices may be configured to perform a process similar to that of FIG. 11. In the example of FIG. 11, V-DMC encoder 200 receives an input mesh (1102). V-DMC encoder 200 determines a base mesh based on the input mesh (1104). V-DMC encoder 200 determines a set of displacement vectors based on the input mesh and the base mesh (1106). V-DMC encoder 200 outputs an encoded bitstream that includes an encoded representation of the base mesh and an encoded representation of the displacement vectors (1108). V-DMC encoder 200 may additionally determine attribute values from the input mesh and include an encoded representation of the attribute values vectors in the encoded bitstream.

FIG. 12 is a flowchart illustrating an example process for decoding a compressed bitstream of mesh data. Although described with respect to V-DMC decoder 300 (FIGS. 1 and 3), it should be understood that other devices may be configured to perform a process similar to that of FIG. 12.

In the example of FIG. 12, V-DMC decoder 300 determines, based on the encoded mesh data, a base mesh (1202). V-DMC decoder 300 determines, based on the encoded mesh data, one or more displacement vectors (1204). V-DMC decoder 300 deforms the base mesh using the one or more displacement vectors (1206). For example, the base mesh may have a first set of vertices, and V-DMC decoder 300 may subdivide the base mesh to determine an additional set of vertices for the base mesh. To deform the base mesh, V-DMC decoder 300 may modify the locations of the additional set of vertices based on the one or more displacement vectors. V-DMC decoder 300 outputs a decoded mesh based on the deformed mesh (1208). V-DMC decoder 300 may, for example, output the decoded mesh for storage, transmission, or display.

Working Group 7 (WG7), often referred to as the 3D Graphics and Haptics Coding Group (3DGH), is presently engaged in standardizing the video-based dynamic mesh coding (V-DMC) for XR applications. The current testing model, derived from the April 2022 call for proposals, involves preprocessing input meshes into possibly simplified versions called “base mesh.” This base mesh could contain fewer vertices and is encoded using a base mesh coder also called a static mesh coder. The preprocessing also generates displacement vectors as well as attribute map that are both separately encoded using a video encoder and/or arithmetic encoder. If the mesh is encoded in a lossless manner, then the base mesh is no longer a simplified version and is used to encode the original mesh. For the lossless manner, the V-DMC TMM v8.0 tool operates in intra-mode where the base mesh encoder becomes the primary encoding method.

The base mesh encoder encodes the connectivity of the mesh as well as the attributes associated with each vertex which typically involves the position and the texture coordinates (UV coordinates). The position consists of 3D coordinates (x,y,z) of the vertex while the texture is stored as a 2D UV coordinate (u,v) also called texture coordinates that points to the texture map image pixel location. The base mesh in V-DMC is encoded using a certain implementation of edgebreaker algorithm where the connectivity is encoded using a CLERS op code using edgebreaker traversal and the residual of the attribute is encoded using prediction from the previously encoded/decoded vertices. The attributes for a mesh can be per-vertex or per-face.

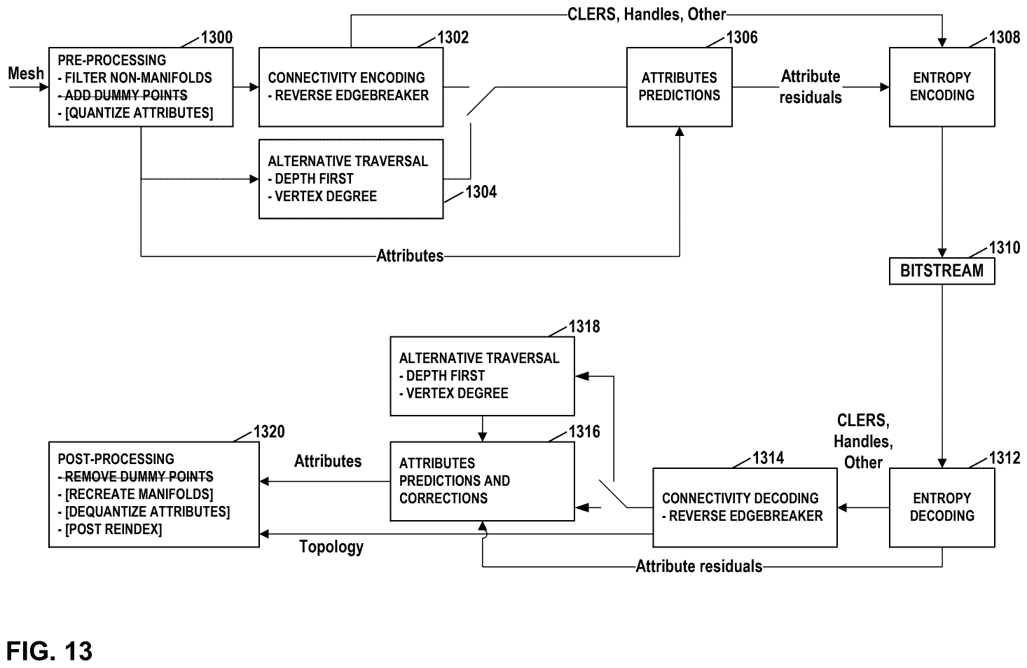

FIG. 13 shows an example overview of a complete Edgebreaker mesh codec using reverse mode in V-DMC v7.0. In other words, FIG. 13 illustrates the end-to-end mesh codec based on Edgebreaker comprising the following primary steps for encoding:
Pre-processing (1300): Initially, a pre-processing is performed to rectify potential connectivity issues in the input mesh, such as non-manifold edges and vertices. This step is crucial because the EdgeBreaker algorithm employed cannot operate with such connectivity problems. Addressing non-manifold issues may involve duplicating some vertices, which are tracked for later merging during decoding. This optimization reduces the number of points in the decoded mesh but necessitates additional information in the bitstream. Dummy points are also added in this pre-processing phase to fill potential surface holes, which EdgeBreaker does not handle. The holes are subsequently encoded by generating “virtual” dummy points by encoding dummy triangles attached to them, without requiring 3D position encoding. If needed, the vertex attributes are quantized in the pre-processing.
Connectivity Encoding (1302): Next, the mesh's connectivity is encoded using a modified Edgebreaker algorithm, generating a CLERS table along with other memory tables used for attribute prediction. In some cases, an alternative traversal algorithm (1304) is applied, such as a depth first traversal algorithm or a vertex degree traversal algorithm.
Attribute Prediction (1306): Vertex attributes are predicted, starting with geometry position attributes, and extending to other attributes, some of which may rely on position predictions, such as texture UV coordinates.
Bitstream Configuration: Finally, configuration and metadata are included in the bitstream (1310). This includes the entropy coding (1308) of CLERS tables and attribute prediction residuals.

FIG. 13 also illustrates the following primary steps for decoding:
The decoding process commences with the entropy decoding (1312) of all entropy-coded sub-bitstreams.
Mesh connectivity is reconstructed (1314) using the CLERS table and the Edgebreaker algorithm, with additional information to manage handles that describe topology.
Vertex positions are predicted (1316) using the mesh connectivity and a minimal set of 3D coordinates. Subsequently, attribute residuals are applied to correct the predictions and obtain the final vertex positions. Other attributes are then decoded (1318), potentially relying on the previously decoded positions, as is the case with UV coordinates. The connectivity of attributes using separate index tables is reconstructed using binary seam information that is entropy coded on a per-edge basis.
In a post-processing stage (1320), dummy triangles are removed. Optionally, non-manifold issues are recreated if the codec is configured for lossless coding. Vertex attributes are also optionally dequantized if they were quantized during encoding.

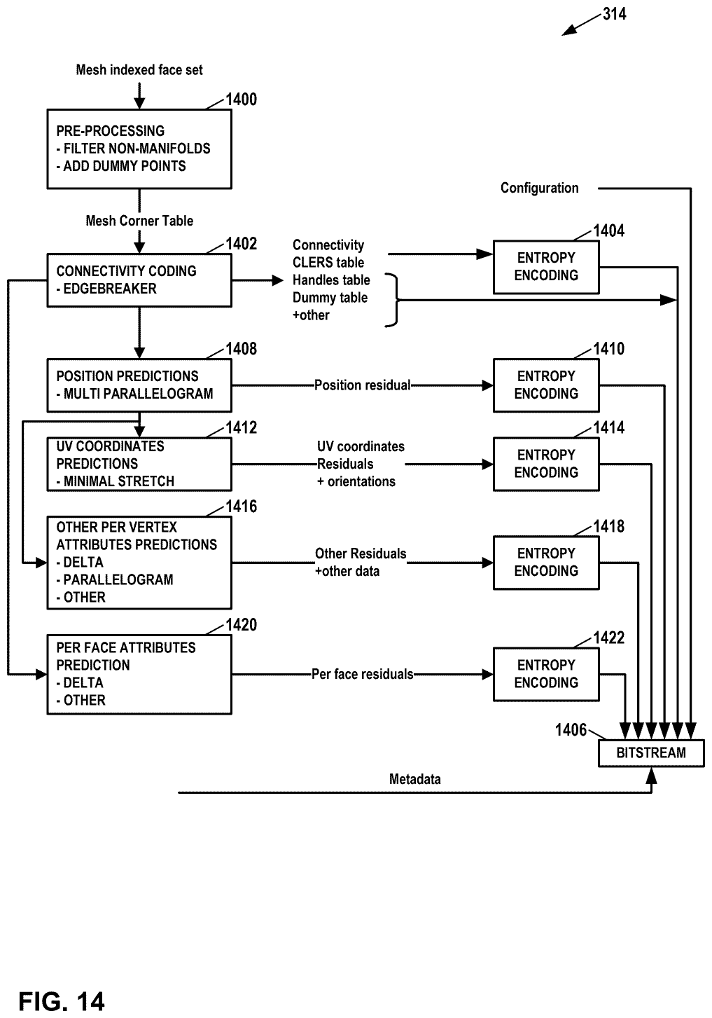

FIG. 14 shows an example detailed overview of base mesh encoder 212. The V-DMC software first represents the 3D volumetric data as a set of base mesh and its corresponding refinement components. This is achieved through first a conversion of an input dynamic mesh representation into a plurality of V3C components, including a base mesh, a set of displacements, a 2D representation of the attributes, and an atlas (see FIG. 2). The base mesh component may be a simplified low-resolution approximation of the original mesh. Base mesh encoder 212 may encode the base mesh component using any mesh codec. Thus, in the example of FIG. 14, base mesh encoder 212 receives a base mesh (e.g., a mesh indexed face set). The mesh indexed face set is a set of indexed faces (i.e., faces to which index values have been assigned).

Base mesh encoder 212 may apply one or more pre-processing operations to the mesh indexed face set (1400). The pre-processing operations may include filtering non-manifolds, adding dummy points, and/or other operations. An output of the pre-processing operations may include a mesh corner table. A mesh corner table organizes a mesh into a structure where each triangle has three corners, each of which is associated with a specific vertex.

Pre-processing is performed to rectify potential connectivity issues in the input mesh (i.e., the mesh indexed face set), such as non-manifold edges and vertices. The EdgeBreaker algorithm employed cannot operate with such connectivity problems. Addressing non-manifold issues may involve duplicating some vertices, which are tracked for later merging during decoding. This optimization may reduce the number of points in the decoded mesh but may necessitate additional information in the bitstream. Base mesh encoder 212 may also add dummy points in the pre-processing phase to fill potential surface holes, which the EdgeBreaker algorithm does not handle. The holes are subsequently encoded by generating “virtual” dummy points by encoding dummy triangles attached to them, without requiring 3D position encoding. If needed, base mesh encoder 212 quantizes the vertex attributes in the pre-processing.

Additionally, base mesh encoder 212 may perform connectivity encoding using an Edgebreaker algorithm (1402). The Edgebreaker algorithm traverses the mesh corner table and encodes each triangle with a sequence of symbols, denoted as C, L, E, R, and S (i.e., CLERS symbols). The CLERS symbols represent connectivity relationships between triangles. The Edgebreaker algorithm may output a connectivity CLERS table containing CLERs symbols, a handles table, a dummy table, and other data. In some examples, base mesh encoder 212 may encode the mesh's connectivity using a modified Edgebreaker algorithm, generating a CLERS table along with other memory tables used for attribute prediction. Base mesh encoder 212 (which may also be referred to as a static mesh encoder) may employ a specific implementation of the Edgebreaker for encoding the base mesh where the connectivity is encoded using a CLERS op code, as described in Jean-Eudes Marvie, Olivier Mocquard, [V-DMC][EE4.4] An efficient reverse edge breaker mode for MEB, ISO/IEC JTC1/SC29/WG7, m65920, January 2024, and J. Rossignac, “3D compression made simple: Edgebreaker with ZipandWrap on a corner-table,” in Proceedings International Conference on Shape Modeling and Applications, Genova, Italy, 2001, and the residual of the attribute is encoded using prediction schemes from the previously encoded/decoded vertices. Base mesh encoder 212 may apply entropy encoding (1404) to syntax elements representing the connectivity CLERs table.

Additionally, base mesh encoder 212 may predict vertex attributes, starting with geometry position attributes, and extending to other attributes, some of which may rely on position predictions, such as texture UV coordinates. Specifically, in the example of FIG. 14, base mesh encoder 212 may perform position prediction (1408). In other words, base mesh encoder 212 may apply prediction methods to generate predictors for positions of vertices. For instance, base mesh encoder 212 may use a multi-parallelogram prediction method to generate predictors for components (e.g., x, y, z components) of positions of vertices. Base mesh encoder 314 may then determine position residuals based on differences between the actual components of the positions of the vertices and the predictors for the components of positions of the vertices.

Base mesh encoder 314 may include configuration and metadata in the bitstream. This may include the entropy coding of CLERS tables and attribute prediction residuals. Specifically, in the example of FIG. 14, base mesh encoder 212 may include the entropy encoded syntax elements representing the connectivity CLERs table and syntax elements representing the handles table, dummy table, and other data in a bitstream 1406. Base mesh encoder 212 may apply entropy encoding (1410) to syntax elements representing the components of the positions of the vertices. Base mesh encoder 212 may include the entropy encoded syntax elements representing the components of the positions of the vertices in bitstream 1406.

Base mesh encoder 212 may also perform UV coordinate prediction (1412) and entropy encode (1414) the resulting UV coordinates, residuals and orientations. Base mesh encoder 212 may generate predictions other per vector attributes, using delta prediction, parallelogram prediction, or other types of prediction (1416). Base mesh encoder 212 may entropy encode the other residuals and other data (1418). Base mesh encoder 212 may also perform per-face attribute prediction, e.g., using delta prediction or one or more other prediction methods (1420). Base mesh encoder 212 may entropy encode resulting per-face residuals (1422).

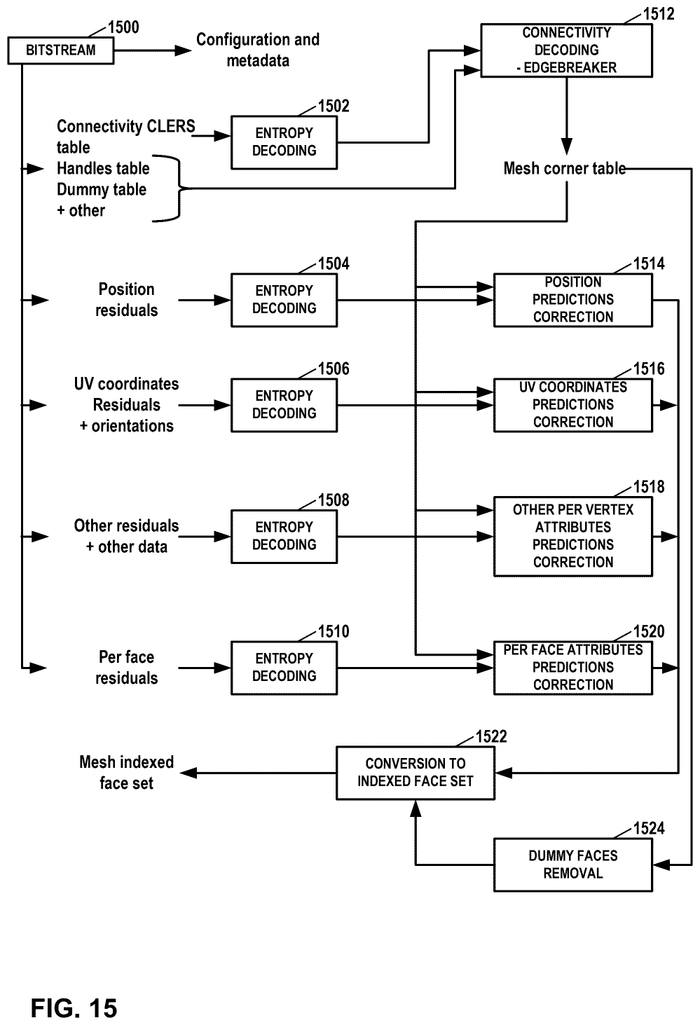

FIG. 15 shows an example detailed overview of base mesh decoder 314. Base mesh decoder 314 may receive a bitstream 1500. The decoding process commences with the decoding of all entropy-encoded sub-bitstreams. Thus, in the example of FIG. 15, base mesh decoder 314 may apply entropy decoding (1502) to obtain a connectivity CLERS table, apply entropy decoding (1504) to obtain position residuals, apply entropy decoding (1506) to obtain UV coordinate residuals and orientations, apply entropy decoding (1508) to obtain other residuals and data, and apply entropy decoding (1510) to obtain per face residuals.

Base mesh decoder 314 may reconstruct mesh connectivity using the CLERS table and the Edgebreaker algorithm (1512), with additional information to manage handles that describe topology. Additionally, base mesh decoder 314 may predict vertex positions using the mesh connectivity and a minimal set of 3D coordinates (1514). Subsequently, base mesh decoder 314 may apply attribute residuals to correct the predictions and obtain the final vertex positions. Base mesh decoder 314 may then decode other attributes, potentially relying on the previously decoded positions, as is the case with UV coordinates (1516), (1518), (1520). Base mesh decoder 314 may reconstruct the connectivity of attributes using separate index tables using binary seam information that is entropy coded on a per-edge basis.

In a post-processing stage, base mesh decoder 314 may remove dummy triangles (1524). Optionally, base mesh decoder 314 recreates non-manifold issues if the codec is configured for lossless coding. Optionally, base mesh decoder 314 may also dequantize vertex attributes if the vertex attributes were quantized during encoding. Base mesh decoder 314 may convert the triangles into an indexed face set (1522). The basemesh encoder 212 may define and categorize the input basemesh into the connectivity and attributes. The geometry and texture coordinates (UV coordinates) are categorized as attributes.

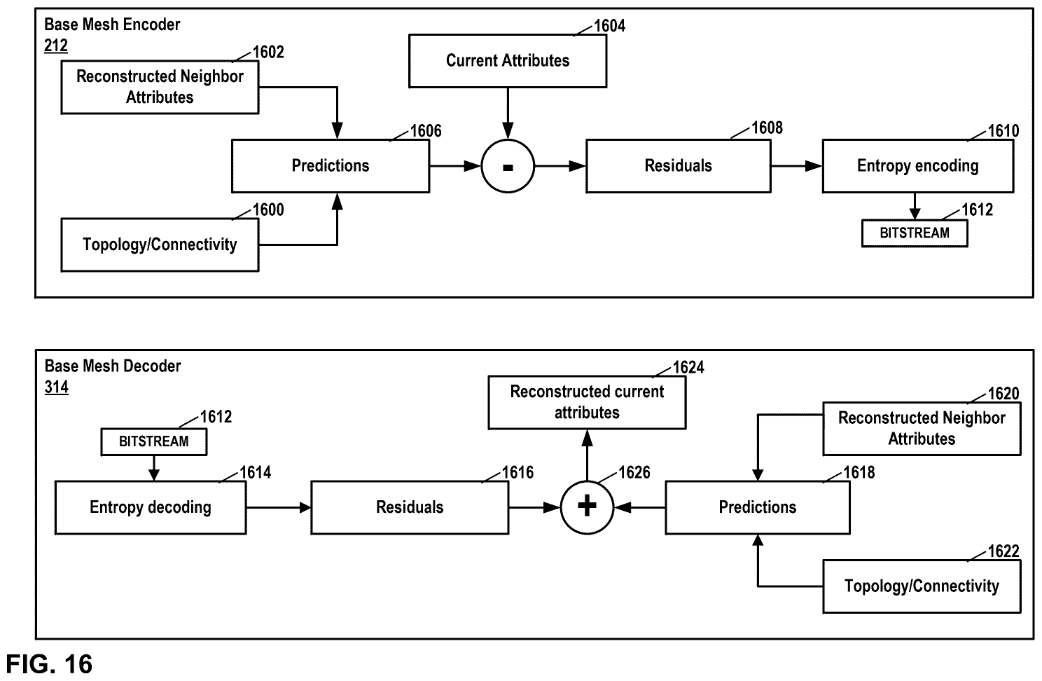

FIG. 16 shows an architecture of base mesh encoder 200 and V-DMC decoder 300 for attribute encoding/decoding within the basemesh encoder (also referred to as static mesh encoder and/or Edgebreaker). Base mesh encoder 200 encodes both the attributes and the connectivity of the triangles and vertices. The attributes are typically encoded using a prediction scheme to predict the vertex attribute using previously visited/encoded/decoded vertices. Then the prediction is subtracted from the actual attribute value to obtain the residual. Finally, the residual attribute value is encoded using an entropy encoder to obtain the encoded base mesh attribute bitstream. The attribute bitstream which contains vertex attribute usually has the geometry/position attribute and the UV coordinates (texture attribute) but can contain any number of attributes like per vertex RGB values, etc.

The attribute encoding procedure in base mesh encoder 212 is shown in FIG. 16 and includes:
Topology/Connectivity (1600): The topology in the basemesh is encoded through the edgebreaker using the CLERS op code. This contains not just the connectivity information but also the data structure for the mesh (current implementation employs corner table). The topology/connectivity information is employed to find the neighboring vertices.
Attributes: These include Geometry (3D coordinates), UV Coordinates (Texture), Normals, RGB values, etc.
Neighboring attributes (1602): These are the attributes of the neighboring vertices that are employed to predict the current vertex's attribute.
Current attribute (1604): This is the attribute of the current vertex that is being encoded/decoded. The attribute of the current vertex is typically predicted using neighboring attributes. Then the residual of the current vertex attribute is encoded.
Predictions (1606): These predictions could be obtained from the connectivity and/or from the previously visited/encoded/decoded vertices. E.g., multi-parallelogram method for geometry, min stretch scheme for UV coordinates, etc. Each attribute may have its own prediction schemes.
Residuals (1608). These are obtained by subtracting the predictions from original attributes. (e.g., residuals=current_vertex_attribute−predicted_attribute)
Entropy Encoding (1610). The residuals are entropy encoded to obtain a bitstream 1612.

Thus, attribute encoding uses a prediction scheme to find the residuals between the predicted and actual attributes. The residuals are entropy encoded into a base mesh attribute bitstream 1612. Each attribute may be encoded differently. The geometry for 3D position and the UV coordinates for the texture are both encoded using prediction methods. To compute these predictions, a multi-parallelogram technique may be utilized for geometry encoding while a min stretch method may be employed for UV coordinates encoding.

Base mesh encoder 212 may encode normal vectors using an octahedral representation. The normal vectors (i.e., normals) are perpendicular to a surface of a mesh. In general, a rendering process may use the normal vectors to determine the orientation of the surface and to apply shading. In 3D modeling, the normal vectors play a role in generating realistic-looking objects. For example, the normal vectors help to define the shape of the object and how the shape interacts with light. Normal vectors may also be used in computer graphics to create smooth surfaces and to calculate the reflection of light. In addition, normal vectors may be used in video games to create realistic-looking environments and to improve the performance of the game.

Base mesh decoder 314 may receive bitstream 1612. Base mesh decoder 314 may then apply entropy decoding (1614) to entropy encoded residuals to obtain residuals 1616. Additionally, base mesh decoder 314 may generate predictions 1618 based on reconstructed neighbor attributes 1620 and topology/connectivity data 1622. Base mesh decoder 314 may generate reconstructed current attributes 1624 based on residuals 1616 and predictions 1618 by performing a reconstruction operation (1626), such as an addition operation.

Base mesh decoder 314 may be configured to determine a normal for a vertex by determining a predicted normal for the vertex, receiving a difference value in an encoded bitstream, and determining the final normal value for the vertex to be equal to the predicted value plus the difference. V-DMC decoder 300 may be configured to perform different prediction processes depending on what nearby vertices have already been decoded.

When performing multi-parallelogram prediction, base mesh decoder 314 may predict a normal value for a current vertex (c in the figure below) as being equal to a previous normal value (c.p) plus a next normal value (c.n) minus an opposite normal value (c.o). Base mech decoder 314 may make a similar prediction for multiple triangles surrounding the current vertex and set the final prediction as the average of the predictions for the multiple triangles.

When performing cross-product prediction, base mesh decoder 314 may predict a normal value for a current vertex (c) by determining a vector between a previous vertex (c.p) and a current vertex (c), determining another vector between the next (c.n) and current vertex (c), and obtaining a cross product of these two vectors. In some examples, base mesh decoder 314 may do this for all or some triangles surrounding the current vertex and determine the predicted normal value as an average.

When performing delta prediction, base mesh decoder 314 may predict a normal value for a current vertex (c) based on an already decoded normal value of a single vertex (either c.p or c.n). Base mesh decoder 314 may determine the actual normal value by receiving a difference value in the bitstream and adding the difference value to the predicted normal value. Base mesh decoder 314 may also implement other types of prediction.

Relevant syntax elements in the V-DMC codec are now discussed. The current syntax for the V-DMC is shown in the syntax tables below in this section. The section of the syntax tables relevant for this disclosure are shown in double underlining.

### MPEG EdgeBreaker Static Mesh Coding Syntax in Tabular Form

### General Mesh Coding Syntax:

Descriptor

```
mesh_coding( ) {
  mesh_coding_header( )
  mesh_position_coding_payload( )
  mesh_attribute_coding_payload( )
}
```

### Mesh Coding Header Syntax:

| | Descriptor |
|---|---|
| mesh_coding_header( ) { | |
| mesh_codec_type | u(2) |
| mesh_vertex_traversal_method | u(2) |
| mesh_position_encoding_parameters( ) | |
| mesh_position_dequantize_flag | u(1) |
| if( mesh_position_dequantize_flag ) | |
| mesh_position_dequantize_parameters( ) | |
| mesh_attribute_count | u(5) |
| for( i = 0; i < mesh_attribute_count; i++ ) { | |
| mesh_attribute_type[ i ] | u(3) |
| if( mesh_attribute_type[ i ] == MESH_ATTR_TEXCOORD ) | |
| NumComponents[ i ] = 2 | |
| else if( mesh_attribute_type[ i ] == MESH_ATTR_NORMAL ) { | |
| mesh_normal_octahedral_flag[ i ] | u(1) |
| if( mesh_normal_octahedral_flag[ i ] ) | |
| NumComponents[ i ] = 2 | |
| Else | |
| NumComponents[ i ] = 3 | |
| } | |
| } | |
| else if( mesh_attribute_type[ i ] == MESH_ATTR_COLOR ) | |
| NumComponents[ i ] = 3 | |
| else if( mesh_attribute_type[ i ] == MESH_ATTR_MATERIAL_ID ) | |
| NumComponents[ i ] = 1 | |
| else if( mesh_attribute_type[ i ] == MESH_ATTR_GENERIC ) { | |
| mesh_attribute_num_components_minus1[ i ] | u(2) |
| NumComponents[ i ] = mesh_attribute_num_components_minus1[ i ] + 1 | |
| } | |
| mesh_attribute_encoding_parameters ( i ) | |
| mesh_attribute_dequantize_flag[ i ] | u(1) |
| if( mesh_attribute_dequantize_flag[ i ] ) | |
| mesh_attribute_dequantize_parameters( i ) | |
| } | |
| mesh_deduplicate_method | ue(v) |
| padding_to_byte_alignment( ) | |
| } | |

### Mesh Position Coding Payload Syntax:

| | Descriptor |
|---|---|
| mesh_position_coding_payload( ) { | |
| mesh_triangle_count | vu(v) |
| mesh_position_start_count | vu(v) |
| mesh_position_fine_residuals_count | vu(v) |
| mesh_position_coarse_residuals_count | vu(v) |
| mesh_clers_count | vu(v) |
| mesh_cc_with_boundary_count | vu(v) |
| mesh_handles_count | vu(v) |
| MinHandles = 10 | |
| if( mesh_handles_count < MinHandles ) { | |
| for( i=0; i < mesh_handles_count; i++ ){ | |
| mesh_handle_first_delta[ i ] | vi(v) |
| mesh_handle_second_delta[ i ] | vi(v) |
| } | |
| } else { | |
| mesh_coded_handle_size | vu(v) |
| for( i=0; i< mesh_handles_count; i++ ){ | |
| mesh_handle_first_sign[ i ] | ae(v) |
| mesh_handle_second_shift[ i ] | ae(v) |
| mesh_handle_first_variable_delta_length4_minus1[ i ] | ae(v) |
| mesh_handle_first_variable_delta[ i ] | ae(v) |
| mesh_handle_second_variable_delta_length4_minus1[ i ] | ae(v) |
| mesh_handle_second_variable_delta[ i ] | ae(v) |
| } | |
| } | |
| padding_to_byte_alignment( ) | |
| mesh_coded_clers_symbols_size | vu(v) |
| for( i=0; i <mesh_clers_count; i++ ) { | |
| mesh_clers_symbol[ i ] | ae(v) |
| } | |
| padding_to_byte_alignment( ) | |
| NumPositionStart = mesh_position_start_count | |
| for( i=0; i < NumPositionStart; i++ ) { | |
| for( j = 0; j < 3; j++ ) { | |
| mesh_position_start[ i ][ j ] | u(v) |
| } | |
| } | |
| padding_to_byte_alignment( ) | |
| NumPredictedFinePositions = mesh_position_fine_residuals_count | |
| if( mesh_position_fine_residuals_count > 0 ) { | |
| mesh_coded_position_fine_residuals_size | vu(v) |
| for( j = 0; j < 3; j++ ){ | |
| for( i = 0; i < NumPredictedFinePositions; i++ ) { | |
| mesh_position_fine_residual[ i ][ j ] | ae(v) |
| } | |
| } | |
| padding_to_byte_alignment( ) | |
| } | |
| NumPredictedCoarsePositions = mesh_position_coarse_residuals_count | |
| if( mesh_position_coarse_residuals_count > 0 ) { | |
| mesh_coded_position_coarse_residuals_size | vu(v) |
| for( j = 0; j < 3; j++ ){ | |
| for( i = 0; i < NumPredictedCoarsePositions; i++ ) { | |
| mesh_position_coarse_residual[ i ][ j ] | ae(v) |
| } | |
| } | |
| padding_to_byte_alignment( ) | |
| } | |
| mesh_position_deduplicate_information( ) | |
| if( mesh_position_reverse_unification_flag ) { | |
| mesh_difference_information( ) | |
| } | |
| } | |

### Mesh Position Deduplicate Information Syntax:

| | Descriptor |
|---|---|
| mesh_position_deduplicate_information( ) { | |
| if( mesh_deduplicate_method == MESH_{——}DEDUP_DEFAULT ) { | |
| mesh_position_deduplicate_count | vu(v) |
| if( mesh_position_deduplicate_count > 0 ){ | |
| NumSplitVertex = 0 | |
| for( i=0; i < mesh_position_deduplicate_count; i++ ) { | |
| mesh_position_deduplicate_idx[ i ] | vu(v) |
| NumSplitVertex = Max( NumSplitVertex, | |
| mesh_position_deduplicate_idx[ i ] + 1 ) | |
| } | |
| NumAddedDuplicatedVertex = mesh_position_deduplicate_count | |
| − NumSplitVertex | |
| NumPositionIsDuplicateFlags = NumPositionStart | |
| + NumPredictedFinePositions | |
| + NumPredictedCoarsePositions | |
| + NumAddedDuplicatedVertex | |
| mesh_position_coded_is_duplicate_size | vu(v) |
| for( i = 0; i< NumPositionIsDuplicateFlags; i++ ) { | |
| mesh_position_is_duplicate_flag[ i ] | ae(v) |
| } | |
| padding_to_byte_alignment( ) | |
| } | |
| } | |
| } | |

### Mesh Attribute Coding Payload Syntax:

| | Descriptor |
|---|---|
| mesh_attribute_coding_payload( ) { | |
| for( i = 0; i < mesh_attribute_count; i++ ) { | |
| mesh_attribute_start_count[ i ] | vu(v) |
| mesh_attribute_fine_residuals_count[ i ] | vu(v) |
| mesh_attribute_coarse_residuals_count[ i ] | vu(v) |
| if( mesh_attribute_separate_index_flag[ i ]) { | |
| mesh_attribute_seams_count[ i ] | vu(v) |
| if( mesh_attribute_seams_count > 0 ) { | |
| mesh_coded_attribute_seams_size[ i ] | vu(v) |
| for( j = 0; j < mesh_attribute_seams_count[ i ]; j++ ) { | |
| mesh_attribute_seam[ i ][ j ] | ae(v) |
| } | |
| } | |
| padding_to_byte_alignment( ) | |
| } | |
| NumAttributeStart[ i ] = mesh_attribute_start_count[ i ] | |
| if( mesh_attribute_type[ i ] == MESH_ATTR_NORMAL ) { | |
| NumAttributeStartComponents[ i ] = 3 | |
| } else { | |
| NumAttributeStartComponents[ i ] = NumComponents [ i ] | |
| } | |
| for( j = 0; j < mesh_attribute_start_count[ i ]; j++ ) { | |
| for( k = 0; k< NumAttributeStartComponents[ i ]; k++ ) { | |
| mesh_attribute_start[ i ][ j ][ k ] | u(v) |
| } | |
| } | |
| padding_to_byte_alignment( ) | |
| if( mesh_attribute_fine_residuals_count[ i ] ){ | |
| mesh_coded_attribute_fine_residuals_size[ i ] | vu(v) |
| for( j = 0; j < mesh_attribute_fine_residuals_count[ i ]; j++ ) { | |
| for( k = 0; k < NumComponents[ i ]; k++ ) { | |
| mesh_attribute_fine_residual[ i ][ j ][ k ] | ae(v) |
| } | |
| } | |
| padding_to_byte_alignment( ) | |
| } | |
| if( mesh_attribute_coarse_residuals_count[ i ] > 0 ){ | |
| mesh_coded_attribute_coarse_residuals_size[ i ] | vu(v) |
| for( j = 0; j < mesh_attribute_coarse_residuals_count[ i ]; j++ ) { | |
| for( k = 0; k < NumComponents[ i ]; k++ ) { | |
| mesh_attribute_coarse_residual[ i ][ j ][ k ] | ae(v) |
| } | |
| } | |
| padding_to_byte_alignment( ) | |
| } | |
| if(mesh_attribute_separate_index_flag[ i ]) | |
| mesh_attribute_deduplicate_info( i ) | |
| /* extra data dependent on the selected prediction scheme */ | |
| AttributeType = mesh_attribute_type[ i ] | |
| AttributePredictionMethod = mesh_attribute_prediction_method[ i ] | |
| mesh_attribute_extra_data( i, AttributeType, AttributePredictionMethod ) | |
| } | |
| padding_to_byte_alignment( ) | |
| } | |

### Mesh Normal Octahedral Extra Data Syntax:

| | Descriptor |
|---|---|
| mesh_normal_octahedral_extra_data( index ) { | |
| mesh_normal_octahedral_bit_depth_minus1[ index ] | u(5) |
| mesh_normal_octahedral_second_residual_flag[ index ] | u(1) |
| padding_to_byte_alignment( ) | |
| if( mesh_normal_octahedral_second_residuals_flag[ index ] ){ | |
| mesh_normal_octahedral_second_residuals_count[ index ] | vu(v) |
| if ( mesh_normal_octrahedral_second_residuals_count[ index ] ) { | |
| mesh_normal_octahedral_second_residuals_size[ index ] | vu(v) |
| for( j = 0; j < mesh_normal_octrahedral_second_residuals_count[ index ]; j++ | |
| ) { | |
| for( k = 0; k < 3; k++ ) { | |
| mesh_normal_octahedral_second_residual[ index ][ j ][ k ] | ae(v) |
| } | |
| } | |
| } | |
| } | |
| padding_to_byte_alignment( ) | |
| } | |

### Mesh Attribute Deduplicate Information Syntax

| | Descriptor |
|---|---|
| mesh_attribute_deduplicate_info( index ) { | |
| if( mesh_deduplicate_method == MESH_{——}DEDUP_DEFAULT ) { | |
| mesh_attribute_deduplicate_count[ index ] | vu(v) |
| if( mesh_position_deduplicate_count[ index ] > 0 ){ | |
| NumSplitAttribute[ index ] = 0 | |
| for( i = 0; i < mesh_attribute_deduplicate_count[ index ]; i++ ) { | |
| mesh_attribute_deduplicate_idx[ index ][ i ] | vu(v) |
| NumSplitAttribute[ index ] = Max(NumSplitAttribute[ index ], | |
| mesh_attribute_deduplicate_idx[ index ][ i ] + 1) | |
| } | |
| NumAddedDuplicatedAttribute[ index ] = | |
| mesh_attribute_deduplicate_count[ index ] − NumSplitAttribute[ index ] | |
| NumAttributeIsDuplicateFlags[ index ] = NumAttributeStart[ index ] | |
| +mesh_attribute_fine_residuals_count[ index ] | |
| +mesh_attribute_coarse_residuals_count[ index ] | |
| +NumAddedDuplicatedAttribute[ index ] | |
| mesh_attribute_coded_is_duplicate_size[ index ] | vu(v) |
| for( i = 0; i < NumAttributeIsDuplicateFlags[ index ]; i++ ) { | |
| mesh_attribute_is_duplicate_flag[ index ][ i ] | ae(v) |
| } | |
| padding_to_byte_alignment( ) | |
| } | |
| } | |

Base mesh encoder 314 entropy encodes attribute residuals using different coding schemes/parsing processes. Table 1, below, shows different parsing processes employed. Most of the syntax element for the residuals are encoded using K.2.5 (TU+EGk+S) which employs a “signed concatenated truncated unary and k-th order exp-Golomb codes” which is explained below. The syntax elements most relevant to this disclosure are shown in double underlining in Table 1.

TABLE 1
MPEG Edgebreaker syntax element specific parsing processes (ae(v))

| Syntax element | Parsing | Parameters |
|---|---|---|
| mesh_position_fine_residual[ ][ ] | K.2.5 (TU + | maxOffset = |
| | Egk + S) | 7, k = 2 |
| mesh_position_coarse_residual[ ][ ] | K.2.5 (TU + | maxOffset = |
| | Egk + S) | 7, k = 2 |
| mesh_attribute_fine_residual[ ][ ][ ] | /* TEXCOORD */ | /* TEXCOORD */ |
| | K.2.5 (TU + | maxOffset = |
| | Egk + S) | 7, k = 2 |
| | /* NORMAL */ | /* NORMAL */ |
| | K.2.5 (TU + | maxOffset = |
| | Egk + S) | 7, k = 2 |
| | /* MATERIAL_ID */ | /* MATERIAL_ID */ |
| | K.2.3 (Egk) | k = 2 |
| mesh_attribute_coarse_residual[ ][ ][ ] | /* TEXCOORD */ | /* TEXCOORD */ |
| | K.2.5 (TU + | maxOffset = |
| | Egk + S) | 7, k = 2 |
| mesh_normal_octahedral_second_residual[ ][ ][ ] | K.2.5 (TU + | maxOffset = |
| | Egk + S) | 7, k = 2 |
| mesh_clers_symbol[ ] | K.2.7 | |
| mesh_attribute_seam[ ][ ] | K.2.1 (FL) | numBins = 1 |
| mesh_texcoord_stretch_orientation[ ][ ] | K.2.1 (FL) | numBins = 1 |
| mesh_handle_first_sign[ ] | K.2.1 (FL) | numBins = 1 |
| mesh_handle_second_shift[ ] | K.2.1 (FL) | numBins = 1 |
| mesh_handle_first_variable_delta_length4_minus1[i] | K.2.6 (TU) | maxVal = 8 |
| mesh_handle_first_variable_delta[i] | K.2.1 (FL) | numBins |
| | | 4*(D1L+ 1) |
| mesh_handle_second_variable_delta_length4_minus1[i] | K.2.6 (TU) | maxVal = 8 |
| mesh_handle_second_variable_delta[i] | K.2.1 (FL) | numBins = |
| | | 4*(D2L + 1) |
| mesh_position_is_duplicate_flag[ ] | K.2.1 (FL) | numBins = 1 |
| mesh_attribute_is_duplicate_flag[ ][ ] | K.2.1 (FL) | numBins = 1 |
| mesh_materialid_default_not_equal_flag[ ][ ] | K.2.1 (FL) | numBins = 1 |
| mesh_materialid_default_left_flag[ ][ ] | K.2.1 (FL) | numBins = 1 |
| mesh_materialid_default_right_flag[ ][ ] | K.2.1 (FL) | numBins = 1 |
| mesh_materialid_default_facing_flag[ ][ ] | K.2.1 (FL) | numBins = 1 |

mesh_position_fine_residual[i][j] specifies the value of the i-th fine position prediction residual associated with the j-th component.

mesh_position_coarse_residual[i][j] specifies the value of the i-th coarse prediction residual associated with the j-th component.

mesh_attribute_fine_residual[i][j][k] specifies the value of the k-th component of the j-th fine prediction residual associated with the i-th attribute.

mesh_attribute_coarse_residual[i][j][k] specifies the value of the k-th component of the j-th coarse prediction residual associated with the i-th attribute.

mesh_normal_octahedral_second_residual[i][j][k] specifies the value of the residual associated with the k-th component of the j-th value of the i-th attribute when the mesh_attribute_type of the i-th attribute is equal to MESH_ATTR_NORMAL and when the related mesh_normal_octahedral_flag is equal to 1.

Base mesh decoder 314 performs a parsing process to parse syntax elements from the bitstream. The parsing process includes different operations for different data types. Of these operations, the operation for parsing signed concatenated truncated unary and k-th order exp-Golomb codes (TU+EGk+S) is most relevant for this disclosure. The parsing process is now described.

### K.2.1—Parsing Unsigned Fixed-Length Codes (FL)

Parsing is parameterized by numBins, the number of bins that represent the syntax element.

The result is the unsigned syntax element value parsedVal, parsed and constructed as:

```
parsedVal = 0
  for (BinIdx = 0; BinIdx < numBins; BinIdx++)
    parsedVal = (parsedVal << 1) + dec_aebin ( )
```

where dec_aebin( ) is the process described in K.3.2 for the current syntax element.

### K.2.2—Parsing Signed Fixed-Length Codes (FL+S)

Parsing is parameterized by numBins, the number of bins that represent the absolute syntax element value.

The unsigned syntax element magnitude is parsed:

```
PartVal = 0
  for (BinIdx = 0; BinIdx < numBins; BinIdx++)
    PartVal = (PartVal << 1) + dec_aebin ( )
```

The result is the signed syntax element value val, parsed and constructed as:

sign = dec_aebin ( )
val = sign ? − PartVal : PartVal

K.2.3—Parsing k-Th Order Exp-Golomb Codes (EGk)

Parsing is parameterized by k, the order of the exp-Golomb code.

First, a unary encoded prefix is parsed as:

prefix = 0
for (BinIdxPfx = 0; dec_aebin ( ) != 0; BinIdxPfx++)
prefix++

Then, a suffix comprising k+prefix bins is parsed:

Suffix = 0
for(BinIdxSfx = 0; BinIdxSfx < k + prefix; BinIdxSfx++)
suffix = (suffix << 1) + dec_aebin( )

The result is the unsigned syntax element value val, constructed as:

val = (1 << (prefix + k)) + suffix − (1 << k)

K.2.4—Parsing Concatenated Truncated Unary and k-Th Order Exp-Golomb Codes (TU+EGk)

Parsing is parameterized by maxOffset, the limit for the truncated unary offset encoding and k, the order of the exp-Golomb code;

First, a truncated unary encoded offset is parsed:

```
  offset = 0
    for(BinIdxTu = 0;
(offset < maxOffset) && (dec_aebin( ) == 1); BinIdxTu++)
      offset++
```

Second, if the value of offset is equal to maxOffset, a unary encoded prefix is parsed:

```
Prefix = 0
  if(offset == maxOffset)
    for(BinIdxPfx = 0; dec_aebin( ) != 0; BinIdxPfx++)
      prefix++
```

Then, if the value of offset is equal to maxOffset, a suffix comprising k+prefix bins is parsed:

```
suffix = 0
  if(offset == maxOffset)
  for(BinIdxSfx = 0; BinIdxSfx < k + prefix; BinIdxSfx++)
    suffix = (suffix << 1) + dec_aebin( )
```

The result is the unsigned syntax element value val, constructed as:

val = offset + (1 << (prefix + k)) + suffix − (1 << k)

K.2.5—Parsing Signed Concatenated Truncated Unary and k-Th Order Exp-Golomb Codes (TU+EGk+S)

Parsing is parameterized by maxOffset, the limit for the truncated unary offset encoding and k, the order of the exp-Golomb code;

First, a truncated unary encoded offset is parsed:

```
offset = 0
  for(BinIdxTu = 0; offset < maxOffset && dec_aebin( ) == 1;
  BinIdxTu++)
    offset++
```

Second, if the value of offset is equal to maxOffset, a unary encoded prefix is parsed:

```
prefix = 0
  if(offset == maxOffset)
    for(BinIdxPfx = 0; dec_aebin( ) != 0; BinIdxPfx++)
      prefix++
```

Then, if the value of offset is equal to maxOffset, a suffix comprising k+prefix bins is parsed:

```
suffix = 0
  if( offset == maxOffset)
  for(BinIdxSfx = 0; BinIdxSfx < k + prefix; BinIdxSfx++)
    suffix = (suffix << 1) + dec_aebin( )
```

The result is the signed syntax element value val, parsed and constructed as: if(offset>0)

```
  sign = dec_aebin( )
  absVal = offset + (1 << (prefix + k)) + suffix − (1 << k)
  val = sign ? − absVal : absVal
else
  val = 0
```

### K.2.6—Parsing Truncated Unary Codes (TU)

Parsing is parameterized by max Val the limit for the encoding.

The result is the unsigned syntax element value PartVal parsed and constructed as:

```
PartVal = 0
  for(BinIdxTu = 0; PartVal < maxVal && dec_aebin( ) == 1;
  BinIdxTu++)
    PartVal++
```

### K.2.7—Parsing Mesh CLERS Symbols

Parsing is performed for symbol in mesh_clers_symbol syntax element with index i.

The result is the unsigned syntax element value val parsed and constructed as:

```
  val = 0
    nbBins = 4
    for( BinIdxClers = 0; BinIdxClers < nbBins; BinIdxClers++ ) {
      bitClers = dec_aebin( )
      if ((bitClers == 0) || ( (BinIdxClers == 1) && (ClersSymbol0 ==
CLERS_C)))
        nbBins = BinIdxClers + 1
      val += bitClers << BinIdxClers
    }
```

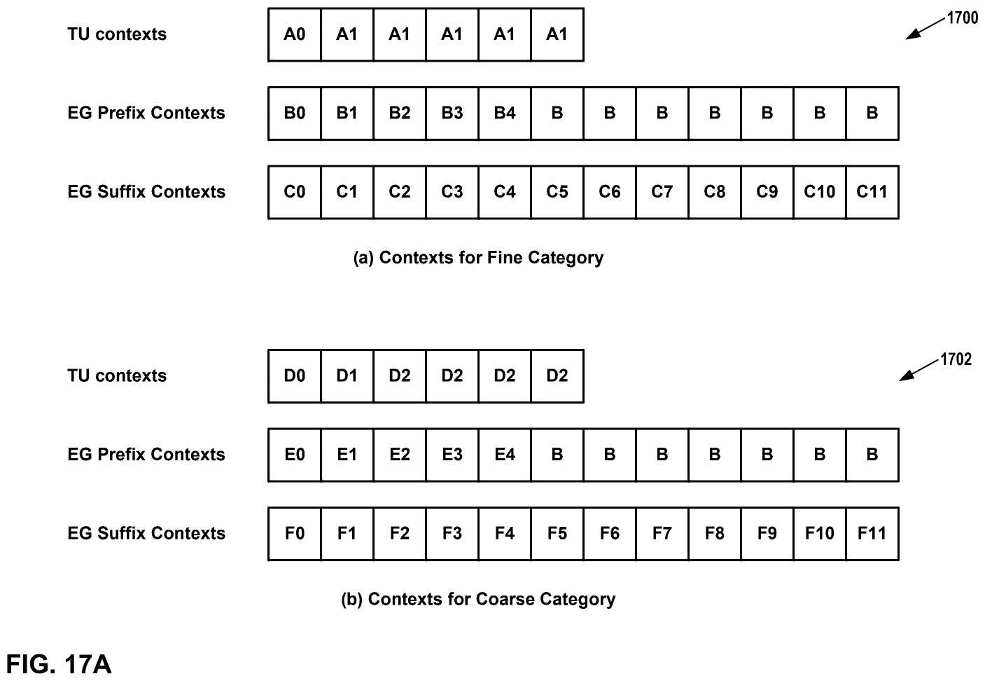

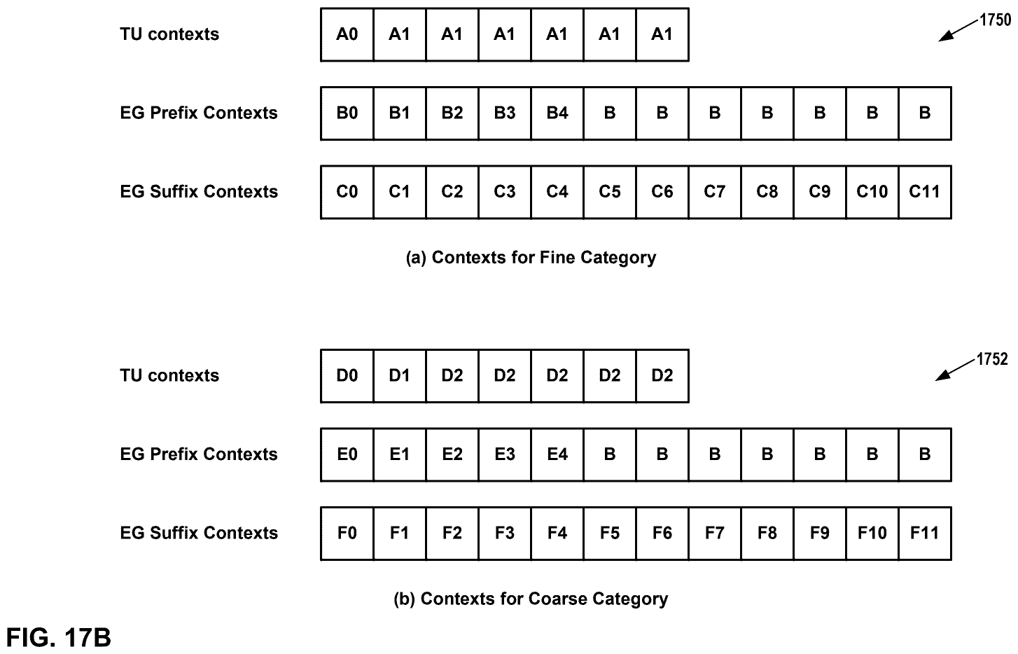

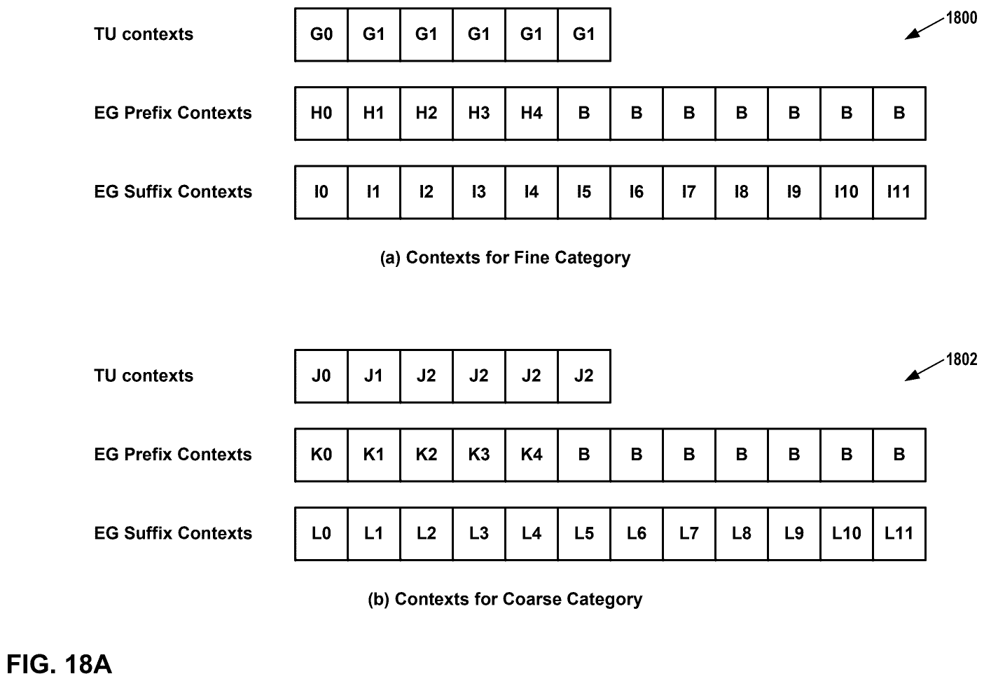

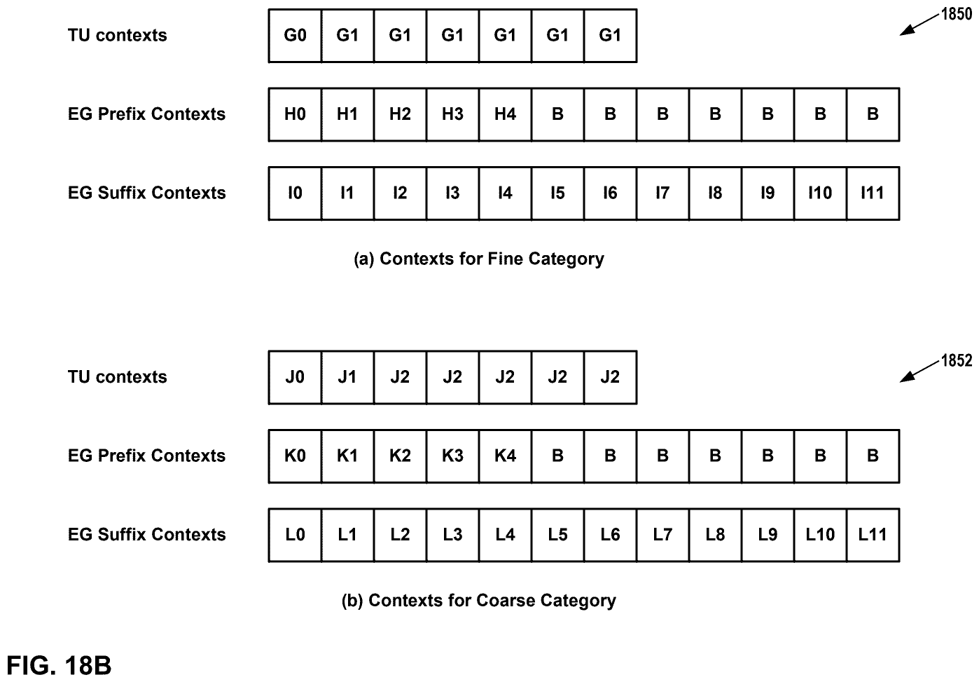

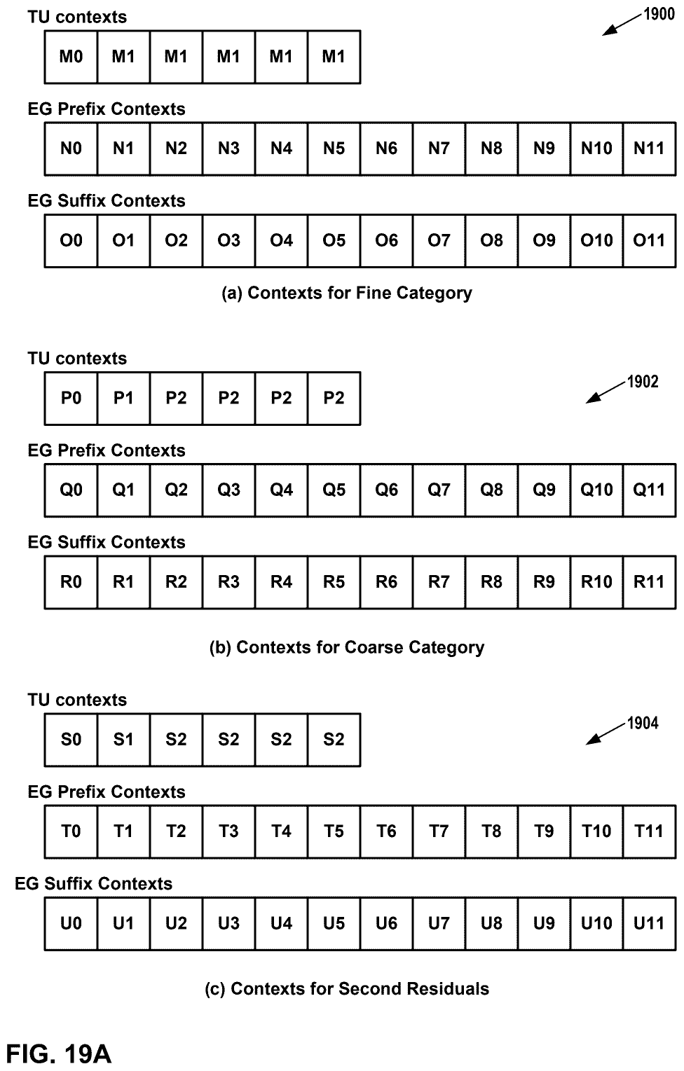

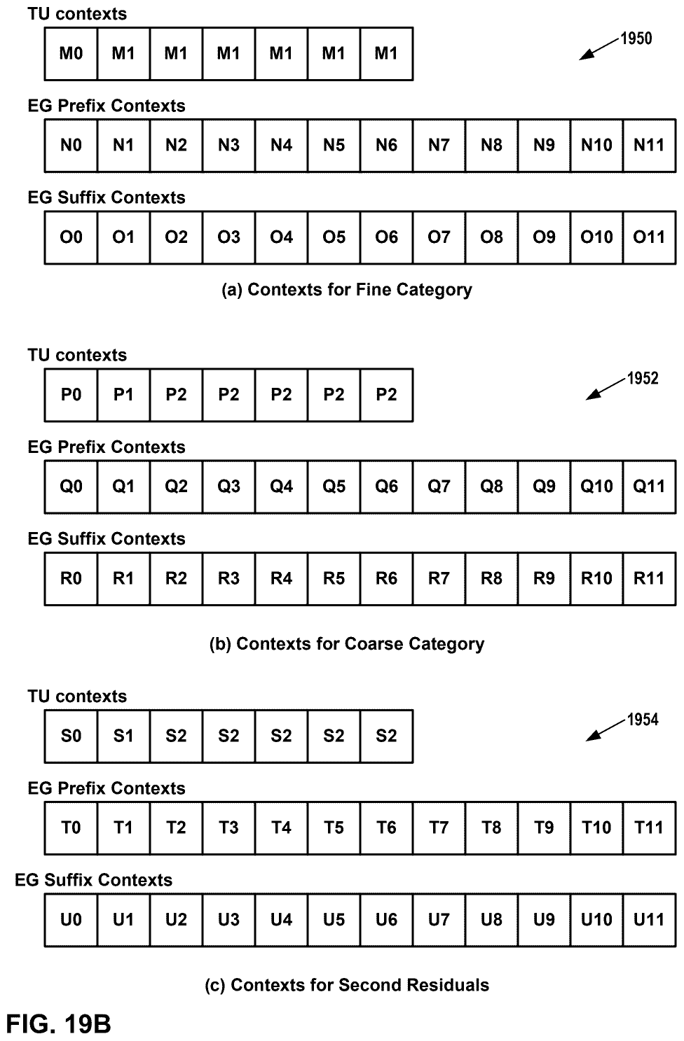

FIG. 17A, FIG. 18A, and FIG. 19A show contexts being employed in V-DMC TMM v8.0 attribute encoder. FIG. 17A shows position residual contexts employed in static mesh encoder. Specifically, FIG. 17A shows a context assignment scheme 1700 for mesh position fine residual syntax elements and a context assignment scheme 1702 for mesh position coarse residual syntax elements. A mesh position fine residual syntax element (e.g., mesh_position_fine_residual) specifies a value of a fine position prediction residual associated with a component of an attribute. A mesh position coarse residual syntax element (e.g., mesh_position_coarse_residual) specifies a value of a coarse position prediction residual associated with a component of an attribute. V-DMC encoder 200 may binarize a mesh position fine residual syntax element into a TU code, an exponential-Golomb prefix, and an exponential-Golomb suffix. Similarly, V-DMC encoder 200 may binarize a mesh position coarse residual syntax element into a TU code, an exponential-Golomb prefix, and an exponential-Golomb suffix.

In the example of FIG. 17A and other similar figures of this disclosure, each square corresponds to a bin of a TU code, exponential-Golomb prefix, or exponential-Golomb suffix. A label (e.g., A0, A1, B0, etc.) wherein a square indicates a context used for entropy encoding and entropy decoding of the bin corresponding to the square. For example, the A0 context is used for entropy encoding and entropy decoding the first bin of the TU code of the mesh position fine residual syntax element, the A1 context is used for entropy encoding and entropy decoding the second through sixth bins of the TU code of the mesh position fine residual syntax element, and so on. The label “B” indicates bypass coding. Bypass coding is a special context in which the probabilities of the bin being 0 or 1 are equal.

FIG. 18A shows texture residuals contexts employed in a static mesh encoder. Specifically, FIG. 18A shows a context assignment scheme 1800 for a mesh attribute fine residual syntax element (e.g., mesh_attribute_fine_residual) that specifies a value of a component of a fine prediction residual associated with a texture attribute. For ease of explanation this disclosure may use the term “fine texture residual syntax element” to refer to a mesh attribute fine residual syntax element that specifies a value of a component of a fine prediction residual associated with a texture attribute. FIG. 18A also shows a context assignment 1802 for a mesh attribute coarse residual syntax element (e.g., mesh_attribute_coarse_residual) that specifies a value of a component of a coarse prediction residual associated with a texture attribute. For ease of explanation, this disclosure may use the term “coarse texture residual syntax element” to refer to a mesh attribute fine residual syntax element that specifies a value of a component of a fine prediction residual associated with a texture attribute.

Base mesh encoder 212 may binarize a fine texture residual syntax element into a TU code, an exponential-Golomb prefix, and an exponential-Golomb suffix. Similarly, base mesh encoder 212 may binarize a coarse texture residual syntax element into a TU code, an exponential-Golomb prefix, and an exponential-Golomb suffix.

FIG. 19A shows normal residual contexts employed in static mesh encoder (i.e., base mesh encoder 212). Specifically, FIG. 19A shows a context assignment scheme 1900 for a mesh attribute fine residual syntax element (e.g., mesh_attribute_fine_residual) that specifies a value of a component of a fine prediction residual associated with a normal vector attribute. For ease of explanation, this disclosure may use the term “fine normal residual syntax element” to refer to a mesh attribute fine residual syntax element that specifies a value of a component of a fine prediction residual associated with a normal vector attribute. Base mesh encoder 212 may binarize a fine normal residual syntax element into a TU code, an exponential-Golomb prefix, and an exponential-Golomb suffix.

FIG. 19A also shows a context assignment 1902 for a mesh attribute coarse residual syntax element (e.g., mesh_attribute_coarse_residual) that specifies the value of a component of a coarse prediction residual associated with a normal vector attribute. For ease of explanation, this disclosure may use the term “coarse normal residual syntax element” to refer to a mesh attribute fine residual syntax element that specifies the value of a component of a coarse prediction residual associated with a normal vector attribute. Base mesh encoder 212 may binarize a coarse normal residual syntax element into a TU code, an exponential-Golomb prefix, and an exponential-Golomb suffix.

Additionally, FIG. 19A shows a context assignment 1904 for a mesh normal vector second residual syntax element (e.g., mesh_normal_octahedral_second_residual) that specifies the value of a residual associated with a component of a value of a normal vector attribute. For ease of explanation, this disclosure may use the term “normal vector second residual syntax element” to refer to a mesh normal vector second residual syntax element (e.g., mesh_normal_octahedral_second_residual) that specifies the value of a residual associated with a component of a value of a normal vector attribute. Base mesh encoder 212 may binarize a normal vector residual syntax element into a TU code, an exponential-Golomb prefix, and an exponential-Golomb suffix.

FIG. 17B shows alternative example context assignments 1750, 1752 for mesh position fine residual syntax elements and mesh position coarse residual syntax elements, respectively. FIG. 18B shows alternative example context assignments 1850, 1852 for mesh texture fine residual syntax elements and mesh texture coarse residual syntax elements. FIG. 19B shows example alternative context assignments 1950, 1952, and 1954 for mesh normal fine residual syntax elements, mesh normal coarse residual syntax elements, and normal second residual syntax elements.

Each attribute has a separate context for each category: Fine and Coarse. Within each category, there may be three different kinds of contexts. In other words, contexts are not shared within each category. As described in other examples below, limited context coding may be used for suffixes of positions and texture. In limited context coding, the first 5 bins are context encoded and decoded, and the remaining bins are bypassed.

Not all bins are encoded and decoded using an estimated probability (i.e. context coded). Bins can also be encoded and decoded assuming equal probability of 0.5 (i.e. bypass coded). As a result, bypass coded bins avoid the feedback loop for the context selection. In addition, the arithmetic coding is also simpler and faster for bypass coded bins, as the division of the range into subintervals can be done by a shift, rather than a lookup table which may be required for the context coded bins. Thus, multiple bypass bins can be processed concurrently in the same cycle at lower power and area cost than context coded bins. This property is highly leveraged by the throughput improvement techniques described below.

Table 2, below, specifies how base mesh encoder 212 and base mesh decoder 314 may determine contexts for entropy encoding various syntax elements. Different sets of contexts are stored in different tables having indexes (CtxTbl). Contexts within a table are associated with different context indexes. To determine a context for a bin of a syntax element, base mesh encoder 212 or base mesh decoder 314 may determine a context index for the portion of the binarized data (e.g., offset, prefix, suffix, etc.) to which the bin belongs and perform the calculation indicated in table 2. For example, to determine a context index for a bin that is among the first 5 bins of the prefix of a mesh position_fine_residual syntax element, base mesh encoder 212 and base mesh decoder 314 may calculate 2+Min(4, BinIdxPfx), where BinIdxPfx is the index of the bin in the prefix. With respect to the mesh_attribute_fine_residual syntax element and the mesh_attribute_coarse_residual syntax element, base context values for prefixes (nbPfxCtx) and base context values for suffixes (nbSfxCtx) are set based on the type of the attribute (e.g., TEXCOORD for texture coordinate attributes, NORMAL for normal vector attributes, and MATERIAL_ID for material identifier attributes). The base context values for prefixes and the base context values for suffixes are then used in the process for determining a context index.

TABLE 2
Values of context (CtxTbl and CtxIdx) for MPEG Edge Breaker binarized ae(v) coded syntax elements

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdxPfx <= 4) | BinIdxPfx) | |
| | | Prefix | bypass | 0 |
| | | (BinIdxPfx > 4) | | |
| | | Suffix | 7 + Min(11, | 12 |
| | | | BinIdxSfx) | |
| | | Sign | bypass | 0 |
| mesh_position_coarse_residual[ ][ ] | 2 | Offset | Min(2, | 3 |
| | | | BinIdxTu) | |
| | | Prefix | 3 + Min(4, | 5 |
| | | (BinIdxPfx <= 4) | BinIdxPfx) | |
| | | Prefix | bypass | 0 |
| | | (BinIdxPfx > 4) | | |
| | | Suffix | 8 + Min(11, | 12 |
| | | | BinIdxSfx) | |
| | | Sign | bypass | 0 |
| mesh_attribute_fine_residual[ ][ ][ ] | 3 | Offset | Min(1, | 2 |
| /* TEXCOORD */ | | | BinIdxTu) | |
| nbPfxCtx = 5, nbSfxCtx = 12 | | Prefix | 2 + | 12 |
| /* NORMAL */ | | (BinIdxPfx <= | Min(nbPfxCtx − 1, | |
| nbPfxCtx = nbSfxCtx = 12 | | nbPfxCtx − 1) | BinIdxPfx) | |
| /* MATERIAL_ID */ | | Prefix | bypass | 0 |
| nbPfxCtx = nbSfxCtx = 8 | | (BinIdxPfx > | | |
| | | nbPfxCtx − 1) | | |
| | | Suffix | 14 + | 12 |
| | | | Min(nbSfxCtx − 1, | |
| | | | BinIdxSfx) | |
| | | Sign | bypass | 0 |
| mesh_attribute_coarse_residual[ ][ ][ ] | 4 | Offset | Min(2, | 3 |
| /* TEXCOORD */ | | | BinIdxTu) | |
| nbPfxCtx = 5, nbSfxCtx = 12 | | Prefix | 3 + | 12 |
| /* NORMAL */ | | (BinIdxPfx <= | Min(nbPfxCtx − 1, | |
| nbPfxCtx = nbSfxCtx = 12 | | nbPfxCtx − 1) | BinIdxPfx) | |
| | | Prefix | bypass | 0 |
| | | (BinIdxPfx > | | |
| | | nbPfxCtx − 1) | | |
| | | Suffix | 15 + | 12 |
| | | | Min(nbSfxCtx − 1, | |
| | | | BinIdxSfx) | |
| | | Sign | bypass | 0 |
| mesh_clers_symbol[ ] | 5 | CtxClers (subclause | | 30 |
| | | I.10.3.4.1) | | |
| mesh_attribute_seam[ ][ ] | 6 | 0 | | 1 |
| mesh_texcoord_stretch_orientation[ ][ ] | 7 | 0 | | 1 |
| mesh_handle_first_sign[ ] | 8 | 0 | | 1 |
| mesh_handle_second_shift[ ] | 9 | 0 | | 1 |
| mesh_handle_first_variable_delta_length4_minus1[ ] | 10 | Min(3, BinIdxTu) | | 4 |
| mesh_handle_first_variable_delta[ ] | 11 | bypass | | 0 |
| mesh_handle_second_variable_delta_length4_minus1[ ] | 12 | Min(3, BinIdxTu) | | 4 |
| mesh_handle_second_variable_delta[ ] | 13 | bypass | | 0 |
| mesh_position_is_duplicate_flag[ ] | 14 | 0 | | 1 |
| mesh_attribute_is_duplicate_flag[ ][ ] | 15 | 0 | | 1 |
| mesh_materialid_default_not_equal_flag[ ][ ] | 16 | 0 | | 1 |
| mesh_materialid_default_left_flag[ ][ ] | 17 | 0 | | 1 |
| mesh_materialid_default_right_flag[ ][ ] | 18 | 0 | | 1 |
| mesh_materialid_default_facing_flag[ ][ ] | 19 | 0 | | 1 |
| mesh_normal_octahedral_second_residual[ ][ ][ ] | 20 | Offset | Min(1, | 2 |
| | | | BinIdxTu) | |
| | | Prefix | 2 + Min(11, | 12 |
| | | | BinIdxPfx) | |
| | | Suffix | 14 + Min(11, | 12 |
| | | | BinIdxSfx) | |
| | | Sign | 26 | 1 |

Updates to context encoding and decoding are now described. These are the updates currently being studied in the V-DMC EE4.4 exploration that would introduce context sharing to context coding schemes described above.

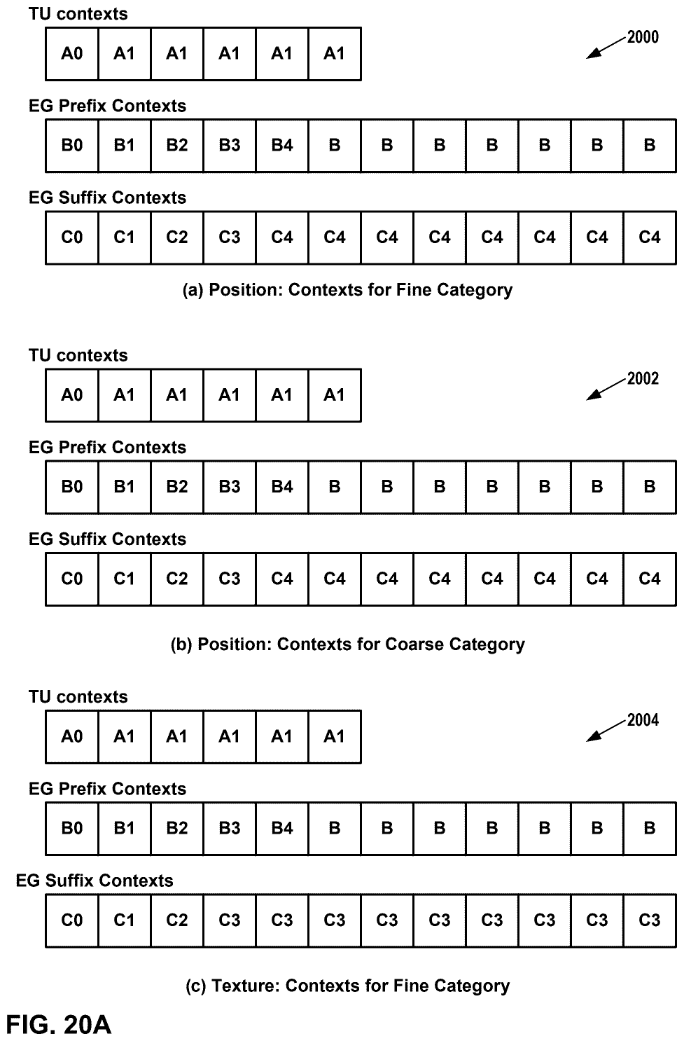

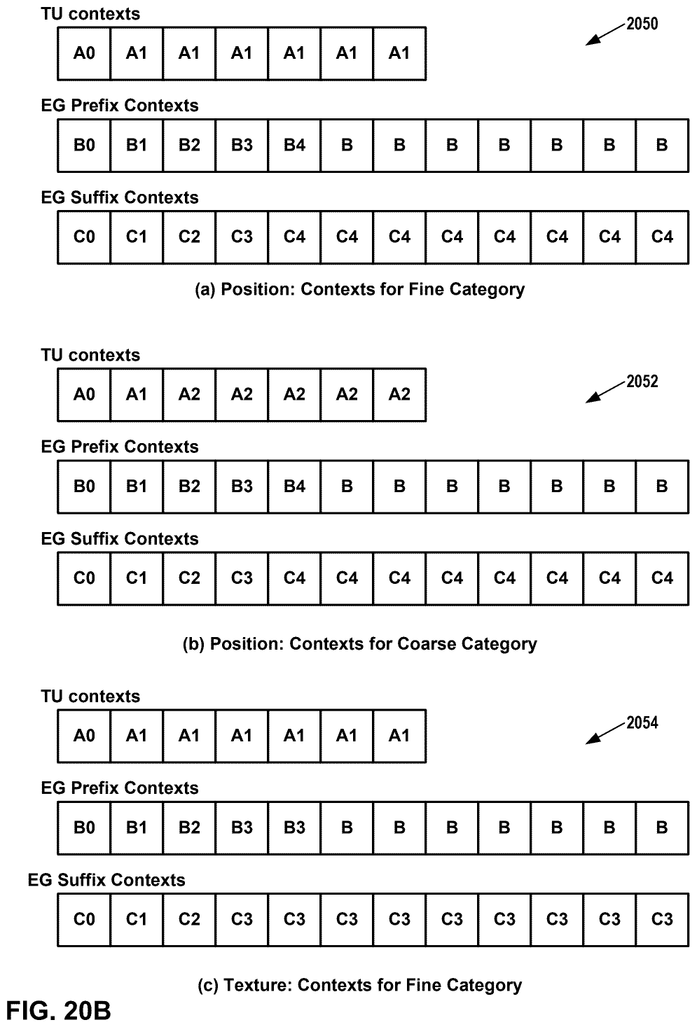

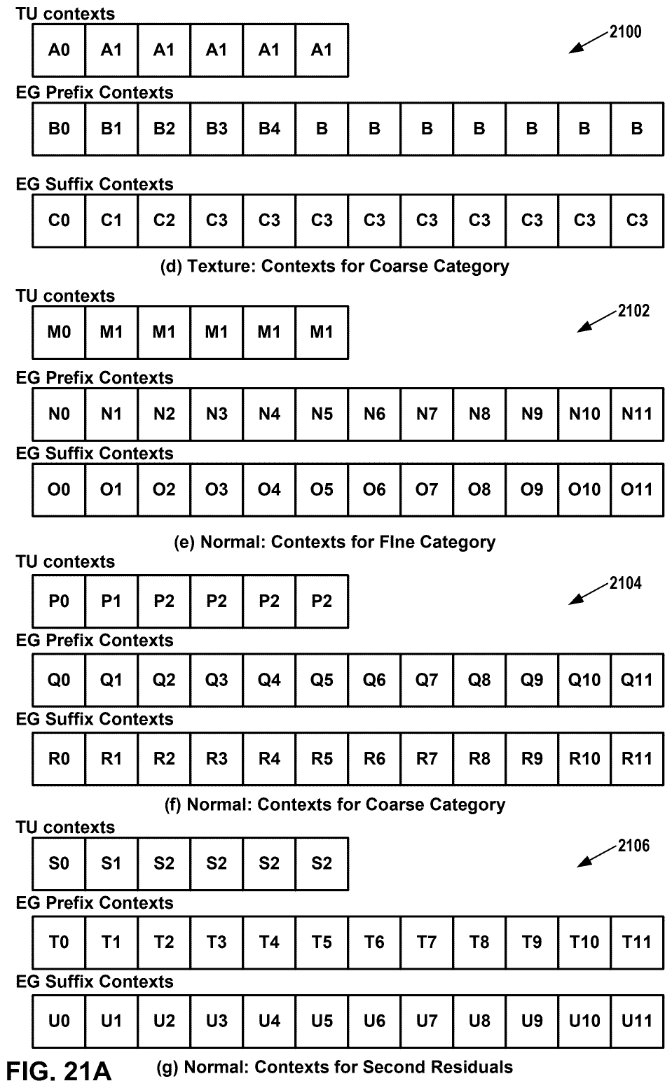

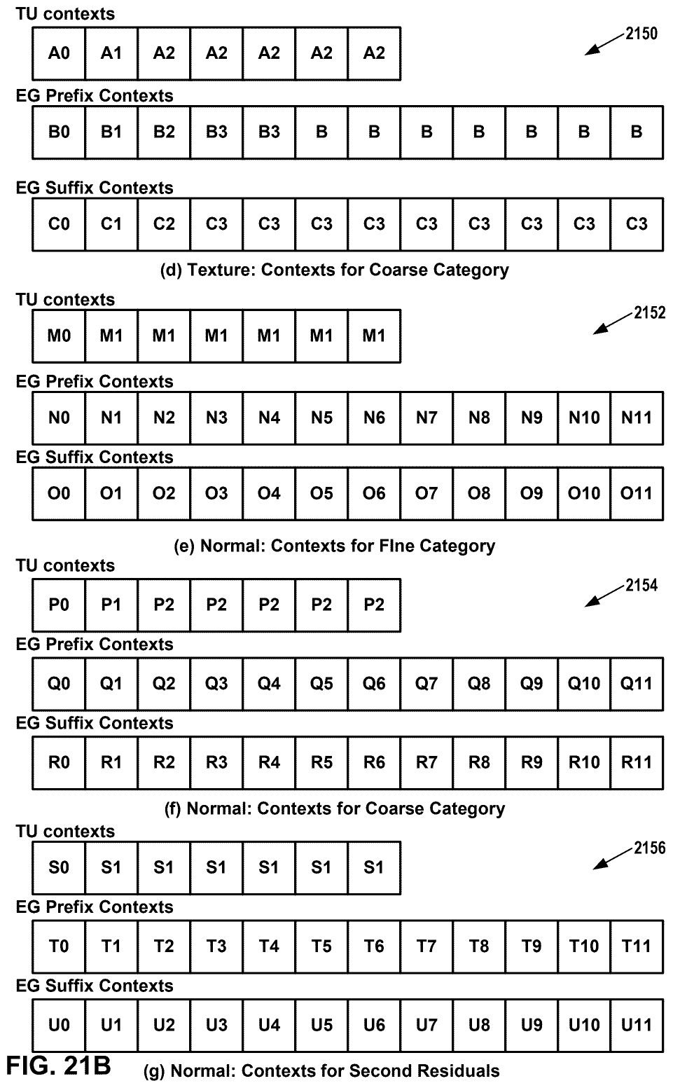

These updates would change the contexts in the following ways (as shown in FIG. 20A and FIG. 21A): FIG. 20A and FIG. 21A show attribute residual contexts employed in a static mesh encoder. FIG. 20B and FIG. 21B show an alternative example attribute residual contexts employed in the static mesh encoder.

FIG. 20A shows a context assignment scheme 2000 for mesh position fine residual syntax elements, a context assignment scheme 2002 for mesh position coarse residual syntax elements, and a context assignment scheme 2004 for mesh texture fine residual syntax elements. FIG. 20B shows a context assignment scheme 2050 for mesh position fine residual syntax elements, a context assignment scheme 2052 for mesh position coarse residual syntax elements, and a context assignment scheme 2054 for mesh texture fine residual syntax elements. FIG. 21A shows a context assignment scheme 2100 for mesh position coarse residual syntax elements, a context assignment scheme 2102 for mesh normal fine residual syntax elements, a context assignment scheme 2104 for mesh normal coarse residual syntax elements, and a context assignment scheme 2106 for normal second residual syntax elements. FIG. 21B shows a context assignment scheme 2150 for mesh position coarse residual syntax elements, a context assignment scheme 2152 for mesh normal fine residual syntax elements, a context assignment scheme 2154 for mesh normal coarse residual syntax elements, and a context assignment scheme 2156 for normal second residual syntax elements.

As shown in FIGS. 20A, 20B, 21A, and 21B, contexts are shared between texture and position attributes. For example, the A0, A1, and A2 contexts are used in the TU codes of mesh position fine residual syntax elements, mesh position coarse residual syntax elements, mesh texture fine residual syntax elements, mesh texture coarse residual syntax elements. Additionally, contexts are shared between coarse and fine attributes. Context in the Suffix category would be shared between bin 5 to bin 12, for Position. Context in the Suffix category would be shared between bin 4 to bin 12, for Texture. Furthermore, there was a proposal to increase the TU Context size of Texture Fine Category from 7 bins to 10 bins. This would change the syntax Table 2 into updated Table 3. Text between * characters (e.g., * text * indicates deletion).

TABLE 3
Values of CtxTbl and CtxIdx for MPEG Edge Breaker binarized ae(v) coded syntax elements

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdxPfx <= 4) | BinIdxPfx) | |
| | | Prefix | bypass | 0 |
| | | (BinIdxPfx > 4) | | |
| | | Suffix | 7 + Min(*11* | *12* 5 |
| | | | 4, BinIdxSfx) | |
| | | Sign | bypass | 0 |
| mesh_position_coarse_residual[ ][ ] | *2* 1 | Offset | Min(2, | 3 |
| | | | BinIdxTu) | |
| | | Prefix | 3 + Min(4, | 5 |
| | | (BinIdxPfx <= 4) | BinIdxPfx) | |
| | | Prefix | bypass | 0 |
| | | (BinIdxPfx > 4) | | |
| | | Suffix | 8 + Min(*11* | *12* 5 |
| | | | 4, BinIdxSfx) | |
| | | Sign | bypass | 0 |
| mesh_attribute_fine_residual [ ][ ][ ] | *3* 1 | Offset | Min(1, | 2 |
| /* TEXCOORD */ | | | BinIdxTu) | |
| nbPfxCtx = 5, nbSfxCtx = *12* 4 | | Prefix | 2 + | 12 |
| /* NORMAL */ | | (BinIdxPfx <= | Min(nbPfxCtx − 1, | |
| nbPfxCtx = nbSfxCtx = 12 | | nbPfxCtx − 1) | BinIdxPfx) | |
| /* MATERIAL_ID */ | | Prefix | bypass | 0 |
| nbPfxCtx = nbSfxCtx = 8 | | (BinIdxPfx > | | |
| | | nbPfxCtx − 1) | | |
| | | Suffix | 14 + | 12 |
| | | | Min(nbSfxCtx − 1, | |
| | | | BinIdxSfx) | |
| | | Sign | bypass | 0 |
| mesh_attribute_coarse_residual [ ][ ][ ] | *4* 1 | Offset | Min(2, | 3 |
| /* TEXCOORD */ | | | BinIdxTu) | |
| nbPfxCtx = 5, nbSfxCtx = *12* 4 | | Prefix | 3 + | 12 |
| /* NORMAL */ | | (BinIdxPfx <= | Min(nbPfxCtx − 1, | |
| nbPfxCtx = nbSfxCtx = 12 | | nbPfxCtx − 1) | BinIdxPfx) | |
| | | Prefix | bypass | 0 |
| | | (BinIdxPfx > | | |
| | | nbPfxCtx − 1) | | |
| | | Suffix | 15 + | 12 |
| | | | Min(nbSfxCtx − 1, | |
| | | | BinIdxSfx) | |
| | | Sign | bypass | 0 |

However, in these proposals, contexts are not shared with the TU codes of mesh normal coarse residual syntax elements, mesh normal fine residual syntax elements, and normal vector second residual syntax elements.

The static mesh encoder (e.g., base mesh encoder 212) employs an Edgebreaker algorithm to encode the connectivity/topology of the base mesh and to encode base mesh attributes (e.g., position, UV coordinates, normal vectors) using a prediction scheme to calculate residuals. The static mesh encoder then entropy encodes the residuals using a “signed concatenated truncated unary and k-th order exp-Golomb (TU+EGk+S)” coding scheme. The (TU+EGk+S) coding scheme requires context selection for the values, as shown in Table 1 and Table 2. FIGS. 17A, 17B, 18A, 18B, 19A, 19B, 20A, 20B, 21A, and 21B show how these values can visually be drawn into bins and contexts, where each letter is a separate context. A meticulous selection of variables, contexts, and entropy coding is essential to achieve optimal results for attribute coding. This disclosure presents multiple approaches to enhance attribute encoding in the static mesh encoder.

### Technique 1: Coarse Removal

In base mesh encoder 212, attributes are first predicted and then their residuals are calculated as shown in FIG. 16. These residuals are entropy encoded. However, these residuals are divided into “Fine” and “Coarse” categories and both categories are encoded independently by different context models. For many attributes, the coarse category is not being employed and therefore the coarse category does not always make sense to have a separate context for coarse residuals. The elimination of coarse residuals from all or a subset of attributes is proposed. The current implemented attributes in the V-DMC static mesh encoder include:
Position.
Normals.
Texture Coordinates (UV coordinates).

Coarse residuals can be eliminated either from all attributes or selectively from specific attributes. Removal of coarse residuals would mean all the residuals in the coarse category would be merged with Fine category. The best results are achieved by removing coarse from position and normal vectors while keeping coarse for texture coordinates. The syntax table of this implementation looks like the table below (The text between * characters is removed, text between \hat{ } characters is edited, the double underlined text contains the syntax elements relevant to context coding of coarse and fine residuals):

### Mesh Position Coding Payload Syntax

| | Descriptor |
|---|---|
| mesh_position_coding_payload( ) { | |
| mesh_triangle_count | vu(v) |
| mesh_position_start_count | vu(v) |
| mesh_position_fine_residuals_count | vu(v) |
| *mesh_position_coarse_residuals_count* | *vu(v)* |
| mesh_clers_count | vu(v) |
| mesh_cc_with_boundary_count | vu(v) |
| mesh_handles_count | vu(v) |
| MinHandles = 10 | |
| if( mesh_handles_count < MinHandles ) { | |
| for( i=0; i < mesh_handles_count; i++ ){ | |
| mesh_handle_first_delta[ i ] | vi(v) |
| mesh_handle_second_delta[ i ] | vi(v) |
| } | |
| } else { | |
| mesh_coded_handle_size | vu(v) |
| for( i=0; i< mesh_handles_count; i++ ){ | |
| mesh_handle_first_sign[ i ] | ae(v) |
| mesh_handle_second_shift[ i ] | ae(v) |
| mesh_handle_first_variable_delta_length4_minus1[ i ] | ae(v) |
| mesh_handle_first_variable_delta[ i ] | ae(v) |
| mesh_handle_second_variable_delta_length4_minus1[ i ] | ae(v) |
| mesh_handle_second_variable_delta[ i ] | ae(v) |
| } | |
| } | |
| padding_to_byte_alignment( ) | |
| mesh_coded_clers_symbols_size | vu(v) |
| for( i=0; i <mesh_clers_count; i++ ) { | |
| mesh_clers_symbol[ i ] | ae(v) |
| } | |
| padding_to_byte_alignment( ) | |
| NumPositionStart = mesh_position_start_count | |
| for( i=0; i < NumPositionStart; i++ ) { | |
| for( j = 0; j < 3; j++ ) { | |
| mesh_position_start[ i ][ j ] | u(v) |
| } | |
| } | |
| padding_to_byte_alignment( ) | |
| NumPredictedFinePositions = mesh_position_fine_residuals_count | |
| if( mesh_position_fine_residuals_count > 0 ) { | |
| mesh_coded_position_fine_residuals_size | vu(v) |
| for( j = 0; j < 3; j++ ){ | |
| for( i = 0; i < NumPredictedFinePositions; i++ ) { | |
| mesh_position_fine_residual[ i ][ j ] | ae(v) |
| } | |
| } | |
| padding_to_byte alignment( ) | |
| } | |
| *NumPredictedCoarsePositions = mesh_position_coarse_residuals_count * | |
| * if( mesh_position_coarse_residuals_count > 0 ) {* | |
| * mesh_coded_position_coarse_residuals_size* | *vu(v)* |
| * for( j = 0; j < 3; j++ ){* | |
| * for( i = 0; i < NumPredictedCoarsePositions; i++ ) {* | |
| * mesh_position_coarse_residual[ i ][ j ]* | *ae(v)* |
| * }* | |
| * }* | |
| * padding_to_byte_alignment( )* | |
| * }* | |
| mesh_position_deduplicate_information( ) | |
| if( mesh_position_reverse_unification_flag ) { | |
| mesh_difference_information( ) | |
| } | |
| } | |

### Mesh Position Deduplicate Information Syntax

| | Descriptor |
|---|---|
| mesh_position_deduplicate_information( ) { | |
| if( mesh_deduplicate_method == MESH_—DEDUP_DEFAULT ) { | |
| mesh_position_deduplicate_count | vu(v) |
| if( mesh_position_deduplicate_count > 0 ){ | |
| NumSplitVertex = 0 | |
| for( i=0; i < mesh_position_deduplicate_count; i++ ) { | |
| mesh_position_deduplicate_idx[ i ] | vu(v) |
| NumSplitVertex = Max( NumSplitVertex, | |
| mesh_position_deduplicate_idx[ i ] + 1 ) | |
| } | |
| NumAddedDuplicatedVertex = mesh_position_deduplicate_count | |
| − NumSplitVertex | |
| NumPositionIsDuplicateFlags = NumPositionStart | |
| + NumPredictedFinePositions | |
| *+ NumPredictedCoarsePositions* | |
| + NumAddedDuplicatedVertex | |
| mesh_position_coded_is_duplicate_size | vu(v) |
| for( i = 0; i< NumPositionIsDuplicateFlags; i++ ) { | |
| mesh_position_is_duplicate_flag[ i ] | ae(v) |
| } | |
| padding_to_byte_alignment( ) | |
| } | |
| } | |
| } | |

### Mesh Attribute Coding Payload Syntax

| | | | Descriptor |
|---|---|---|---|
| mesh_attribute_coding_payload( ) { | | | |
| | for( i = 0; i < mesh_attribute_count; i++ ) { | | |
| | mesh_attribute_start_count[ i ] | | vu(v) |
| mesh_attribute_fine_residuals_count[ i ] | | | vu(v) |
| \hat{ } | | If (\hat{ } | |
| \hat{ }mesh_attribute_type[ i ] == MESH_ATTR_TEXCOORD ) \hat{ } | | | |
| \hat{ } | | mesh_attribute_coarse_residuals_count[ i ]\hat{ } | \hat{ }vu(v)\hat{ } |
| | if( mesh_attribute_separate_index_flag[ i ]) { | | |
| | | mesh_attribute_seams_count[ i ] | vu(v) |
| | | if( mesh_attribute_seams_count > 0 ) { | |
| | | mesh_coded_attribute_seams_size[ i ] | vu(v) |
| | | for( j = 0; j < mesh_attribute_seams_count[ i ]; j++ ) { | |
| | | mesh_attribute_seam[ i ][ j ] | ae(v) |
| | | } | |
| | | } | |
| | | padding_to_byte_alignment( ) | |
| | } | | |
| | NumAttributeStart[ i ] = mesh_attribute_start_count[ i ] | | |
| | if( mesh_attribute_type[ i ] == MESH_ATTR_NORMAL ) { | | |
| | | NumAttributeStartComponents[ i ] = 3 | |
| | } else { | | |
| | | NumAttributeStartComponents[ i ] = NumComponents[ i ] | |
| | } | | |
| | for( j = 0; j < mesh_attribute_start_count[ i ]; j++ ) { | | |
| | | for( k = 0; k< NumAttributeStartComponents[ i ]; k++ ) { | |
| | | mesh_attribute_start[ i ][ j ][ k ] | u(v) |
| | | } | |
| | } | | |
| | padding_to_byte_alignment( ) | | |
| if( mesh_attribute_fine_residuals_count[ i ] ){ | | | |
| mesh_coded_attribute_fine_residuals_size[ i ] | | | vu(v) |
| for( j = 0; j < mesh_attribute_fine_residuals_count[ i ]; j++ ) { | | | |
| for( k = 0; k < NumComponents[ i ]; k++ ) { | | | |
| mesh_attribute_fine_residual[ i ][ i ][ k ] | | | ae(v) |
| } | | | |
| } | | | |
| padding_to_byte_alignment( ) | | | |
| } | | | |
| \hat{ } | If ( mesh_attribute_type[ i ] == MESH_ATTR_TEXCOORD ){ | | |
| \hat{ } | | | |
| \hat{ } | | if( mesh attribute_coarse_residuals_count[ i ] > 0 ){\hat{ } | |
| \hat{ } | | | \hat{ }vu(v)\hat{ } |
| | mesh_coded_attribute_coarse_residuals_size[ i ]\hat{ } | | |
| \hat{ } | | | |
| | for( j = 0; j < mesh_attribute_coarse_residuals_count[ i ]; j++ ) {\hat{ } | | |
| \hat{ } | | | |
| | for( k = 0; k < NumComponents[ i ]; k++ ) {\hat{ } | | |
| | \hat{ } | | \hat{ }ae(v)\hat{ } |
| | mesh_attribute_coarse_residual[ i ][ j ][ k ]\hat{ } | | |
| \hat{ } | | }\hat{ } | |
| \hat{ } | | }\hat{ } | |
| \hat{ } | | padding_to_byte_alignment( )\hat{ } | |
| \hat{ } | | }\hat{ } | |
| \hat{ } | | }\hat{ } | |
| | if(mesh_attribute_separate_index_flag[ i ]) | | |
| | | mesh_attribute_deduplicate_info( i ) | |
| | /* | extra data dependent on the selected prediction scheme */ | |

| | AttributeType = mesh_attribute_type[ i ] |
|---|---|
| | AttributePredictionMethod = mesh_attribute_prediction_method[ i ] |
| | mesh_attribute_extra_data( i, AttributeType, |
| AttributePredictionMethod ) | |
| | } |
| | padding_to_byte_alignment( ) |

}

### Mesh Normal Octahedral Extra Data Syntax

| | Descriptor |
|---|---|
| mesh_normal_octahedral_extra_data( index ) { | |
| mesh_normal_octahedral_bit_depth_minus1[ index ] | u(5) |
| mesh_normal_octahedral_second_residual_flag[ index ] | u(1) |
| padding_to_byte_alignment( ) | |
| if( mesh_normal_octahedral_second_residuals_flag[ | |
| index ] ){ | |
| mesh_normal_octahedral_second_residuals_count[ | vu(v) |
| index ] | |
| if ( | |
| mesh_normal_octrahedral_second_residuals_count[ | |
| index ] ) { | |
| mesh_normal_octahedral_second_residuals_size[ | vu(v) |
| index ] | |
| for( j = 0; i < | |
| mesh_normal_octrahedral_second_residuals_count[ | |
| index ]; j++ | |
| ) { | |
| for( k = 0; k < 3; k++ ) { | |
| mesh_normal_octahedral_second_residual[ | ae(v) |
| index ][ i ][ k ] | |
| } | |
| } | |
| } | |
| } | |
| padding_to_byte_alignment( ) | |
| } | |

### Mesh Attribute Deduplicate Information Syntax

Descriptor

```
  mesh_attribute_deduplicate_info( index ) {
    if( mesh_deduplicate_method == MESH_—DEDUP_DEFAULT ) {
```

| | mesh_attribute_deduplicate_count[ index ] | vu(v) |
|---|---|---|
| | if( mesh_position_deduplicate_count[ index ] > 0 ){ | |
| | NumSplitAttribute[ index ] = 0 | |
| for( i = 0; i < mesh_attribute_deduplicate_count[ index ]; i++ ) { | | |
| | mesh_attribute_deduplicate_idx[ index ][ i ] | vu(v) |
| NumSplitAttribute[ index ] = Max(NumSplitAttribute[ index ], | | |
| mesh_attribute_deduplicate_idx[ index ][ i ] + 1) | | |
| | } | |
| | NumAddedDuplicatedAttribute[ index ] = | |
| mesh_attribute_deduplicate_count[ index ] − NumSplitAttribute[ inde | | |
| x ] | | |
| \hat{ } | If ( | |
| mesh_attribute_type[ i ] == MESH_ATTR_TEXCOORD ){\hat{ } | | |
| \hat{ } | | |
| NumAttributeIsDuplicateFlags[ index ] = NumAttributeStart[ index ] | | |
| +mesh_attribute_fine_residuals_count[ index ] | | |
| +mesh_attribute_coarse_residuals_count[ index ] | | |
| | +NumAddedDuplicatedAttribute[ index ]\hat{ } | |
| \hat{ } | else\hat{ } | |
| \hat{ } | | |
| NumAttributeIsDuplicateFlags[ index ] = NumAttributeStart[ index ] | | |
| +mesh_attribute_fine_residuals_count[ index ] | | |
| | +NumAddedDuplicatedAttribute[ index ]\hat{ } | |
| | mesh_attribute_coded_is_duplicate_size[ index ] | vu(v) |
| for( i = 0; i < NumAttributeIsDuplicateFlags[ index ]; i++ ) { | | |
| | mesh_attribute_is_duplicate_flag[ index ][ i ] | ae(v) |
| | } | |
| | padding_to_byte_alignment( ) | |
| | } | |

}

The contexts would look like as shown in FIG. 22A and FIG. 23A. Specifically, FIG. 22A shows a context assignment scheme 2200 for mesh position fine residual syntax elements, a context assignment scheme 2202 for mesh texture fine residual syntax elements, and a context assignment scheme 2204 for mesh texture coarse residual syntax elements. FIG. 23A shows a context assignment scheme 2300 for mesh normal fine residual syntax elements and a context assignment scheme 2302 for normal second residual syntax elements. FIG. 22B and FIG. 23B show an alternative example removal of coarse residuals from position and normals, in accordance with techniques of this disclosure. Specifically, FIG. 22B shows a context assignment scheme 2250 for mesh position fine residual syntax elements, a context assignment scheme 2252 for mesh texture fine residual syntax elements, and a context assignment scheme 2254 for mesh texture coarse residual syntax elements. FIG. 23B shows a context assignment scheme 2350 for mesh normal fine residual syntax elements and a context assignment 2352 for normal second residual syntax elements.

Table 3 would be updated to Table 4, below, due to Technique 1.

TABLE 4
Values of CtxTbl and CtxIdx for Technique 1

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdxPf | BinIdxPfx) | |
| | | x <= 4) | | |
| | | Prefix | bypass | 0 |
| | | (BinIdxPf | | |
| | | x > 4) | | |
| | | Suffix | 7 + Min(4, | 5 |
| | | | BinIdxSfx) | |
| | | Sign | bypass | 0 |
| *mesh_position_coarse_residual[ ][ ]* | *1* | *Offset* | *Min(2 | *3* |
| | | | BinIdxTu)* | |
| | | *Prefix | *3 + Min(4, | *5* |
| | | (BinIdxPf | BinIdxPfx)* | |
| | | x <= 4)* | | |
| | | *Prefix | *bypass* | *0* |
| | | (BinIdxPf | | |
| | | x > 4)* | | |
| | | *Suffix* | *8 + Min( 4, | *5* |
| | | | BinIdxSfx)* | |
| | | *Sign* | *bypass* | *0* |
| mesh_attribute_fine_residual[ ][ ][ ] | 1 | Offset | Min(1, | 2 |
| /* TEXCOORD */ | | | BinIdxTu) | |
| nbPfxCtx = 5, nbSfxCtx = 4 | | | | |
| /* NORMAL */ | | Prefix | 2 + | 12 |
| nbPfxCtx = nbSfxCtx = 12 | | (BinIdxPf | Min(nbPfxCtx | |
| /* MATERIAL_ID */ | | x <= | −1, BinIdxPfx) | |
| nbPfxCtx = nbSfxCtx = 8 | | nbPfxCtx − | | |
| | | 1) | | |
| | | Prefix | bypass | 0 |
| | | (BinIdxPf | | |
| | | x > | | |
| | | nbPfxCtx − | | |
| | | 1) | | |
| | | Suffix | 14 + | 12 |
| | | | Min(nbSfxCtx | |
| | | | −1, BinIdxSfx) | |
| | | Sign | bypass | 0 |
| mesh_attribute_coarse_residual[ ][ ][ | 1 | Offset | Min(2, | 3 |
| ] | | | BinIdxTu) | |
| /* TEXCOORD */ | | Prefix | 3 + | 12 |
| nbPfxCtx = 5, nbSfxCtx = 4 | | (BinIdxPf | Min(nbPfxCtx | |
| * /* NORMAL */ * | | x <= | −1, BinIdxPfx) | |
| * nbPfxCtx = nbSfxCtx = 12 * | | nbPfxCtx − | | |
| | | 1) | | |
| | | Prefix | bypass | 0 |
| | | (BinIdxPf | | |
| | | x > | | |
| | | nbPfxCtx − | | |
| | | 1) | | |
| | | Suffix | 15 + | 12 |
| | | | Min(nbSfxCtx | |
| | | | −1, BinIdxSfx) | |
| | | Sign | bypass | 0 |

### Technique 2: Context Selection for Normal Attribute

The current context for attributes in V-DMC TMM v8.0 is shown in FIG. 28A and FIG. 29A and their values are explained in Table 1 and Table 2. It is proposed to update the context shown in FIGS. 20A, 20B, 21A, and 21B and Table 3 to improve the coding efficiency of the attributes and the normal vectors. The following modifications to the V-DMC TMM v8.0 may enhance entropy encoding of normal vectors in accordance with Technique 2:

Normals Attribute Fine Residuals (mesh_attribute_fine_residuals)
maxOffset=7
k=5;
const auto bctx=2;

### Normals Attribute Coarse Residuals (Mesh_Attribute_Coarse_Residuals)

maxOffset=7
k=5;
const auto bctx=1;

### Normals Octahedral Second Residuals (Mesh_Normal_Octahedral_Second_Residuals)

maxOffset=7
k=1;
const auto bctx=3;
Employ bypass coding with Bypass after first bin.

In some examples, base mesh encoder 212 and base mesh decoder 314 use limited context coding for the prefix portion of normal second residuals. In this approach, the first bin is context coded, while the remaining bins are bypassed. These edits are shown in FIG. 24A and FIG. 25A. Specifically, FIG. 24A shows an example context assignment scheme 2400 for mesh normal fine residual syntax elements, a context assignment scheme 2402 for mesh normal coarse residual syntax elements, and a context assignment 2404 for mesh texture fine residual syntax elements. FIG. 25A shows an example context assignment scheme 2500 for mesh texture fine residual syntax elements, a context assignment scheme 2502 for mesh normal fine residual syntax elements, a context assignment scheme 2504 for mesh texture coarse residual syntax elements, and a context assignment 2506 for normal second residual syntax elements. These edits change Table 1 to Table 5 and Table 3 to Table 6. The edited part is between \hat{ } characters,

TABLE 5
Technique 2: Updated MPEG Edgebreaker syntax
element specific parsing processes (ae(v))

| Syntax element | Parsing | Parameters |
|---|---|---|
| mesh_position_fine_residual[ ][ ] | K.2.5 (TU + | maxOffset = |
| | Egk + S) | 7, k = 2 |
| mesh_position_coarse_residual[ ][ ] | K.2.5 (TU + | maxOffset = |
| | Egk + S) | 7, k = 2 |
| \hat{ } mesh_attribute_fine_residual[ ][ ][ ] \hat{ } | /* | /* |
| | TEXCOORD | TEXCOORD |
| | */ | */ |
| | K.2.5 (TU + | maxOffset = |
| | Egk + S) | \hat{ } 7 \hat{ }, k = 2 |
| | \hat{ }/* NORMAL | \hat{ } /* NORMAL |
| | */ \hat{ } | */ \hat{ } |
| | \hat{ } K.2.5 (TU + | \hat{ } maxOffset |
| | Egk + S) \hat{ } | = 7, k = 5 \hat{ } |
| | /* | /* |
| | MATERIAL_I | MATERIAL_I |
| | D */ | D */ |
| | K.2.3 (Egk) | k = 2 |
| \hat{ } mesh_attribute_coarse_residual[ ][ ][ ] \hat{ } | /* | /* |
| | TEXCOORD | TEXCOORD |
| | */ | */ |
| | K.2.5 (TU + | maxOffset = |
| | Egk + S) | 7, k = 2 |
| | \hat{ } /* | \hat{ } /* |
| | NORMAL */ | NORMAL */ |
| | K.2.5 (TU + | maxOffset = |
| | Egk + S) \hat{ } | 7, k = 5/* \hat{ } |
| \hat{ } mesh_normal_octahedral_second_residual[ ][ | \hat{ } K.2.5 (TU + | \hat{ } maxOffset |
| ][ ] \hat{ } | Egk + S) \hat{ } | = 7, k = 1 \hat{ } |
| mesh_clers_symbol[ ] | K.2.7 | |
| mesh_attribute_seam[ ][ ] | K.2.1 (FL) | numBins =1 |
| mesh_texcoord_stretch_orientation[ ][ ] | K.2.1 (FL) | numBins = 1 |
| mesh_handle_first_sign[ ] | K.2.1 (FL) | numBins = 1 |
| mesh_handle_second_shift[ ] | K.2.1 (FL) | numBins = 1 |
| mesh_handle_first_variable_delta_length4_minus1[ | K.2.6 (TU) | maxVal = 8 |
| i] | | |
| mesh_handle_first_variable_delta[i] | K.2.1 (FL) | numBins = |
| | | 4*(D1L + 1) |
| mesh_handle_second_variable_delta_length4_minu | K.2.6 (TU) | maxVal = 8 |
| s1[i] | | |
| mesh_handle_second_variable_delta[i] | K.2.1 (FL) | numBins = |
| | | 4*(D2L + 1) |
| mesh_position_is_duplicate_flag[ ] | K.2.1 (FL) | numBins =1 |
| mesh_attribute_is_duplicate_flag[ ][ ] | K.2.1 (FL) | numBins =1 |
| mesh_materialid_default_not_equal_flag[ ][ ] | K.2.1 (FL) | numBins =1 |
| mesh_materialid_default_left_flag[ ][ ] | K.2.1 (FL) | numBins =1 |
| mesh_materialid_default_right_flag[ ][ ] | K.2.1 (FL) | numBins =1 |
| mesh_materialid_default_facing_flag[ ][ ] | K.2.1 (FL) | numBins =1 |

TABLE 6
Technique 2: Updated values of context (CtxTbl and CtxIdx)
for MPEG Edgebreaker binarized ae(v) coded syntax elements

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdx | BinIdxPfx) | |
| | | Pfx <= | | |
| | | 4) | | |
| | | Prefix | bypass | 0 |
| | | (BinIdx | | |
| | | Pfx > 4) | | |
| | | Suffix | 7 + Min(4, | 5 |
| | | | BinIdxSfx) | |
| | | Sign | bypass | 0 |
| mesh_position_coarse_residual[ ][ ] | 1 | Offset | Min(2, | 3 |
| | | | BinIdxTu) | |
| | | Prefix | 3 + Min(4, | 5 |
| | | (BinIdx | BinIdxPfx) | |
| | | Pfx <= | | |
| | | 4) | | |
| | | Prefix | bypass | 0 |
| | | (BinIdx | | |
| | | Pfx > 4) | | |
| | | Suffix | 8 + Min(11, | 12 |
| | | | BinIdxSfx) | |
| | | Sign | bypass | 0 |
| mesh_attribute_fine_residual[ ][ ][ ] | 1 | Offset | Min(1, | 2 |
| /* TEXCOORD */ | | | BinIdxTu) | |
| nbPfxCtx = 5, nbSfxCtx = 4 | | Prefix | 2 + | 12 |
| /* NORMAL */ | | (BinIdx | Min(nbPfx | |
| nbPfxCtx = nbSfxCtx = 12 | | Pfx <= | Ctx −1, | |
| /* MATERIAL_ID */ | | nbPfxCt | BinIdxPfx) | |
| nbPfxCtx = nbSfxCtx = 8 | | x −1) | | |
| | | Prefix | bypass | 0 |
| | | (BinIdx | | |
| | | Pfx > | | |
| | | nbPfxCt | | |
| | | x −1) | | |
| | | Suffix | 14 + | 12 |
| | | | Min(nbSfx | |
| | | | Ctx−1, | |
| | | | BinIdxSfx) | |
| | | Sign | bypass | 0 |
| mesh_attribute_coarse_residual[ ][ ][ ] | 1 | Offset | \hat{ } Min(bctx | 3 |
| /* TEXCOORD */ | | | −1, | |
| nbPfxCtx = 5, nbSfxCtx = 4, \hat{ } bctx = 3 \hat{ } | | | BinIdxTu) | |
| /* NORMAL */ | | | \hat{ } | |
| nbPfxCtx = nbSfxCtx = 12, \hat{ } bctx = 1 \hat{ } | | Prefix | 3 + | 12 |
| | | (BinIdx | Min(nbPfx | |
| | | Pfx <= | Ctx −1, | |
| | | nbPfxCt | BinIdxPfx) | |
| | | x −1) | | |
| | | Prefix | bypass | 0 |
| | | (BinIdx | | |
| | | Pfx > | | |
| | | nbPfxCt | | |
| | | x −1) | | |
| | | Suffix | 15 + | 12 |
| | | | Min(nbSfx | |
| | | | Ctx−1, | |
| | | | BinIdxSfx) | |
| | | Sign | bypass | 0 |
| mesh_clers_symbol[ ] | 5 | CtxClers ( subclause | | 30 |
| | | I.10.3.4.1) | | |
| mesh_attribute_seam[ ][ ] | 6 | 0 | | 1 |
| mesh_texcoord_stretch_orientation[ ][ ] | 7 | 0 | | 1 |
| mesh_handle_first_sign[ ] | 8 | 0 | | 1 |
| mesh_handle_second_shift[ ] | 9 | 0 | | 1 |
| mesh_handle_first_variable_delta_length4_ | 10 | Min(3, BinIdxTu) | | 4 |
| minus1[ ] | | | | |
| mesh_handle_first_variable_delta[ ] | 11 | bypass | | 0 |
| mesh_handle_second_variable_delta_length | 12 | Min(3, BinIdxTu) | | 4 |
| 4_minus1[ ] | | | | |
| mesh_handle_second_variable_delta[ ] | 13 | bypass | | 0 |
| mesh_position_is_duplicate_flag[ ] | 14 | 0 | | 1 |
| mesh_attribute_is_duplicate_flag[ ][ ] | 15 | 0 | | 1 |
| mesh_materialid_default_not_equal_flag[ ][ ] | 16 | 0 | | 1 |
| mesh_materialid_default_left_flag[ ][ ] | 17 | 0 | | 1 |
| mesh_materialid_default_right_flag[ ][ ] | 18 | 0 | | 1 |
| mesh_materialid_default_facing_flag[ ][ ] | 19 | 0 | | 1 |
| \hat{ } | 20 | Offset | \hat{ } Min(2, | \hat{ }3 \hat{ } |
| mesh normal octahedral second residual[ ] | | | BinIdxTu) | |
| [ ][ ] \hat{ } | | | \hat{ } | |
| | | \hat{ }Prefix | \hat{ }2 + | \hat{ }12 |
| | | (BinIdx | Min(11, | \hat{ } |
| | | Pfx <= | BinIdxPfx) | |
| | | 0)\hat{ } | \hat{ } | |
| | | \hat{ } Prefix | \hat{ }bypass \hat{ } | \hat{ } 0 \hat{ } |
| | | (BinIdx | | |
| | | Pfx > 0) | | |
| | | \hat{ } | | |
| | | Suffix | 14 + | 12 |
| | | | Min(11, | |
| | | | BinIdxSfx) | |
| | | Sign | 26 | 1 |

FIG. 24B and FIG. 25B show alternative context assignment schemes for context selection for normal attributes, in accordance with techniques of this disclosure. Specifically, FIG. 24B shows an example context assignment scheme 2450 for mesh normal fine residual syntax elements, a context assignment scheme 2452 for mesh normal coarse residual syntax elements, and a context assignment 2454 for mesh texture fine residual syntax elements. FIG. 25B shows an example context assignment scheme 2550 for mesh texture fine residual syntax elements, a context assignment scheme 2552 for mesh normal fine residual syntax elements, a context assignment scheme 2554 for mesh texture coarse residual syntax elements, and a context assignment 2556 for normal second residual syntax elements.

Please note that technique 1 removes coarse residuals for the normal vector attribute. However, technique 2 provides for context selection for coarse normal residuals. This is because both technique 1 and technique 2 can be independently or jointly applied and does not rely on each other. One can either apply technique 1, technique 2, or both technique 1 and technique 2.

A possible solution is a combination of Technique 1 and 2, which would make the context look like as shown in FIG. 26A and FIG. 27A. Specifically, FIG. 26A shows an example context assignment scheme 2600 for mesh position fine residual syntax elements, a context assignment scheme 2602 for mesh texture coarse residual syntax elements, and a context assignment 2604 for mesh texture coarse residual syntax elements. FIG. 27A shows an example context assignment scheme 2700 for mesh normal fine residual syntax elements and a context assignment scheme 2702 for normal second residual syntax elements. FIG. 26B and FIG. 27B show an alternative example of Coarse Removal+Context Update for Normal. Specifically, FIG. 26B shows an example context assignment scheme 2650 for mesh position fine residual syntax elements, a context assignment scheme 2652 for mesh texture coarse residual syntax elements, and a context assignment 2654 for mesh texture coarse residual syntax elements. FIG. 27B shows an example context assignment scheme 2750 for mesh normal fine residual syntax elements and a context assignment scheme 2752 for normal second residual syntax elements.

TABLE 2
Technique 1 + 2: Updated values of context (CtxTbl and CtxIdx)
for MPEG Edge Breaker binarized ae(v) coded syntax elements

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdx | BinIdxPfx) | |
| | | Pfx <= | | |
| | | 4) | | |
| | | Prefix | bypass | 0 |
| | | (BinIdx | | |
| | | Pfx > 4) | | |
| | | Suffix | 7 + Min(4, | 5 |
| | | | BinIdxSfx) | |
| | | Sign | bypass | 0 |
| * mesh_position_coarse_residual[ ][ ] * | * 1 * | *Offset* | *Min(2, | *3* |
| | | | BinIdxTu)* | |
| | | *Prefix | *3 + Min(4, | *5* |
| | | (BinIdx | BinIdxPfx) | |
| | | Pfx <= | * | |
| | | 4)* | | |
| | | *Prefix | *bypass* | *0* |
| | | (BinIdx | | |
| | | Pfx > | | |
| | | 4)* | | |
| | | *Suffix* | *8 + | *12* |
| | | | Min(11, | |
| | | | BinIdxSfx)* | |
| | | *Sign* | *bypass* | *0* |
| mesh_attribute_fine_residual[ ][ ][ ] | 1 | Offset | Min(1, | 2 |
| /* TEXCOORD */ | | | BinIdxTu) | |
| nbPfxCtx = 5, nbSfxCtx = 4 | | Prefix | 2 + | 12 |
| /* NORMAL */ | | (BinIdx | Min(nbPfx | |
| nbPfxCtx = nbSfxCtx = 12 | | Pfx <= | Ctx −1, | |
| /* MATERIAL_ID */ | | nbPfxCt | BinIdxPfx) | |
| nbPfxCtx = nbSfxCtx = 8 | | x −1) | | |
| | | Prefix | bypass | 0 |
| | | (BinIdx | | |
| | | Pfx > | | |
| | | nbPfxCt | | |
| | | x −1) | | |
| | | Suffix | 14 + | 12 |
| | | | Min(nbSfx | |
| | | | Ctx−1, | |
| | | | BinIdxSfx) | |
| | | Sign | bypass | 0 |
| mesh_attribute_coarse_residual[ ][ ][ ] | 1 | Offset | \hat{ } Min(bctx | 3 |
| /* TEXCOORD */ | | | −1, | |
| nbPfxCtx = 5, nbSfxCtx = 4, \hat{ } bctx = 3 \hat{ } | | | BinIdxTu) | |
| * /* NORMAL */ * | | | \hat{ } | |
| * nbPfxCtx = nbSfxCtx = 12, bctx = 1 * | | Prefix | 3 + | 12 |
| | | (BinIdx | Min(nbPfx | |
| | | Pfx <= | Ctx −1, | |
| | | nbPfxCt | BinIdxPfx) | |
| | | x −1) | | |
| | | Prefix | bypass | 0 |
| | | (BinIdx | | |
| | | Pfx > | | |
| | | nbPfxCt | | |
| | | x −1) | | |
| | | Suffix | 15 + | 12 |
| | | | Min(nbSfx | |
| | | | Ctx−1, | |
| | | | BinIdxSfx) | |
| | | Sign | bypass | 0 |
| mesh_clers_symbol[ ] | 5 | CtxClers ( subclause | | 30 |
| | | 1.10.3.4.1) | | |
| mesh_attribute_seam[ ][ ] | 6 | 0 | | 1 |
| mesh_texcoord_stretch_orientation[ ][ ] | 7 | 0 | | 1 |
| mesh_handle_first_sign[ ] | 8 | 0 | | 1 |
| mesh_handle_second_shift[ ] | 9 | 0 | | 1 |
| mesh_handle_first_variable_delta_length4_ | 10 | Min(3, BinIdxTu) | | 4 |
| minus1[ ] | | | | |
| mesh_handle_first_variable_delta[ ] | 11 | bypass | | 0 |
| mesh_handle_second_variable_delta_length | 12 | Min(3, BinIdxTu) | | 4 |
| 4_minus1[ ] | | | | |
| mesh_handle_second_variable_delta[ ] | 13 | bypass | | 0 |
| mesh_position_is_duplicate_flag[ ] | 14 | 0 | | 1 |
| mesh_attribute_is_duplicate_flag[ ][ ] | 15 | 0 | | 1 |
| mesh_materialid_default_not_equal_flag[ ][ ] | 16 | 0 | | 1 |
| mesh_materialid_default_left_flag[ ][ ] | 17 | 0 | | 1 |
| mesh_materialid_default_right_flag[ ][ ] | 18 | 0 | | 1 |
| mesh_materialid_default_facing_flag[ ][ ] | 19 | 0 | | 1 |
| mesh_normal_octahedral_second_residual[ ] | 20 | Offset | Min(2, | 3 |
| [ ][ ] | | | BinIdxTu) | |
| | | Prefix | 2 + Min(11, | 12 |
| | | | BinIdxPfx) | |
| | | (BinIdx | | |
| | | Pfx <= | | |
| | | 0) | | |
| | | Prefix | bypass | 0 |
| | | (BinIdx | | |
| | | Pfx > 0) | | |
| | | Suffix | 14 + | 12 |
| | | | Min(11, | |
| | | | BinIdxSfx) | |
| | | Sign | 26 | 1 |

### Technique 4—Updated Context Selection for Normal Attribute

It is proposed to update the context shown in FIG. 20B and FIG. 21B and Table 3 to improve the coding efficiency of the attributes and the normals. Here are the suggested modifications to the V-DMC TMM v8.0 to enhance entropy encoding of normals:

### Normals Attribute Fine Residuals (Mesh_Attribute_Fine_Residuals)

maxOffset=7
k=5;
const auto bctx=2;
maxPrefixIdx=maxSuffixIdx=12;
Employ context Sharing.

### Normals Attribute Coarse Residuals (Mesh_Attribute_Coarse_Residuals)

maxOffset=7
k=5;
const auto bctx=2;
maxPrefixIdx=maxSuffixIdx=12;
Employ context Sharing.

### Normals Octahedral Second Residuals (Mesh_Normal_Octahedral_Second_Residuals)

maxOffset=7
k=1;
const auto bctx=3;
maxPrefixIdx=maxSuffixIdx=1;
Employ context Sharing.
Employ bypass coding with Bypass after first bin.

Furthermore, the following additions are proposed:
Introduce context sharing in normal encoding. The mesh_attribute_fine_residuals, mesh_attribute_coarse_residuals, and mesh_normal_octahedral_second_residuals would share context between each other for Normal attribute.
The Normal attribute would share context between Normal encoding, and other attributes (Position/Geometry and Texture/UV Coordinates)
The normal octahedral second residuals would employ limited context coding with bypass coding implemented.

The context would change from FIG. 20B/FIG. 20B to FIG. 28/FIG. 29. FIG. 28 and FIG. 29 show an example of contexts employed in static mesh encoder (Normal part updated). Only the normal part is updated. Specifically, FIG. 28 shows a context assignment scheme 2800 for mesh position fine residual syntax elements, a context assignment scheme 2802 for mesh position coarse residual syntax elements, and a context assignment scheme 2804 for mesh texture fine residual syntax elements. FIG. 29 shows a context assignment scheme 2900 for mesh texture coarse residual syntax elements, a context assignment scheme 2902 for mesh normal fine residual syntax elements, a context assignment scheme 2904 for mesh normal coarse residual syntax elements, and a context assignment scheme 2906 for normal second residual syntax elements.

These edits change Table 1 to Table 8 and Table 2 to Table 9. Table 8 and Table 9 are shown below. The edited part is shown in between \hat{ } characters.

TABLE 8
Technique 4: Updated MPEG Edgebreaker syntax element specific parsing processes (ae(v))

| Syntax element | Parsing | Parameters |
|---|---|---|
| mesh_position_fine_residual[ ][ ] | K.2.5 (TU + Egk + S) | maxOffset = 7, k = |
| | | 2 |
| mesh_position_coarse_residual[ ][ ] | K.2.5 (TU + Egk + S) | maxOffset = 7, k = |
| | | 2 |
| \hat{ }mesh_attribute_fine_residual[ ][ ][ ]\hat{ } | /* TEXCOORD */ | /* TEXCOORD */ |
| | K.2.5 (TU + Egk + S) | |
| | \hat{ } /* NORMAL */ | maxOffset = 7, k = |
| | K.2.5 (TU + Egk + S) | 2 |
| | \hat{ } | \hat{ } /* NORMAL */ |
| | /* MATERIAL_ID | maxOffset = 7, k = |
| | */ | 5 \hat{ } |
| | K.2.3 (Egk) | /* MATERIAL_ID |
| | | */ |
| | | k = 2 |
| \hat{ } mesh_attribute_coarse_residual[ ][ ][ ]\hat{ } | /* TEXCOORD */ | /* TEXCOORD */ |
| | K.2.5 (TU + Egk + S) | maxOffset = 7, k = |
| | \hat{ } /* NORMAL */ | 2 |
| | K.2.5 (TU + Egk + | \hat{ } /* NORMAL */ |
| | S) \hat{ } | maxOffset = 7, k = |
| | | 5/* \hat{ } |
| \hat{ } mesh_normal_octahedral_second_residual[ ][ ][ ] \hat{ } | \hat{ } K.2.5 (TU + Egk + | \hat{ } maxOffset = 7, k |
| | S) \hat{ } | = 1 \hat{ } |
| mesh_clers_symbol[ ] | K.2.7 | |
| mesh_attribute_seam [ ][ ] | K.2.1 (FL) | numBins =1 |
| mesh_texcoord_stretch_orientation[ ]]] | K.2.1 (FL) | numBins = 1 |
| mesh_handle_first_sign[ ] | K.2.1 (FL) | numBins = 1 |
| mesh_handle_second_shift[ ] | K.2.1 (FL) | numBins = 1 |
| mesh_handle_first_variable_delta_length4_minus1[i] | K.2.6 (TU) | maxVal = 8 |
| mesh_handle_first_variable_delta[i] | K.2.1 (FL) | numBins = |
| | | 4*(D1L + 1) |
| mesh_handle_second_variable_delta_length4_minus1[i] | K.2.6 (TU) | maxVal = 8 |
| mesh_handle_second_variable_delta[i] | K.2.1 (FL) | numBins = |
| | | 4*(D2L + 1) |
| mesh_position_is_duplicate_flag[ ] | K.2.1 (FL) | numBins =1 |
| mesh_attribute_is_duplicate_flag[ ][ ] | K.2.1 (FL) | numBins =1 |
| mesh_materialid_default_not_equal_flag[ ][ ] | K.2.1 (FL) | numBins =1 |
| mesh_materialid_default_left_flag[ ][ ] | K.2.1 (FL) | numBins =1 |
| mesh_materialid_default_right_flag[ ][ ] | K.2.1 (FL) | numBins =1 |
| mesh_materialid_default_facing_flag[ ][ ] | K.2.1 (FL) | numBins =1 |

TABLE 9
Technique 4: Updated values of context (CtxTbl and CtxIdx)
for MPEG Edge Breaker binarized ae(v) coded syntax elements

| Syntax element | CtxTbl | CtxIdx | | Count |
|---|---|---|---|---|
| mesh_position_fine_residual[ ][ ] | 1 | Offset | Min(1, | 2 |
| | | | BinIdxTu) | |
| | | Prefix | 2 + Min(4, | 5 |
| | | (BinIdxPf | BinIdxPfx) | |
| | | x <= 4) | | |
| | | Prefix | bypass | 0 |
| | | (BinIdxPf | | |
| | | x > 4) | | |
| | | Suffix | 7 + Min(4, | 5 |
| | | | BinIdxSfx) | |
| | | Sign | bypass | 0 |
| mesh_position_coarse_residual[ ][ ] | 1 | Offset | Min(2, | 3 |
| | | | BinIdxTu) | |
| | | Prefix | 3 + Min(4, | 5 |
| | | (BinIdx Pf | BinIdxPfx) | |
| | | x <= 4) | | |
| | | Prefix | bypass | 0 |
| | | (BinIdxPf | | |
| | | x > 4) | | |
| | | Suffix | 8 + Min(4, | 5 |
| | | | BinIdxSfx) | |
| | | Sign | bypass | 0 |
| mesh_attribute_fine_residual[ ][ ][ ] | 1 | Offset | Min(1, | 2 |
| /* TEXCOORD */ | | | BinIdxTu) | |
| nbPfxCtx = 5, nbSfxCtx = 4 | | Prefix | 2 + | 12 |
| /* NORMAL */ | | (BinIdxPf | Min(nbPfxCt | |
| nbPfxCtx = nbSfxCtx = 12 | | x <= | x −1, | |
| /* MATERIAL_ID */ | | nbPfxCtx | BinIdxPfx) | |
| nbPfxCtx = nbSfxCtx = 8 | | −1) | | |
| | | Prefix | bypass | 0 |
| | | (BinIdxPf | | |
| | | x > | | |
| | | nbPfxCtx | | |
| | | −1) | | |
| | | Suffix | 14 + | 12 |
| | | | Min(nbSfxCt | |
| | | | x−1, | |
| | | | BinIdxSfx) | |
| | | Sign | bypass | 0 |
| mesh_attribute_coarse_residual[ ][ ][ ] | 1 | Offset | \hat{ } Min(bctx − | \hat{ } 3 \hat{ } |
| /* TEXCOORD */ | | | 1, BinIdxTu) | |
| nbPfxCtx = 5, nbSfxCtx = 4, \hat{ } bctx = 3 \hat{ } | | | \hat{ } | |
| /* NORMAL */ | | Prefix | \hat{ } 3 + | \hat{ } 12 \hat{ } |
| nbPfxCtx = nbSfxCtx = 12, \hat{ } bctx = 2 \hat{ } | | \hat{ } | Min(nbPfxCt | |
| | | (BinIdxPf | x −1, | |
| | | x <= | BinIdxPfx) \hat{ } | |
| | | nbPfxCtx | | |
| | | −1) \hat{ } | | |
| | | Prefix | bypass | 0 |
| | | (BinIdxPf | | |
| | | x > | | |
| | | nbPfxCtx | | |
| | | −1) | | |
| | | Suffix | 15 + | 12 |
| | | | Min(nbSfxCt | |
| | | | x−1, | |
| | | | BinIdxSfx) | |
| | | Sign | bypass | 0 |
| mesh_clers_symbol[ ] | 5 | CtxClers ( subclause | | 30 |
| | | I.10.3.4.1) | | |
| mesh_attribute_seam[ ][ ] | 6 | 0 | | 1 |
| mesh_texcoord_stretch_orientation[ ][ ] | 7 | 0 | | 1 |
| mesh_handle_first_sign[ ] | 8 | 0 | | 1 |
| mesh_handle_second_shift[ ] | 9 | 0 | | 1 |
| mesh_handle_first_variable_delta_length4_minus1[ | 10 | Min(3, BinIdxTu) | | 4 |
| ] | | | | |
| mesh_handle_first_variable_delta[ ] | 11 | bypass | | 0 |
| mesh_handle_second_variable_delta_length4_min | 12 | Min(3, BinIdxTu) | | 4 |
| us1[ ] | | | | |
| mesh_handle_second_variable_delta[ ] | 13 | bypass | | 0 |
| mesh_position_is_duplicate_flag[ ] | 14 | 0 | | 1 |
| mesh_attribute_is_duplicate_flag[ ][ ] | 15 | 0 | | 1 |
| mesh_materialid_default_not_equal_flag[ ][ ] | 16 | 0 | | 1 |
| mesh_materialid_default_left_flag[ ][ ] | 17 | 0 | | 1 |
| mesh_materialid_default_right_flag[ ][ ] | 18 | 0 | | 1 |
| mesh_materialid_default_facing_flag[ ][ ] | 19 | 0 | | 1 |
| \hat{ } mesh_normal_octahedral_second_residual[ ][ ][ ] | \hat{ } 1 \hat{ } | Offset | \hat{ } Min(2, | \hat{ }3\hat{ } |
| \hat{ } | | | BinIdxTu) \hat{ } | |
| | | \hat{ }Prefix | \hat{ }2 + Min(11, | \hat{ }12\hat{ } |
| | | (BinIdxPf | BinIdxPfx)\hat{ } | |
| | | x <= 0)\hat{ } | | |
| | | \hat{ }Prefix | bypass | 0 |
| | | (BinIdxPf | | |
| | | x > 0)\hat{ } | | |
| | | Suffix | \hat{ }15 + Min(1, | \hat{ }1\hat{ } |
| | | | BinIdxSfx)\hat{ } | |
| | | Sign | \hat{ }bypass\hat{ } | \hat{ }0\hat{ } |

### Technique 5: Updated Context Selection for Normal Encoding

This disclosure also describes a new process for context selection for normal vector encoding within the base mesh encoder/static mesh encoder of V-DMC TMM v9.0.

### Normals Attribute Fine Residuals (Mesh_Attribute_Fine_Residuals)

maxOffset=7
k=5
const auto bctx=2
maxPrefixIdx=11, nbPrefixIdx=11
maxSuffixIdx=1, nbSuffixIdx=1.
Employ context Sharing.
Employ bypass coding.

### Normals Attribute Coarse Residuals (Mesh_Attribute_Coarse_Residuals)

maxOffset=7
k=1
const auto bctx=1
maxPrefixIdx=1, nbPrefixIdx=8
maxSuffixIdx=1, nbSuffixIdx=1.
Employ context Sharing.
Employ bypass coding.

### Normals Octahedral Second Residuals (Mesh_Normal_Octahedral_Second_Residuals)

maxOffset=7
k=1
const auto bctx=2
maxPrefixIdx=1, nbPrefixIdx=1
maxSuffixIdx=1, nbSuffixIdx=1
Employ context Sharing.
Employ bypass coding with Bypass after first bin.

### Explanation:

Context is being shared between other attributes and normal vector attributes.
Context is being shared between fine, coarse, and 2nd residuals of normal vector attribute encoding. The mesh_attribute_fine_residuals, mesh_attribute_coarse_residuals, and mesh_normal_octahedral_second_residuals would share context between each other for Normal attribute.
Bypass encoding is implemented in fine, coarse, and 2nd residuals of normal vector attribute encoding. The normal vector residuals would employ limited context coding with bypass coding implemented.
Bypass encoding is implemented both in prefix and suffix parts.

FIG. 30A and FIG. 30B show the implementation of normal contexts in TMM v9.0 that is explained above as well as in the two syntax tables ahead. Specifically, FIG. 30A shows a context assignment scheme 3000 for mesh position fine residual syntax elements, a context assignment scheme 3002 for mesh position coarse residual syntax elements, and a context assignment scheme 3004 for mesh texture fine residual syntax elements. FIG. 30B shows a context assignment scheme 3050 for mesh texture coarse residual syntax elements, a context assignment scheme 3052 for mesh normal fine residual elements, a context assignment scheme 3054 for mesh normal coarse residual elements, and a context assignment scheme 3056 for normal second residual syntax elements.

The following are the syntax table changes taken from the specification of Study of technologies for Video-based mesh coding, ISO/IEC JTC1/SC29/WG7, MDS24196_WG07_N00960, July 2024. The lines between \hat{ } characters is either changed or updated by this disclosure.

TABLE K-2
MPEG EdgeBreaker syntax element specific parsing processes (ae(v))

| Syntax element | Parsing | Parameters |
|---|---|---|
| mesh_position_fine_residual[ ][ ] | K.2.5 (TU + EGk + S) | maxOffset = 7, k = 2 |
| mesh_position_coarse_residual[ ][ ] | K.2.5 (TU + EGk + S) | maxOffset = 7, k = 2 |
| mesh_attribute_fine_residual[ ][ ][ ] | /* TEXCOORD */ | /* TEXCOORD */ |
| | K.2.5 (TU + EGk + S) | \hat{ }maxOffset = 10\hat{ }, k = |
| | /* NORMAL */ | 2 |
| | K.2.5 (TU + EGk + S) | \hat{ }/* NORMAL */\hat{ } |
| | /* GENERIC*/ | \hat{ }maxOffset = 7, k = 5\hat{ } |
| | K.2.5 (TU + EGk + S) | /* GENERIC*/ |
| | /* MATERIAL_ID */ | maxOffset = 7, k = 2 |
| | K.2.3 (EGk) | /* MATERIAL_ID */ |
| | | k = 2 |
| mesh_attribute_coarse_residual[ ][ ][ ] | /* TEXCOORD */ | /* TEXCOORD */ |
| | K.2.5 (TU + EGk + S) | maxOffset = 7, k = 2 |
| | /* NORMAL */ | \hat{ }/* NORMAL */\hat{ } |
| | K.2.5 (TU + EGk + S) | \hat{ }maxOffset = 7, k = [symbol] |
| | /* GENERIC */ | 1\hat{ } |
| | K.2.5 (TU + EGk + S) | /* GENERIC*/ |
| | | maxOffset = 7, k = 2 |
| \hat{ }mesh_normal_octahedral_second_residual[ ][ ][ ]\hat{ } | \hat{ }K.2.5 (TU + EGk + S)\hat{ } | \hat{ }maxOffset = 7, k = 1\hat{ } |
| mesh_clers_symbol[ ] | K.2.7 | |
| mesh_attribute_seam[ ][ ] | K.2.1 (FL) | numBins =1 |
| mesh_texcoord_stretch_orientation[ ][ ] | K.2.1 (FL) | numBins = 1 |
| mesh_handle_first_sign[ ] | K.2.1 (FL) | numBins = 1 |
| mesh_handle_second_shift[ ] | K.2.1 (FL) | numBins = 1 |
| mesh_handle_first_variable_delta_length4_minus1[i] | K.2.6 (TU) | maxVal = 8 |
| mesh_handle_first_variable_delta[i] | K.2.1 (FL) | numBins = 4*(D1L + |
| | | 1) |
| mesh_handle_second_variable_delta_length4_minus1[i] | K.2.6 (TU) | maxVal = 8 |
| mesh_handle_second_variable_delta[i] | K.2.1 (FL) | numBins = 4*(D2L + |
| | | 1) |
| mesh_position_is_duplicate_flag[ ] | K.2.1 (FL) | numBins =1 |
| mesh_attribute_is_duplicate_flag[ ][ ] | K.2.1 (FL) | numBins =1 |
| mesh_materialid_default_not_equal_flag[ ][ ] | K.2.1 (FL) | numBins =1 |
| mesh_materialid_default_left_flag[ ][ ] | K.2.1 (FL) | numBins =1 |
| mesh_materialid_default_right_flag[ ][ ] | K.2.1 (FL) | numBins =1 |
| mesh_materialid_default_facing_flag[ ][ ] | K.2.1 (FL) | numBins =1 |

TABLE K-8
Values of CtxTbl and CtxIdx for MPEG Edge Breaker binarized ae(v) coded syntax elements

| Syntax element | CtxTbl | CtxIdx | |
|---|---|---|---|
| mesh_position_fine_residual[ ][ ] | 1 | Offset | Min(1, BinIdxTu) |
| | | Prefix | 3 + Min(4, BinIdxPfx) |
| | | (BinIdxPfx <= 5) | |
| | | Prefix | bypass |
| | | (BinIdxPfx > 5) | |
| | | Suffix | 15 + Min(4, |
| | | (BinIdxSfx <= 5) | BinIdxSfx) |
| | | Suffix | bypass |
| | | (BinIdxSfx > 5) | |
| | | Sign | bypass |
| mesh_position_coarse_residual[ ][ ] | 1 | Offset | Min(2, BinIdxTu) |
| | | Prefix | 3 + Min(4, BinIdxPfx) |
| | | (BinIdxPfx <= 5) | |
| | | Prefix | bypass |
| | | (BinIdxPfx > 5) | |
| | | Suffix | 15 + Min(4, |
| | | (BinIdxSfx <= 5) | BinIdxSfx) |
| | | Suffix | bypass |
| | | (BinIdxSfx > 5) | |
| | | Sign | bypass |
| mesh_attribute_fine_residual[ ][ ][ ] | 1 | Offset | Min(1, BinIdxTu) |
| /* TEXCOORD */ | | | |
| nbPfxCtx = 6, nbSfxCtx = 6 | | | |
| maxPfxCtx = 4, maxSfxCtx = 4 | | Prefix | 3 + Min(maxPfxCtx −1, |
| /* NORMAL */ | | (BinIdxPfx <= | BinIdxPfx) |
| \hat{ }nbPfxCtx = [symbol] 11, nbSfxCtx = [symbol] 1\hat{ } | | nbPfxCtx −1) | |
| \hat{ }maxPfxCtx = [symbol] 11, maxSfxCtx = [symbol] 1 \hat{ } | | Prefix | bypass |
| /* GENERIC */ | | (BinIdxPfx > | |
| nbPfxCtx = nbSfxCtx = 12 | | nbPfxCtx −1) | |
| maxPfxCtx = maxSfxCtx = 12 | | Suffix | 15 + Min(maxSfxCtx − |
| /* MATERIAL_ID */ | | (BinIdxSfx <= | 1, BinIdxSfx) |
| nbPfxCtx = nbSfxCtx = 8 | | nbSfxCtx −1) | |
| maxPfxCtx = maxSfxCtx = 8 | | Suffix | bypass |
| | | (BinIdxSfx > | |
| | | nbSfxCtx −1) | |
| | | Sign | bypass |
| mesh_attribute_coarse_residual [ ][ ][ ] | 1 | Offset | Min(bctx − 1, |
| /* TEXCOORD */ | | | BinIdxTu) |
| nbPfxCtx = 6, nbSfxCtx = 6 | | | |
| maxPfxCtx = 4, maxSfxCtx = 4 | | Prefix | 3 + Min(maxPfxCtx −1, |
| bctx = 3 | | (BinIdxPfx <= | BinIdxPfx) |
| /* NORMAL */ | | nbPfxCtx −1) | |
| \hat{ }nbPfxCtx = [symbol] 8, nbSfxCtx = [symbol] 1\hat{ } | | Prefix | bypass |
| \hat{ }maxPfxCtx = [symbol] 1, maxSfxCtx = [symbol] 1 \hat{ } | | (BinIdxPfx > | |
| \hat{ }bctx = [symbol] 1\hat{ } | | nbPfxCtx −1) | |
| /* GENERIC */ | | Suffix | 15 + Min(maxSfxCtx − |
| nbPfxCtx = nbSfxCtx = 12 | | (BinIdxSfx <= | 1, BinIdxSfx) |
| maxPfxCtx = maxSfxCtx = 12 | | nbSfxCtx −1) | |
| bctx = 3 | | Suffix | bypass |
| | | (BinIdxSfx > | |
| | | nbSfxCtx −1) | |
| | | Sign | bypass |
| \hat{ }mesh_normal_octahedral_second_residual[ ][ | \hat{ }1\hat{ } | \hat{ }Offset\hat{ } | \hat{ }Min( [symbol] 1, BinIdxTu)\hat{ } |
| ][ ]\hat{ } | | \hat{ }Prefix | \hat{ }3\hat{ } |
| | | [symbol] \hat{ } | |
| | | [symbol] | [symbol] |
| | | [symbol] | |
| | | \hat{ }Suffix\hat{ } | \hat{ }15\hat{ } |
| | | \hat{ }Sign\hat{ } | \hat{ }bypass\hat{ } |

| | | |
|---|---|---|
| mesh_clers_symbol[ ] | 2 | CtxClers ( subclause I.10.3.4.1) |
| mesh_attribute_seam[ ][ ] | 3 | 0 |
| mesh_texcoord_stretch_orientation[ ][ ] | 4 | 0 |
| mesh_handle_first_sign[ ] | 5 | 0 |

FIG. 31 is a flowchart illustrating an example operation of V-DMC encoder 200 in accordance with one or more techniques of this disclosure. In the example of FIG. 31, V-DMC encoder 200 may receive an input mesh (3100). Furthermore, V-DMC encoder 200 may generate a base mesh based on the input mesh (3102). For example, V-DMC encoder 200 may decimate the input mesh to determine the base mesh, e.g., as described above.

V-DMC encoder 200 may determine a normal vector for a first vertex of the base mesh (3104). In some examples, to determine the normal vector of a vertex, such as the first vertex, V-DMC encoder 200 may determine the normal vectors of faces that share the vertex (e.g., by calculating a cross-product of two edge vectors of the face) and then averaging the normal vectors of the faces. In some examples, a weighted average of the normal vectors of the faces is used to determine the normal vector of the vertex.

Furthermore, V-DMC encoder 200 may apply a first prediction method to generate a first prediction of a component of the normal vector of the first vertex (3106). For instance, V-DMC encoder 200 may use a fine prediction method, such as a multi-parallelogram prediction method, to generate the prediction of the component of the normal vector of the first vertex.

V-DMC encoder 200 may determine a value of a component of a first prediction residual (3108). The value of the component of the first prediction residual may indicate a difference between the prediction of the component of the normal vector of the first vertex and a value of the component of the normal vector of the first vertex. For example, V-DMC encoder 200 may subtract, on a component-by-component basis, the first prediction from the normal vector of the first vertex.

Additionally, V-DMC encoder 200 may generate first entropy-encoded data by applying entropy encoding to first data (3110). The first data is a binarized representation of a first syntax element (e.g., mesh_attribute_fine_residual) that indicates a value of the a component of the first residual value of the normal vector of the first vertex. The first data comprises first truncated unary (TU) data and a first exponential-Golomb code, and the first exponential-Golomb code comprises a first prefix and a first suffix.

V-DMC encoder 200 may generate second entropy-encoded data by applying entropy encoding to second data (3112). The second data is a binarized representation of a second syntax element (e.g., mesh_normal_octahedral_second_residuals) that indicates a second residual value of the component of the normal vector of the first vertex. The second residual value may indicate a difference between a value of the component of the normal vector of the first vertex and the value of the component of the normal vector of the first vertex reconstructed from an octahedral representation of the component of the normal vector of the first vertex. The second data comprises second truncated unary (TU) data and a second exponential-Golomb code, and the second exponential-Golomb code comprises a second prefix and a second suffix.

Furthermore, V-DMC encoder 200 may determine a normal vector for a second vertex of the base mesh (3114). V-DMC encoder 200 may apply a second prediction method to generate a second prediction of the component of the normal vector of the first vertex (3116). For instance, V-DMC encoder 200 may use a coarse prediction method, such as a cross prediction or delta prediction, to generate the prediction of the component of the normal vector of the first vertex.

In general, delta prediction uses the normal of either a previous or a next vertex to generate the prediction of the component of the normal vector of the first vertex. Table 1, below, includes example code for the delta prediction scheme.

TABLE 1
Delta Prediction Scheme for Normal Encoding

```
void EBReversiEncoder::normalEncodeWithPredictionDelta(const int c) {
  const auto& ov = _ovTable;
  const auto& V = ov.V;
  const auto& O = ov.O;
  const auto& Norm = ov.normals;
  const auto& v = ov.v(c);
  // is vertex already predicted ?
  if (MV[v] > 0)
    return;
  // mark the vertex
  MV[v] = 1;
  oNrmFine.push_back(false); // Always False for Delta
```

| | |
|---|---|
| glm::vec3 predNorm(0, 0, 0); | // the predicted position |
| int count = 0; | // number of valid parallelograms |
| | found |

```
  int altC = c;
  // loop through corners attached to the current vertex
  // swing right around the fan
  int nextC = ov.n(O[ov.n(altC)]);
  while (nextC >= 0 && nextC != c)
  {
    altC = nextC;
    nextC = ov.n(O[ov.n(altC)]);
  };
  bool isBoundary = (nextC != c);
  // 1. Use delta with available values
  const auto& c_p_v = ov.v(ov.p(c));
  const auto& c_n_v = ov.v(ov.n(c));
  if (c_p_v > −1 && MV[c_p_v] > −1) {
    if (cfg.useOctahedral) {
      calculate2DResiduals(Norm[v], Norm[c_p_v]);
    }
    else
      oNormals.push_back(Norm[v] − Norm[c_p_v]);
    return;
  }
  if (c_n_v > −1 && MV[c_n_v] > −1) {
    if (cfg.useOctahedral) {
      calculate2DResiduals(Norm[v], Norm[c_n_v]);
    }
    else
      oNormals.push_back(Norm[v] − Norm[c_n_v]);
    return;
  }
  // 2. if on a boundary
  // then may use deltas from previous vertex on the boundary
  if (isBoundary) {
```

| | |
|---|---|
| const auto b = ov.p(altC); | // b is on boundary |

```
    const auto b_v = ov.v(b);
    auto marked = MV[b_v];
    if (marked > −1) {
      if (cfg.useOctahedral) {
      calculate2DResiduals(Norm[v], Norm[b_v]);
      }
      else
        oNormals.push_back(Norm[v] − Norm[b_v]);
      return;
    }
  }
  // 3. no other choice
```

| | |
|---|---|
| osNormals.push_back(Norm[v]); | // global value (it is a start, |
| | pushed in separate table) |

}

The following describes delta prediction. First loop through corners attached to the current vertex to find whether the current vertex is on a boundary or not. Then, check whether the previous vertex's normal has been visited/encoded/decoded. If yes, then use the previous vertex's normal as the prediction and end the prediction scheme. Then check whether the next vertex's normal has been visited/encoded/decoded. If yes, then use the next vertex's normal as the prediction and end the prediction scheme. If both the previous and next vertex's normals are not available, then see if the current vertex is on the boundary. If yes, then use the boundary neighboring vertex's normal as the prediction and end the prediction scheme. If none of these are true, this means that the current vertex is the very first starting vertex of the encoding scheme and therefore, would store the global value of this vertex's normal rather than predicting the normal.

In general, the multi-parallelogram prediction method This multi-parallelogram prediction scheme for normals is similar to the multi-parallelogram prediction scheme employed for positions/geometry. Table 2, below, includes example code the MPARA.

TABLE 2
Multi-parallelogram Prediction Scheme for Normal Encoding

```
void EBReversiEncoder::normalEncodeWithPredictionMPARA(const int c) {
  const auto MAX_PARALLELOGRAMS = 4;
  const auto& ov = _ovTable;
  const auto& V = ov.V;
  const auto& O = ov.O;
  const auto& Norm = ov.normals;
  const auto& v = ov.v(c);
  // is vertex already predicted ?
  if (MV[v] > 0)
    return;
  // mark the vertex
  MV[v] = 1;
  // go around the fan of a vertex and predict using all the parallelograms.
  // A parallelogram consists of the current, next, previous, and opposite vertex.
  // The previous, next, and opposite vertex is employed to predict the normal of
  // the current vertex.
```

| | |
|---|---|
| glm::vec3 predNorm(0, 0, 0); | // the predicted normals |
| int count = 0; | // number of valid parallelograms found |

```
  int altC = c;
  // loop through corners attached to the current vertex
  // swing right around the fan
  int nextC = ov.n(O[ov.n(altC)]);
  while (nextC >= 0 && nextC != c)
  {
    altC = nextC;
    nextC = ov.n(O[ov.n(altC)]);
  };
  bool isBoundary = (nextC != c);
  // now in position on the right most corner sharing v
  // turn left an evaluate the possible predictions
  const int startC = altC;
  do
  {
    if (count >= MAX_PARALLELOGRAMS) break;
    const auto& oppoV = ov.v(O[altC]);
    const auto& prevV = ov.v(ov.p(altC));
    const auto& nextV = ov.v(ov.n(altC));
    if ((oppoV > −1 && prevV > −1 && nextV > −1) &&
      ((MV[oppoV] > 0) && (MV[prevV] > 0) && (MV[nextV] > 0)))
    {
      // parallelogram prediction estNorm = prevNrm + nextNrm − oppoNrm
      glm::vec3 estNorm = Norm[prevV] + Norm[nextV] − Norm[oppoV];
```

| | |
|---|---|
| predNorm += estNorm; | // accumulate parallelogram predictions |

```
      ++count;
    }
```

| | |
|---|---|
| altC = ov.p(O[ov.p(altC)]); | // swing around the triangle fan |
| } while (altC >= 0 && altC != startC); | // incomplete fan or full rotation |

```
  // 1. use parallelogram prediction when possible
  if (count > 0) {
    predNorm = glm::round(predNorm / glm::vec3(count));
    // center the prediction.
    const int32_t center = ( 1u << static_cast<uint32_t>( qn−1 ) );
    for (int c = 0; c < 3; c++) {
      predNorm[c] = predNorm[c] − center;
    }
    // normalize the prediction
    predNorm = glm::normalize( predNorm );
    if (!std::isnan( predNorm[0] ) ) {
      // Quantize the normals
```

| | |
|---|---|
| const glm::vec3 minNrm | = {−1.0, −1.0, −1.0}; |
| const glm::vec3 maxNrm | = {1.0, 1.0, 1.0}; |
| const glm::vec3 diag | = maxNrm − minNrm; |
| const float range | = std::max( std::max( diag.x, diag.y ), diag.z ); |

```
      const int32_t maxNormalQuantizedValue = ( 1u << static_cast<uint32_t>( qn
) ) − 1;
      for (int c = 0; c < 3; c++) {
        predNorm[c] = static_cast<float>(std::floor( ( ( predNorm[c] − minNrm[c] ) /
range ) *
```

maxNormalQuantizedValue + 0.5f ) );

```
      }
      if (cfg.useOctahedral) {
        calculate2DResiduals(Norm[v], predNorm);
      }
      else
        oNormals.push_back(Norm[v] − predNorm);
      oNrmFine.push_back(true);
      return;
    }
  }
        // 2. or fallback to delta with available values
        const auto& c_p_v = ov.v(ov.p(c));
        const auto& c_n_v = ov.v(ov.n(c));
        if (c_p_v > −1 && MV[c_p_v] > −1) {
          if (cfg.useOctahedral) {
            calculate2DResiduals(Norm[v], Norm[c_p_v]);
          }
          else
            oNormals.push_back(Norm[v] − Norm[c_p_v]);
          oNrmFine.push_back(false);
          return;
        }
        if (c_n_v > −1 && MV[c_n_v] > −1) {
          if (cfg.useOctahedral) {
            calculate2DResiduals(Norm[v], Norm[c_n_v]);
          }
          else
            oNormals.push_back(Norm[v] − Norm[c_n_v]);
          oNrmFine.push_back(false);
          return;
        }
        // 3. if on a boundary
        // then may use deltas from previous vertex on the boundary
        if (isBoundary) {
          const auto b = ov.p(startC); // b is on boundary
          const auto b_v = ov.v(b);
          auto marked = MV[b_v];
          if (marked > −1) {
            if (cfg.useOctahedral) {
              calculate2DResiduals(Norm[v], Norm[b_v]);
            }
            else
              oNormals.push_back(Norm[v] − Norm[b_v]);
            oNrmFine.push_back(false);
            return;
          }
        }
        // 4. no other choice
```

| | |
|---|---|
| osNormals.push_back(Norm[v]); | // global value (it is a start, pushed |

in separate table)
}

To perform multi-parallelogram prediction for normal, first loop through corners attached to the current vertex to find whether the current vertex is on a boundary or not. Once the loop ends, the process would be on the on the right most corner sharing the current vertex and the process would turn left one triangle at a time and evaluate the possible predictions. For each triangle visited, the process checks if the next, previous, and the opposite corners have been visited/encoded/decoded in the past. If yes, then all three are available and the process can predict the current vertex's normal using the formula:

$$N\_current = N\_next + N\_previous - N\_opposite$$

The parallelogram formula calculates the current corner's normal by adding the next and previous corner's normals and subtracting the opposite corner's normal. By rotating around the fan, multiple parallelogram predictions are performed, and the predictions are accumulated. Afterwards, the average of the predictions is taken to find the final predictions. The final prediction may be normalized and converted to unsigned integer. If for some reason the multi-parallelogram prediction cannot be performed, then the prediction scheme falls back on Delta prediction and follows the steps outlined above and Table 1. The derivation behind the formula shown for parallelogram prediction before is shown below:

$$N\_midPN = ( ( N\_next + N\_previous ) ) / 2$$

$$N\_current = N\_midPN - ( N\_opposite - N\_midPN$$

$$N\_current = N\_next + N\_previous - N\_opposite$$

In general, cross prediction is a cross product-based prediction scheme. This prediction scheme uses geometry of the current and neighboring vertices to predict the normal of the current vertex. Cross prediction shown in Table 3, below, employs the following steps. First, loop through corners attached to the current vertex to find whether the current vertex is on a boundary or not. Once the loop ends, the process would be on the on the right most corner sharing the current vertex and the process would turn left one triangle at a time and evaluate the possible predictions. For each triangle, find two vectors. The first vector is from current to previous vertex. The second vector is from current to next vertex. The process then performs cross-product of these two vectors to obtain the current vertex's normal. The predictions from multiple triangles are accumulated and averaged to obtain the final prediction. The final prediction may be normalized and converted to unsigned integer. If for some reason the multi-parallelogram prediction cannot be performed, then the prediction scheme falls back on Delta prediction and follows the steps outlined above and in Table 1. In some cases, unlike multi-parallelogram, the cross-prediction scheme may not use opposite corner and, therefore, may not use the whole parallelogram. Instead, it employs only a triangle formed by current, previous, and next corners.

TABLE 3
Cross product-based Prediction Scheme for Normal Encoding

```
void EBReversiEncoder::normalEncodeWithPredictionCross(const int c) {
  const auto& ov = _ovTable;
  const auto& V = ov.V;
  const auto& O = ov.O;
  const auto& Norm = ov.normals;
  const auto& G = ov.positions;
  const auto& v = ov.v(c);
  // is vertex already predicted ?
  if (MV[v] > 0)
    return;
  // mark the vertex
  MV[v] = 1;
  // Go around the fan and start getting cross products of vectors to predict normals
  // Average all the predictions to obtain the final prediction.
```

| | |
|---|---|
| glm::vec3 predNorm(0, 0, 0); | // the predicted normals |
| int count = 0; | // number of valid parallelograms found |

```
  int altC = c;
  // loop through corners attached to the current vertex
  // swing right around the fan
  int nextC = ov.n(O[ov.n(altC)]);
  while (nextC >= 0 && nextC != c)
  {
    altC = nextC;
    nextC = ov.n(O[ov.n(altC)]);
  };
  bool isBoundary = (nextC != c);
  // now in position on the right most corner sharing v
  // turn left an evaluate the possible predictions
  const int startC = altC;
  do
  {
    const auto& prevV = ov.v(ov.p(altC));
    const auto& nextV = ov.v(ov.n(altC));
    /*if ((prevV > −1 && nextV > −1) &&
      ((MV[prevV] > 0) && (MV[nextV] > 0)))*/
    if (prevV > −1 && nextV > −1)
    {
      const glm::vec3 v12 = G[prevV] − G[v];
      const glm::vec3 v13 = G[nextV] − G[v];
```

| | |
|---|---|
| predNorm += glm::cross( v13, v12 ); | // Accumulate predictions |

```
      ++count;
    }
```

| | |
|---|---|
| altC = ov.p(O[ov.p(altC)]); | // swing around the triangle fan |
| } while (altC >= 0 && altC != startC); | // incomplete fan or full rotation |

```
  // 1. use cross products
  if (count > 0) {
    // normalize the prediction
    predNorm = glm::normalize( predNorm );
    if (!std::isnan( predNorm[0] ) ) {
      // Quantize the normals
```

| | |
|---|---|
| const glm::vec3 minNrm | = {−1.0, −1.0, −1.0}; |
| const glm::vec3 maxNrm | = {1.0, 1.0, 1.0}; |
| const glm::vec3 diag | = maxNrm − minNrm; |
| const float range | = std::max( std::max( diag.x, diag.y ), diag.z ); |
| const int32_t maxNormalQuantizedValue | = ( 1u << static_cast<uint32_t>( qn |

```
) ) − 1;
      for (int c = 0; c < 3; c++) {
        predNorm[c] = static_cast<float>(std::floor( ( ( predNorm[c] − minNrm[c] ) /
range ) *
```

```
            maxNormalQuantizedValue + 0.5f
      ) );
```

```
      }
      if (cfg.useOctahedral) {
        calculate2DResiduals(Norm[v], predNorm);
      }
      else
        oNormals.push_back(Norm[v] − predNorm);
      oNrmFine.push_back(true);
      return;
    }
  }
          // 2. or fallback to delta with available values
        const auto& c_p_v = ov.v(ov.p(c));
        const auto& c_n_v = ov.v(ov.n(c));
        if (c_p_v > −1 && MV[c_p_v] > −1) {
          if (cfg.useOctahedral) {
            calculate2DResiduals(Norm[v], Norm[c_p_v]);
          }
          else
            oNormals.push_back(Norm[v] − Norm[c_p_v]);
          oNrmFine.push_back(false);
          return;
        }
        if (c_n_v > −1 && MV[c_n_v] > −1) {
          if (cfg.useOctahedral) {
            calculate2DResiduals(Norm[v], Norm[c_n_v]);
          }
          else
            oNormals.push_back(Norm[v] − Norm[c_n_v]);
          oNrmFine.push_back(false);
          return;
        }
        // 3. if on a boundary
        // then may use deltas from previous vertex on the boundary
        if (isBoundary) {
          const auto b = ov.p(startC); // b is on boundary
          const auto b_v = ov.v(b);
          auto marked = MV[b_v];
          if (marked > −1) {
            if (cfg.useOctahedral) {
              calculate2DResiduals(Norm[v], Norm[b_v]);
            }
            else
              oNormals.push_back(Norm[v] − Norm[b_v]);
            oNrmFine.push_back(false);
            return;
          }
        }
        // 4. no other choice
```

| | |
|---|---|
| osNormals.push_back(Norm[v]); | // global value (it is a start, pushed |

in separate table)
}

V-DMC encoder 200 may determine a value of a component of a second prediction residual (3118). The value of the component of the second prediction residual may indicate a difference between the prediction of the component of the normal vector of the second vertex and a value of the component of the normal vector of the second vertex. V-DMC encoder 200 may determine the value of the component of the first prediction residual of the normal vector of the second vertex in the same way as the first vertex.

V-DMC encoder 200 may generate third entropy-encoded data by applying entropy encoding to third data (3120). The third data is a binarized representation of a third syntax element that indicates the value of the component of the second prediction residual. The third data comprises third truncated unary (TU) data and a third exponential-Golomb code, and the third exponential-Golomb code comprises a third prefix and a third suffix.

When generating the first, second, and third entropy-encoded data, V-DMC encoder 200 may use a first shared non-bypass context for entropy encoding at least one bin of each of the first TU data, the second TU data, and the third TU data. For instance, in the example of FIG. 30B, the context A0 may be shared among the TU data for the mesh normal fine residual syntax element (e.g., first syntax element), the TU data for the normal second residual syntax element (e.g., second syntax element), and the TU data for the mesh normal coarse residual syntax element. Similarly, as shown in FIG. 30B, when applying entropy encoding to the first data, applying the entropy encoding to the second data, and applying the entropy encoding to the third data, V-DMC encoder 200 may use a second shared non-bypass context (B0) for entropy encoding at least one bin of each of the first prefix, the second prefix, and the third prefix. Furthermore, in some examples, such as the example of FIG. 30B, V-DMC encoder 200 may use the second shared non-bypass context for entropy encoding second through eighth bins of the third prefix. In some examples, such as the example of FIG. 30B, when applying the entropy encoding to the first data, applying the entropy encoding to the second data, and applying the entropy encoding to the third data, V-DMC encoder 200 may use a third shared non-bypass context (A1) for entropy encoding each remaining bin of the first TU data and each remaining bin of the second TU data, and may use the first shared context (B0) for entropy encoding each remaining bone of the third TU data.

In some examples, such as the example of FIG. 30B, applying the entropy encoding to the first data comprises using second (B1), third (B2), fourth (B3), fifth (B4), sixth (B5), seventh (B6), eighth (B7), ninth (B8), tenth (B9), and eleventh contexts (B10) for entropy encoding second, third, fourth, fifth, sixth, seventh, eighth, ninth, tenth, and eleventh bins of the first prefix. In some examples, such as the example of FIG. 30B, when V-DMC encoder 200 is applying the entropy encoding to the first data, V-DMC encoder 200 may further apply bypass decoding to a 12th bin of the first prefix. When applying the entropy encoding to the second data, V-DMC encoder 200 may apply bypass decoding to a 2nd through 12th bin of the second prefix. When V-DMC encoder 200 is applying the entropy encoding to the third data, V-DMC encoder 200 may apply bypass decoding to a 9th through 12th bin of the third prefix. Sharing the non-bypass context in this way may reduce the number of contexts that V-DMC encoder 200 stores, which may reduce the complexity of V-DMC encoder 200.

V-DMC encoder 200 may output an encoded bitstream that includes an encoded representation of the base mesh and the first, second, and third entropy-encoded data (3122).

FIG. 32 is a flowchart illustrating an example operation of V-DMC decoder 300 for decoding a mesh from a bitstream that includes encoded mesh data, in accordance with one or more techniques of this disclosure. In the example of FIG. 36, V-DMC decoder 300 may determine, based on encoded mesh data, a base mesh with a set of vertices (3200).

V-DMC decoder 300 may use a first prediction method to generate a prediction of a component of a first normal vector of a first vertex in the set of vertices (3202). For instance, V-DMC decoder 300 may use a fine prediction method, such as a multi-parallelogram prediction method, to generate the prediction of the component of the normal vector of the first vertex.

V-DMC decoder 300 may apply entropy decoding to first entropy-encoded data in the bitstream to decode first data (3204). The first data is a binarized representation of a first syntax element (e.g., mesh_attribute_fine_residual). The first syntax element indicates a value for a component of a first prediction residual. The first prediction residual may indicate a difference between the prediction of the component of the first normal vector and a value of the component of the first normal vector. The first data comprises first TU data and a first exponential-Golomb code, the first exponential-Golomb code comprising a first prefix and a first suffix.

Additionally, V-DMC decoder 300 may apply entropy decoding to second entropy-encoded data in the bitstream to decode second data (3206). The second data is a binarized representation of a second syntax element (e.g., mesh_normal_octahedral_second_residuals). The second syntax element indicates a second residual of the component of the normal vector of the first vertex. The second residual value may indicate a difference between the original value of the component of the normal vector of the first vertex and the value of the component of the normal vector of the first vertex reconstructed from an octahedral representation of the component of the normal vector of the first vertex. The second data may comprise second truncated unary (TU) data and a second exponential-Golomb code, the second exponential-Golomb code comprising a second prefix and a second suffix.

V-DMC decoder 300 may determine the first normal vector based in part on the first prediction, the first residual value of the component of the first normal vector, and the second residual value of the component of the residual of the first normal vector (3208). For example, V-DMC decoder 300 may add the prediction of the component of the first normal vector to the first and second residuals of the component of the first normal vector to reconstruct the component of the normal vector.

Additionally, V-DMC decoder 300 may use a second prediction method to generate a prediction of a component of a second normal vector of a second vertex in the set of vertices (3210). For example, V-DMC decoder 300 may use a coarse prediction method, such as cross prediction or delta prediction, to generate the prediction of the component of the second normal vector.

V-DMC decoder 300 may apply entropy decoding to third entropy-encoded data in the bitstream to decode a third data (3212). The third data is a binarized representation of a third syntax element. The third syntax element may indicate a value of a component a second prediction residual. The value of the component of the second prediction residual indicates a difference between the prediction of the component of the second normal vector and a value of the component of the second normal vector. The third data may include third TU data and a third exponential-Golomb code, the third exponential-Golomb code comprising a third prefix and a third suffix.

V-DMC decoder 300 may determine the second normal vector based in part on the prediction of the component of the second normal vector and the value of the component of the second prediction residual (3214). For example, V-DMC decoder 300 may determine the component of the normal vector of the second vertex by adding the prediction of the component of the normal vector of the second vertex to the first residual of the component of the normal vector of the second vertex. In some examples, V-DMC decoder 300 may determine the normal vector of the second vertex based in part on the prediction of the component of the normal vector of the second vertex, the first residual value of the component of the normal vector of the second vertex, and a second residual value of the component of the normal vector of the second vertex. V-DMC decoder 300 may determine the second residual value of the component of the normal vector of the second vertex in the same way as the second residual value of the normal vector of the first vertex.

When applying the entropy decoding to the first data, applying the entropy decoding to the second data, and applying the entropy decoding to the third data, V-DMC decoder 300 may use a first shared non-bypass context for entropy decoding at least one bin of each of the first TU data, the second TU data, and the third TU data. For instance, in the example of FIG. 30B, the context A0 may be shared among the TU data for the mesh normal fine residual syntax element (e.g., the first syntax element), the TU data for the normal second residual syntax element (e.g., the second syntax element), and the TU data for the mesh normal coarse residual syntax element (e.g., the third syntax element). Similarly, as shown in FIG. 30B, when applying entropy decoding to the first data, applying the entropy decoding to the second data, and applying the entropy decoding to the third data, V-DMC decoder 300 may use a second shared non-bypass context (B0) for entropy decoding at least one bin of each of the first prefix, the second prefix, and the third prefix. Furthermore, in some examples, such as the example of FIG. 30B, V-DMC decoder 300 may use the second shared non-bypass context (B0) for entropy decoding second through eighth bins of the third prefix. In some examples, such as the example of FIG. 30B, when applying the entropy decoding to the first data, applying the entropy decoding to the second data, and applying the entropy decoding to the third data, V-DMC decoder 300 may use a third shared non-bypass context (A1) for entropy decoding each remaining bin of the first TU data and each remaining bin of the second TU data, and using the first shared context (B0) for entropy decoding each remaining bone of the third TU data.

In some examples, such as the example of FIG. 30B, applying the entropy decoding to the first data comprises using second (B1), third (B2), fourth (B3), fifth (B4), sixth (B5), seventh (B6), eighth (B7), ninth (B8), tenth (B9), and eleventh (B10) contexts for entropy decoding second, third, fourth, fifth, sixth, seventh, eighth, ninth, tenth, and eleventh bins of the first prefix. In some examples, such as the example of FIG. 30B, when V-DMC decoder 300 is applying the entropy decoding to the first data, V-DMC decoder 300 may further apply bypass decoding to a 12th bin of the first prefix. When applying the entropy decoding to the second data, V-DMC decoder 300 may apply bypass decoding to a 2nd through 12th bin of the second prefix. When V-DMC decoder 300 is applying the entropy decoding to the third data, V-DMC decoder 300 may apply bypass decoding to a 9th through 12th bin of the third prefix. Sharing the non-bypass context in this way may reduce the number of contexts that V-DMC decoder 300 stores, which may reduce the complexity of V-DMC decoder 300.

Furthermore, in the example of FIG. 32, V-DMC decoder 300 may subdivide the base mesh to determine an additional set of vertices for the base mesh (3216). For instance, V-DMC decoder 300 may estimate locations of additional vertices in between the vertices of the base mesh. V-DMC decoder 300 may then determine one or more displacement vectors (3218). V-DMC decoder 300 may deform the base mesh (3220). To deform the base mesh, V-DMC decoder 300 may modify locations of the additional set of vertices based on the one or more displacement vectors. V-DMC decoder 300 may determine a decoded mesh based on the deformed base mesh (3222).

Examples in the various aspects of this disclosure may be used individually or in any combination.

The following is a non-limiting list of clauses in accordance with one or more techniques of this disclosure.

Clause 1A. A device for decoding encoded mesh data, the device comprising: one or more memory units; and one or more processing units implemented in circuitry, coupled to the one or more memory units, and configured to: determine, based on the encoded mesh data, a base mesh with a first set of vertices; subdividing the base mesh to determine an additional set of vertices for the base mesh; determine one or more displacement vectors; deform the base mesh, wherein to deform the base mesh, the one or more processing units are configured to modify locations of the additional set of vertices based on the one or more displacement vectors; determine a decoded mesh based on the deformed base mesh; select a context for decoding a representation of an attribute value of a vertex of the decoded mesh in accordance with any of the techniques of this disclosure; and perform entropy decoding of the representation of the attribute value using the selected context.

Clause 2B. A device for encoding encoded mesh data, the device comprising: one or more memory units; and one or more processing units implemented in circuitry, coupled to the one or more memory units, and configured to: receive an input mesh; determine a base mesh based on the input mesh; determine a set of displacement vectors based on the input mesh and the base mesh; determine an attribute value for a vertex of the input mesh; select a context for encoding a representation of the attribute value in accordance with any of the techniques of this disclosure; perform entropy encoding on the representation using the selected context; and output an encoded bitstream that includes an encoded representation of the base mesh, the encoded representation of the attribute value, and an encoded representation of the displacement vectors.

Clause 3B. A method for encoding or decoding mesh data that comprises: selecting a context for encoding a representation of an attribute value in accordance with any of the techniques of this disclosure; and performing entropy encoding or entropy decoding on the representation using the selected context.

Clause 4B. The method of clause 3B, wherein the attribute value of the vertex is a normal vector of the vertex.

Clause 5B. The method of any of clauses 3B-4B, wherein the attribute value is a first attribute value of the vertex and the one or more processors are further configured to perform entropy decoding of representations of one or more additional attribute values of the vertex using the selected context.

Clause 6B. The method of any of clauses 3B-5B, wherein attribute values of the vertex include a first representation of a residual of a normal vector of the vertex, a second representation of the residual of the normal vector of the vertex, and a second residual of the normal vector of the vertex, the first representation of the residual of the normal vector being more coarse than the second representation of the residual of the normal vector, and the method comprises performing entropy encoding or entropy decoding on the first representation of the residual of the normal vector, the second representation of the residual of the normal vector, and the second residual of the normal vector using the selected context.

Clause 7B. The method of any of clauses 3B-6B, wherein attribute values of the vertex include a first representation of a residual of a normal vector of the vertex, a second representation of the residual of the normal vector of the vertex, and a second residual of the normal vector of the vertex, the first representation of the residual of the normal vector being more coarse than the second representation of the residual of the normal vector, and the method comprises using bypass encoding or bypass decoding as part of performing entropy encoding or entropy decoding one or more bins of the first representation of the residual of the normal vector, the second representation of the residual of the normal vector, or the second residual of the normal vector.

Clause 8B. A device for encoding or decoding mesh data, the device comprising: one or more memory units; and one or more processing units implemented in circuitry, coupled to the one or more memory units, and configured to: select a context for encoding a representation of an attribute value in accordance with any of the techniques of this disclosure; and perform entropy encoding or entropy decoding on the representation using the selected context.

Clause 9B. The device of clause 8B, wherein the one or more processing units are configured to implement the methods of any of clauses 4B-7B.

Clause 10B. One or more non-transitory computer-readable storage media comprising instructions stored thereon that, when executed by one or more processors, cause the one or more processors to perform any of the techniques of this disclosure.

Clause 1B. A device for decoding encoded mesh data, the device comprising: one or more memory units; and one or more processors implemented in circuitry, coupled to the one or more memory units, and configured to decode a mesh from a bitstream that includes the encoded mesh data, wherein the one or more processors are configured to, as part of decoding the mesh: determine, based on the encoded mesh data, a base mesh that includes a set of vertices; use a first prediction method to generate a prediction of a component of a first normal vector of a first vertex in the set of vertices; apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determine the first normal vector based in part on the prediction of the component of the first normal vector, the value of the component of the first prediction residual, and the second residual value of the component of the first normal vector; use a second prediction method to generate a prediction of a component of a second normal vector of a second vertex in the set of vertices; apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determine the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdivide the base mesh to determine an additional set of vertices for the base mesh; determine one or more displacement vectors; deform the base mesh, wherein to deform the base mesh, the one or more processors are configured to modify locations of the additional set of vertices based on the one or more displacement vectors; and determine a decoded mesh based on the base mesh.

Clause 2B. The device of claim 1B, wherein, to apply the entropy decoding to the first, second, and third entropy-encoded data, the one or more processors are further configured to use a second shared non-bypass context for entropy decoding at least one bin of each of the first prefix, the second prefix, and the third prefix.

Clause 3B. The device of claim 2B, wherein to apply the entropy decoding to the second entropy-encoded data, the one or more processors are further configured to use the second shared non-bypass context for entropy decoding second through eighth bins of the third prefix.

Clause 4B. The device of claim 1B, wherein to apply the entropy decoding to the first, second, and third entropy-encoded data, the one or more processors are further configured to use a third shared non-bypass context for entropy decoding each remaining bin of the first TU data and each remaining bin of the third TU data, and use the first shared non-bypass context for entropy decoding each remaining bone of the second TU data.

Clause 5B. The device of claim 1B, wherein to apply the entropy decoding to the first entropy-encoded data, the one or more processors are further configured to use a second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

Clause 6B. The device of claim 1B, wherein: to apply the entropy decoding to the first entropy-encoded data, the one or more processors are further configured to apply bypass decoding to a 12th bin of the first prefix, to apply the entropy decoding to the second entropy-encoded data, the one or more processors are further configured to apply bypass decoding to a 9th through 12th bin of the second prefix, and to applying the entropy decoding to the third entropy-encoded data, the one or more processors are further configured to apply bypass decoding to a 2nd through 12th bin of the third prefix.

Clause 7B. A method for decoding encoded mesh data, the method comprising: decoding a mesh from a bitstream that includes the encoded mesh data, wherein decoding the mesh comprises: determining, based on the encoded mesh data, a base mesh that includes a set of vertices; using a first prediction method to generate a prediction of a component of a first normal vector of a first vertex in the set of vertices; applying entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; applying entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determining the first normal vector based in part on the prediction of the component of the first normal vector, the value of the component of the first prediction residual, and the second residual value of the component of the first normal vector; using a second prediction method to generate a prediction of a component of a second normal vector of a second vertex in the set of vertices; applying entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determining the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdividing the base mesh to determine an additional set of vertices for the base mesh; determining one or more displacement vectors; deforming the base mesh, wherein deforming the base mesh comprises modifying locations of the additional set of vertices based on the one or more displacement vectors; and determining a decoded mesh based on the base mesh.

Clause 8B. The method of claim 7B, wherein applying the entropy decoding to the first, second, and third entropy-encoded data comprises using a second shared non-bypass context for entropy decoding at least one bin of each of the first prefix, the second prefix, and the third prefix.

Clause 9B. The method of claim 8B, wherein applying the entropy decoding to the second entropy-encoded data further comprises using the second shared non-bypass context for entropy decoding second through eighth bins of the third prefix.

Clause 10B. The method of claim 7B, wherein applying the entropy decoding to the first, second, and third entropy-encoded data comprises using a third shared non-bypass context for entropy decoding each remaining bin of the first TU data and each remaining bin of the third TU data, and using the first shared non-bypass context for entropy decoding each remaining bone of the second TU data.

Clause 11B. The method of claim 7B, wherein applying the entropy decoding to the first entropy-encoded data comprises using a second, third, and fourth non-bypass context for entropy decoding second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

Clause 12B. The method of claim 7B, wherein: applying the entropy decoding to the first entropy-encoded data further comprises applying bypass decoding to a 12th bin of the first prefix, applying the entropy decoding to the third entropy-encoded data further comprises applying bypass decoding to a 9th through 12th bin of the third prefix, and applying the entropy decoding to the second entropy-encoded data further comprises applying bypass decoding to a 2nd through 12th bin of the second prefix.

Clause 13B. A non-transitory computer-readable storage medium having instructions stored thereon that, when executed by one or more processors, cause the one or more processors to: decode a mesh from a bitstream that includes encoded mesh data, wherein the one or more processors are configured to, as part of decoding the mesh: determine, based on the encoded mesh data, a base mesh that includes a set of vertices; use a first prediction method to generate a prediction of a component of a first normal vector of a first vertex in the set of vertices; apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix; apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix; determine the first normal vector based in part on the prediction of the component of the first normal vector, the value of the component of the first prediction residual, and the second residual value of the component of the first normal vector; use a second prediction method to generate a prediction of a component of a second normal vector of a second vertex in the set of vertices; apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix; determine the normal vector of the second vertex based in part on the prediction of the component of the second normal vector and the value of the component of the second prediction residual, wherein applying the entropy decoding to the first, second, and third entropy-encoded data comprises using a first shared non-bypass context for entropy decoding at least one bin of each of the first TU data, the second TU data, and the third TU data; subdivide the base mesh to determine an additional set of vertices for the base mesh; determine one or more displacement vectors; deform the base mesh, wherein to deform the base mesh, the one or more processors are configured to modify locations of the additional set of vertices based on the one or more displacement vectors; and determine a decoded mesh based on the base mesh.

Clause 14B. The non-transitory computer-readable storage medium of claim 13B, wherein, to apply the entropy decoding to the first, second, and third entropy-encoded data, the instructions further cause the one or more processors to use a second shared non-bypass context for entropy decoding at least one bin of each of the first prefix, the second prefix, and the third prefix.

Clause 15B. The non-transitory computer-readable storage medium of claim 14B, wherein to apply the entropy decoding to the second entropy-encoded data, the instructions further cause the one or more processors to use the second shared non-bypass context for entropy decoding second through eighth bins of the third prefix.

Clause 16B. The non-transitory computer-readable storage medium of claim 13B, wherein to apply the entropy decoding to the first, second, and third entropy-encoded data, the instructions further cause the one or more processors to use a third shared non-bypass context for entropy decoding each remaining bin of the first TU data and each remaining bin of the third TU data, and use the first shared non-bypass context for entropy decoding each remaining bone of the second TU data.

Clause 17B. The non-transitory computer-readable storage medium of claim 13B, wherein to apply the entropy decoding to the first entropy-encoded data, the instructions further cause one or more processors to use a second, third, and fourth non-bypass context for entropy decoding second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

Clause 18B. The non-transitory computer-readable storage medium of claim 13B, wherein: to apply the entropy decoding to the first entropy-encoded data, the instructions further cause the one or more processors to apply bypass decoding to a 12th bin of the first prefix, to apply the entropy decoding to the second entropy-encoded data, the instructions further cause the one or more processors to apply bypass decoding to a 9th through 12th bin of the second prefix, and to applying the entropy decoding to the third entropy-encoded data, the instructions further cause the one or more processors to apply bypass decoding to a 2nd through 12th bin of the third prefix.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques may be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for decoding encoded mesh data, the device comprising:
one or more memory units; and
one or more processors implemented in circuitry, coupled to the one or more memory units, and configured to decode a mesh from a bitstream that includes the encoded mesh data, wherein the one or more processors are configured to, as part of decoding the mesh:
determine, based on the encoded mesh data, a base mesh that includes a set of vertices;
use a first prediction method to generate a prediction of a component of a first normal vector of a first vertex in the set of vertices;
apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix;
apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix;
determine the first normal vector based in part on the prediction of the component of the first normal vector, the value of the component of the first prediction residual, and the second residual value of the component of the first normal vector;
use a second prediction method to generate a prediction of a component of a second normal vector of a second vertex in the set of vertices;
apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix;
determine the normal vector of the second vertex based in part on the prediction of the component of the second normal vector and the value of the component of the second prediction residual,
wherein applying the entropy decoding to the first, second, and third entropy-encoded data comprises using a first shared non-bypass context for entropy decoding at least one bin of each of the first TU data, the second TU data, and the third TU data;
subdivide the base mesh to determine an additional set of vertices for the base mesh;
determine one or more displacement vectors;
deform the base mesh, wherein to deform the base mesh, the one or more processors are configured to modify locations of the additional set of vertices based on the one or more displacement vectors; and
determine a decoded mesh based on the base mesh.

2. The device of claim 1, wherein, to apply the entropy decoding to the first, second, and third entropy-encoded data, the one or more processors are further configured to use a second shared non-bypass context for entropy decoding at least one bin of each of the first prefix, the second prefix, and the third prefix.

3. The device of claim 2, wherein to apply the entropy decoding to the second entropy-encoded data, the one or more processors are further configured to use the second shared non-bypass context for entropy decoding second through eighth bins of the third prefix.

4. The device of claim 1, wherein to apply the entropy decoding to the first, second, and third entropy-encoded data, the one or more processors are further configured to use a third shared non-bypass context for entropy decoding each remaining bin of the first TU data and each remaining bin of the third TU data, and use the first shared non-bypass context for entropy decoding each remaining bone of the second TU data.

5. The device of claim 1, wherein to apply the entropy decoding to the first entropy-encoded data, the one or more processors are further configured to use a second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

6. The device of claim 1, wherein:
to apply the entropy decoding to the first entropy-encoded data, the one or more processors are further configured to apply bypass decoding to a 12th bin of the first prefix,
to apply the entropy decoding to the second entropy-encoded data, the one or more processors are further configured to apply bypass decoding to a 9th through 12th bin of the second prefix, and
to applying the entropy decoding to the third entropy-encoded data, the one or more processors are further configured to apply bypass decoding to a 2nd through 12th bin of the third prefix.

7. A method for decoding encoded mesh data, the method comprising:
decoding a mesh from a bitstream that includes the encoded mesh data, wherein decoding the mesh comprises:
determining, based on the encoded mesh data, a base mesh that includes a set of vertices;
using a first prediction method to generate a prediction of a component of a first normal vector of a first vertex in the set of vertices;
applying entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix;
applying entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix;
determining the first normal vector based in part on the prediction of the component of the first normal vector, the value of the component of the first prediction residual, and the second residual value of the component of the first normal vector;
using a second prediction method to generate a prediction of a component of a second normal vector of a second vertex in the set of vertices;
applying entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix;
determining the normal vector of the second vertex based in part on the prediction of the component of the second normal vector and the value of the component of the second prediction residual,
wherein applying the entropy decoding to the first, second, and third entropy-encoded data comprises using a first shared non-bypass context for entropy decoding at least one bin of each of the first TU data, the second TU data, and the third TU data;
subdividing the base mesh to determine an additional set of vertices for the base mesh;
determining one or more displacement vectors;
deforming the base mesh, wherein deforming the base mesh comprises modifying locations of the additional set of vertices based on the one or more displacement vectors; and
determining a decoded mesh based on the base mesh.

8. The method of claim 7, wherein applying the entropy decoding to the first, second, and third entropy-encoded data comprises using a second shared non-bypass context for entropy decoding at least one bin of each of the first prefix, the second prefix, and the third prefix.

9. The method of claim 8, wherein applying the entropy decoding to the second entropy-encoded data further comprises using the second shared non-bypass context for entropy decoding second through eighth bins of the third prefix.

10. The method of claim 7, wherein applying the entropy decoding to the first, second, and third entropy-encoded data comprises using a third shared non-bypass context for entropy decoding each remaining bin of the first TU data and each remaining bin of the third TU data, and using the first shared non-bypass context for entropy decoding each remaining bone of the second TU data.

11. The method of claim 7, wherein applying the entropy decoding to the first entropy-encoded data comprises using a second, third, and fourth non-bypass context for entropy decoding second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

12. The method of claim 7, wherein:
applying the entropy decoding to the first entropy-encoded data further comprises applying bypass decoding to a 12th bin of the first prefix,
applying the entropy decoding to the third entropy-encoded data further comprises applying bypass decoding to a 9th through 12th bin of the third prefix, and
applying the entropy decoding to the second entropy-encoded data further comprises applying bypass decoding to a 2nd through 12th bin of the second prefix.

13. A non-transitory computer-readable storage medium having instructions stored thereon that, when executed by one or more processors, cause the one or more processors to:
decode a mesh from a bitstream that includes encoded mesh data, wherein the one or more processors are configured to, as part of decoding the mesh:
determine, based on the encoded mesh data, a base mesh that includes a set of vertices;
use a first prediction method to generate a prediction of a component of a first normal vector of a first vertex in the set of vertices;
apply entropy decoding to first entropy-encoded data in the bitstream to decode first data, wherein the first data is a binarized representation of a first syntax element, the first syntax element indicates a value of a component of a first prediction residual, the value of the component of the first prediction residual indicates a difference between the prediction of the component of the first normal vector and a value of the component of the first normal vector, the first data comprises first truncated unary (TU) data and a first exponential-Golomb code, the first exponential-Golomb code comprising a first prefix and a first suffix;
apply entropy decoding to second entropy-encoded data in the bitstream to decode second data, wherein the second data is a binarized representation of a second syntax element, the second syntax element indicates a second residual value of the component of the normal vector of the first vertex, the second data comprises second truncated unary (TU) data and a second exponential-Golomb code, the second exponential-Golomb code comprising a second prefix and a second suffix;
determine the first normal vector based in part on the prediction of the component of the first normal vector, the value of the component of the first prediction residual, and the second residual value of the component of the first normal vector;
use a second prediction method to generate a prediction of a component of a second normal vector of a second vertex in the set of vertices;
apply entropy decoding to third entropy-encoded data in the bitstream to decode third data, wherein the third data is a binarized representation of a third syntax element, the third syntax element indicates a value of a component of a second prediction residual, wherein the value of the component of the second prediction residual indicates a difference between the prediction of the component of the second normal vector and a value of the component of the second normal vector, the third data comprising third TU data and a third exponential-Golomb code, the third exponential-Golomb code comprising a third prefix and a third suffix;
determine the normal vector of the second vertex based in part on the prediction of the component of the second normal vector and the value of the component of the second prediction residual,
wherein applying the entropy decoding to the first, second, and third entropy-encoded data comprises using a first shared non-bypass context for entropy decoding at least one bin of each of the first TU data, the second TU data, and the third TU data;
subdivide the base mesh to determine an additional set of vertices for the base mesh;
determine one or more displacement vectors;
deform the base mesh, wherein to deform the base mesh, the one or more processors are configured to modify locations of the additional set of vertices based on the one or more displacement vectors; and
determine a decoded mesh based on the base mesh.

14. The non-transitory computer-readable storage medium of claim 13, wherein, to apply the entropy decoding to the first, second, and third entropy-encoded data, the instructions further cause the one or more processors to use a second shared non-bypass context for entropy decoding at least one bin of each of the first prefix, the second prefix, and the third prefix.

15. The non-transitory computer-readable storage medium of claim 14, wherein to apply the entropy decoding to the second entropy-encoded data, the instructions further cause the one or more processors to use the second shared non-bypass context for entropy decoding second through eighth bins of the third prefix.

16. The non-transitory computer-readable storage medium of claim 13, wherein to apply the entropy decoding to the first, second, and third entropy-encoded data, the instructions further cause the one or more processors to use a third shared non-bypass context for entropy decoding each remaining bin of the first TU data and each remaining bin of the third TU data, and use the first shared non-bypass context for entropy decoding each remaining bone of the second TU data.

17. The non-transitory computer-readable storage medium of claim 13, wherein to apply the entropy decoding to the first entropy-encoded data, the instructions further cause one or more processors to use a second, third, and fourth non-bypass context for entropy decoding second, third, fourth, fifth, sixth, seventh, eighth, ninth, tenth, and eleventh contexts for entropy decoding second, third, fourth, fifth, sixth, seventh, eighth, ninth, tenth, and eleventh bins of the first prefix.

18. The non-transitory computer-readable storage medium of claim 13, wherein:
to apply the entropy decoding to the first entropy-encoded data, the instructions further cause the one or more processors to apply bypass decoding to a 12th bin of the first prefix,
to apply the entropy decoding to the second entropy-encoded data, the instructions further cause the one or more processors to apply bypass decoding to a 9th through 12th bin of the second prefix, and
to applying the entropy decoding to the third entropy-encoded data, the instructions further cause the one or more processors to apply bypass decoding to a 2nd through 12th bin of the third prefix.
